(19) United States
(12) Patent Application Publication
(10) Pub. No.: US 2024/0394693 A1
(43) Pub. Date: Nov. 28, 2024

(54) METHOD AND SYSTEM FOR PROTECTING LOCATION PRIVACY IN MOBILE PAYMENT, MEDIUM, DEVICE, AND TERMINAL

(71) Applicant: GUIZHOU UNIVERSITY OF FINANCE AND ECONOMICS, Guiyang (CN)

(72) Inventors: Hai LIU, Guiyang (CN); Fangqiong LI, Guiyang (CN); Mingsen DENG, Guiyang (CN); Hongfa DING, Guiyang (CN); Heling JIANG, Guiyang (CN)

(73) Assignee: GUIZHOU UNIVERSITY OF FINANCE AND ECONOMICS, Guiyang (CN)

(21) Appl. No.: 18/522,267

(22) Filed: Nov. 29, 2023

(30) Foreign Application Priority Data
May 16, 2023 (CN) 202310547496.3

(51) Int. Cl. G06Q 20/38; G06Q 20/40

(52) U.S. Cl. CPC G06Q 20/385; G06Q 20/4016; G06Q 20/407

(57) ABSTRACT

A method for protecting location privacy in mobile payment is provided. A decentralized coin mixing idea is introduced into mobile payment, and an anonymous transaction model and a reputation evaluation model are constructed. A user reputation evaluation scheme is designed, and a reputation value of a user is measured based on historical behavior of the user. An anonymous transaction scheme based on reputation evaluation and a double auction is designed, and a functional relationship between the reputation value of the user and an auction bid is established. Candidate collaborative users who meet a reputation requirement, a privacy requirement and a bid standard of a requesting user are selected through a double auction, to construct an anonymous set. The anonymous set is inserted between the user and a merchant to cut off a direct transaction association between the user and the merchant to protect the location privacy of mobile payment users.

### CROSS REFERENCE TO THE RELATED APPLICATIONS

This application is based upon and claims priority to Chinese Patent Application No. 202310547496.3, filed on May 16, 2023, the entire contents of which are incorporated herein by reference.

### TECHNICAL FIELD

The present disclosure relates to the technical field of privacy protection, and in particular, to a method and system for protecting location privacy in mobile payment, a medium, a device, and a terminal.

### BACKGROUND

At present, with the continuous popularization of intelligent terminal devices and the development and innovation of mobile payment technology, application scenarios for mobile payment gradually tend to be diversified and vertical, covering all aspects of people's daily lives, and mobile payment has become a mainstream payment method in society.

However, privacy and security issues with mobile payment are constantly emerging, while the mobile payment industry is generally booming. In a real scenario, when a user uses mobile payment for account settlement in a store, because the geographical location of the store is relatively fixed, a payment platform can easily determine a physical relation between the user and the consumption location thereof based on user transaction information grasped by the payment platform and store location information provided by a merchant. Assuming that users A and B, respectively, use mobile payment for settlement in a bar and a pharmacy, a mobile payment platform has transaction information about the users and can associate the users with corresponding consumption locations in combination with the geographical locations of the bar and the pharmacy. If the mobile payment platform illegally abuses the consumption location information of the users, it can obtain other personal privacy information about the users, such as their consumption level, interests and hobbies, health status and others. Although a friend-entrusted payment function provided by the mobile payment platform can disturb correspondence between the user and the consumption location thereof to some extent, the privacy of the transaction information results in a low rate of using this function. Therefore, people are facing leakage risks of personal privacy information while enjoying the convenience of mobile payments.

At present, research on mobile payment security by researchers around the world focuses more on payment security. Research on location privacy and security is quite scarce. Most of the location privacy protection mechanisms proposed by existing research are also oriented toward location-based service (LBS) scenarios, and are not suitable for mobile payment environments. Therefore, a location privacy leakage problem in mobile payments still needs to be resolved.

To resolve the location privacy leakage problem in mobile payments, a transaction association between a user and a merchant needs to be cut off. An anonymous transaction is the best idea to remove the transaction association. Disclosure of the pseudo-anonymity of bitcoins has led to the prevalence of anonymous transactions in the bitcoin field. A decentralized coin mixing scheme is widely used due to the lack of need for third-party mixing servers and complex cryptographic techniques. An anonymous transaction can remove the relation between a user and a merchant location from a transaction record and disturb the mapping relationship between the user and the consumption location thereof. In this way, even if the mobile payment platform has the transaction record of the user and location information of the store, it cannot determine who is consuming at the current location to protect the location information security of the user. However, even if the possible bad behavior of collaborative users in a transaction process is considered and a corresponding accountability mechanism is designed in the existing decentralized coin mixing scheme, because the reputations of the collaborative users are not evaluated when an anonymous set is constructed, the final generated anonymous set still includes low-reputation collaborative users. This increases the risk of malicious leakage of user transaction information and reduces the anonymity of the scheme.

Academic research has found that the public auditing property of a blockchain poses a serious threat to the identity privacy of bitcoin users and is committed to finding a solution to enhance anonymity of bitcoin transactions. Existing research may be broadly classified into two types: anonymous cryptocurrencies and coin mixing schemes.

Miers et al. believed that existing e-cash schemes rely on a trusted currency issuer to create e-cash, which is inconsistent with a distributed system architecture of bitcoins, and that there is a single point of failure problem with the participation of a trusted third party. In view of this, they proposed a distributed e-cash system called Zerocoin without the participation of a trusted third party. A zero-knowledge proof technology is used to destroy the relation between individual bitcoin transactions and expand the coin-mixing scope. However, the maintenance costs for the system are very high due to the use of complex cryptography technology. Danezis et al. used an elliptic curve signature and a bilinear mapping to replace a strong Rivest-Shamir-Adleman (RSA) assumption and a double discrete logarithm proof on which Zerocoin relies to improve overall performance of the scheme. Garman et al. argued that Zerocoin achieves strong anonymity of transactions but has high system overheads. They proposed reducing the quantity of non-interactive zero-knowledge proofs by increasing coin forgery costs, to reduce computational overheads of the system. Even if the performance of Zerocoin is improved in the prior art, Zerocoin itself is not a completely anonymous currency but still shows a target address and a specific amount of a transaction. Therefore, Sasson et al. developed an anonymous payment scheme called Zerocash with a stronger privacy protection function through a concise and non-interactive zero-knowledge proof. On the basis of Zerocoin, Zerocash protects the transaction amount and identity privacy of both parties and implements full anonymity for transactions. However, a trusted third party is needed to generate global parameters, and the overall efficiency of the scheme is low due to an unfalsifiable cryptographic assumption relied on.

The basic principle of a coin-mixing idea was first proposed by Chuam. Asymmetrically encrypted communication information is transmitted through an intermediary to prevent an attacker from identifying the identities of and a relation between both communication parties. Existing coin mixing schemes are classified into centralized coin mixing schemes and decentralized coin mixing schemes based on whether the schemes rely on third-party mixing servers.

In a centralized MixCoin scheme proposed by Bonneau et al., a mixing server, Mix, processes all transactions to remove a relation between both transaction parties. An accountability mechanism is designed to prevent Mix from stealing users' bitcoins. However, a mapping between an input address and an output address of a transaction is visible to Mix, such that Mix can leak users' transaction information. Therefore, Yu and Valenta used blind signature technology to prevent Mix from linking the input address to the output address and protect users' transaction information from being maliciously leaked by Mix. Heilmanet et al. designed a centralized TumbleBit scheme on the premise that a third party is untrusted. The scheme uses blind signatures and smart contracts to ensure the security of transactions between users and Mix and uses a cut-and-choose method of secure multiparty computation to remove links between users and Mix and enhance transaction anonymity. In view of the problem that an existing blind signature scheme is incompatible with an elliptic curve digital signature algorithm (ECDSA) used in a bitcoin protocol, Yi et al. proposed a blind signature compatible with a standard ECDSA and applied the proposed blind ECDSA to implement the anonymity of bitcoin transactions. Liu et al. designed an unlinkable coin mixing scheme through a group transaction and a ring signature technology such that untrusted Mix can only check whether the output address belongs to its customer but does not determine which address belongs to which customer, to prevent Mix from leaking users' privacy. However, exposure to Mix increases the possibility of guessing both parties of an actual transaction. In addition, there is vulnerability to denial-of-service (DOS) attacks due to a performance bottleneck in Mix. To resolve the Mix performance bottleneck problem of the centralized coin mixing scheme, Lu et al. constructed a system model based on user-mix-supervisor and designed a random selection algorithm for Mix to enhance anonymity and the anti-DOS attack ability of the scheme. In this model, Mix is responsible only for hosting and transferring bitcoins, and the supervisor is responsible only for allocating and managing coin mixing tasks, to eliminate risks of becoming a performance bottleneck. However, in this scheme, the supervisor can still determine the Mix selected by the user and a specific transaction address, such that the supervisor can leak the user's private information and break transaction anonymity.

The centralized coin mixing scheme relies on a third-party mixing server, resulting in problems of a single point of failure and a performance bottleneck. In view of these problems, Maxwell et al. proposed a decentralized coin mixing scheme called Coinjoin without the participation of any trusted or untrusted third-party mixing server. Nodes in a blockchain serve as intermediaries to replace the mixing server. However, in the negotiation process between the nodes, the intermediaries may infer relevant transaction information and collude with each other. In addition, and are vulnerable to DOS attacks. Ruffing et al. improved Coinjoin and proposed a transaction shuffling scheme called CoinShuffle. Although the possibility that the nodes have malicious behavior is avoided, there is vulnerability to DOS attacks. When a quantity of tasks is very large, this scheme can select only one task to perform coin mixing and has poor performance. Bissias et al. proposed the Xim scheme, which allows users to randomly and anonymously select intermediaries. This scheme increases difficulty in guessing a mapping relationship between both transaction parties and can resist DOS attacks. However, it takes several hours to complete a bitcoin mixing task, resulting in that the scheme has low execution efficiency. Ziegeldorf et al. used a threshold signature technology and a threshold ECDSA signature scheme to generate escrow addresses in a distributed manner. User funds transferred to the escrow address are jointly owned and controlled by a plurality of mixing nodes. The funds in the escrow address can be redeemed through a threshold transaction only when most nodes agree. Therefore, a coin mixing scheme called CoinParty is constructed, which allows a part of nodes to fail or even launch malicious attacks. However, due to a limitation on the maximum transaction size of bitcoins, only a small quantity of transactions can be processed at a time, intermediaries need to always be online, and there is vulnerability to DOS attacks. Zijue WANG et al. combined a one-way aggregate signature technology, homomorphic encryption, and the coin mixing idea to implement anonymous protection of information such as a user identity and a transaction amount. Mardi et al. proposed a multiparty shuffling scheme to resolve a problem of high system overheads caused by the need for a plurality of signatures from participants in the existing decentralized coin mixing scheme. Through a plurality of rounds of shuffling, an attacker cannot determine the relation between both transaction parties, such that anonymization of bitcoin transactions is implemented. However, there are the same limitations as CoinShuffle, and the execution efficiency of the scheme is low.

In conclusion, anonymous cryptocurrency relies on complex cryptography technology, making the overall efficiency of the scheme low. The centralized coin mixing scheme, with the introduction of a third-party mixing server, has the problems of a single point of failure and a performance bottleneck. In contrast, the decentralized coin mixing scheme has the advantages of simple deployment and good performance. However, although a corresponding accountability mechanism is designed in the existing decentralized coin mixing scheme to restrict the behavior of nodes, credibility of the nodes is not measured when an anonymous set is constructed. If a node with low credibility is introduced to participate in coin mixing, the risks of the node maliciously leaking user information increase, thereby reducing the anonymity of the scheme. Therefore, directly applying the existing anonymous bitcoin transaction schemes cannot effectively implement the anonymous transactions of mobile payment users.

Through the foregoing analysis, the prior art has the following problems and defects:
(1) The existing anonymous cryptocurrency scheme uses complex cryptography technology that causes high maintenance costs for the system and relies on the unfalsifiable cryptographic assumption, which makes the overall efficiency of the scheme low.
(2) The existing centralized coin mixing scheme has the problems of a single point of failure and a performance bottleneck due to the introduction of a third-party mixing server. There is a vulnerability to DOS attacks. The scheme has poor performance and low execution efficiency. The mixing server can leak user privacy information and destroy transaction anonymity.
(3) In the existing decentralized coin mixing scheme, because the reputations of the collaborative users are not evaluated when the anonymous set is constructed, the final generated anonymous set still includes low-reputation collaborative users. This increases the the risk of malicious leakage of user transaction information and reduces the anonymity of the scheme.

### SUMMARY

In view of the problems in the prior art, the present disclosure provides a method and system for protecting location privacy in mobile payment, a medium, a device, and a terminal, and in particular, relates to a method and system for protecting location privacy in mobile payment based on reputation evaluation and a double auction, a medium, a device, and a terminal.

The present disclosure is implemented as follows. A method for protecting location privacy in mobile payment includes: introducing a decentralized coin mixing idea into mobile payment, and constructing an anonymous transaction model and a reputation evaluation model in a mobile payment environment; designing a user reputation evaluation scheme, and measuring a reputation value of a user based on historical behavior of the user; designing an anonymous transaction scheme based on reputation evaluation and a double auction, and establishing a functional relationship between the reputation value of the user and an auction bid; selecting, through the double auction, candidate collaborative users who meet a reputation requirement, a privacy requirement and a bid standard of a requesting user, to construct an anonymous set; and inserting the anonymous set constructed by collaborative users between the user and a merchant to cut off a direct transaction association between the user and the merchant and implement transaction anonymization.

Further, the anonymous transaction model in the mobile payment environment constructed based on the decentralized coin mixing idea includes the requesting user, the collaborative users and the merchant. A secure communication link exists between the requesting user and the collaborative user.

A set of all users in a network is U={P₀, P₁, P₂, . . . , Pₙ, . . . , Pₘ}. The requesting user P₀ is an initiator of an anonymous transaction, sends an anonymous transaction collaboration request Q_{P}_{₀} to the other users U′={P₁, P₂, . . . , Pₙ, . . . , Pₘ} in the network, and selects k users from n candidate collaborative users who accept the collaboration request, to construct the anonymous set Set={A₁ . . . , Aᵢ, . . . , Aₖ}. k is the privacy requirement of the requesting user P₀. The anonymous set Set is introduced to transform an actual transaction D(P₀→S) into D(P₀→S)⇒D₀(P₀→A_{Set})·D₁(A_{Set}→S), where D₀(P₀→A_{Set}) is used to cut off the direct transaction association between the requesting user P₀ and the merchant S. D₁(A_{Set}→S) is used to ensure that funds are transferred to a correct merchant account. After the anonymous set is successfully constructed, the requesting user P₀ divides the original transaction as follows: D(P₀→S)⇒d₀(P₀→A₁)·(A₁→A₂)· . . . dₖ₋₁(Aₖ₋₁→Aₖ)·dₖ(Aₖ→S). Each transaction dᵢ(Aᵢ→Aᵢ₊₁) obtained after the division is executed by a collaborative user Aᵢ to implement a flow of the funds of the requesting user. The collaborative user Aᵢ is a participant in the anonymous transaction and obtains remuneration by providing a collaboration service to the requesting user. After receiving a collaboration task dᵢ(Aᵢ→Aᵢ₊₁) sent by the requesting user P₀, the collaborative user Aᵢ transfers a fixed amount of funds to an account of Aᵢ₊₁ based on collaboration content. Identities of the requesting user and the collaborative user may change in a next transaction. That is, the collaborative user of the current transaction may be a requesting user of the next transaction. The merchant S is an actual recipient of the anonymous transaction, does not participate in a specific execution process of the anonymous transaction, and serves only as a final recipient of the funds.

Impact of the historical behavior of the user in an anonymous transaction process on the reputation value of the user is analyzed through the reputation evaluation model. Within a discrete time period T={1, 2, . . . , t, . . . }, the requesting user P₀ broadcasts the collaboration request Q_{P}_{₀} in expectation of a response from the network user Pⱼ, to generate the anonymous set Set. If the requesting user has malicious behavior of falsifying information, deceiving the collaborative user into executing a false anonymous transaction, or not paying remuneration to the collaborative user who executes a transaction in the anonymous transaction process, a reputation value of the requesting user is reduced as a penalty. A formula for measuring an instantaneous reputation value X_{P}_{₀}(t) of the requesting user P₀ at a moment t is as follows:

$${χ}_{{P}_{0}} ( t ) = max ( 0 , {χ}_{{P}_{0}} ( t - 1 ) - n * \frac{{β}_{{P}_{0}}^{t}}{{α}_{{P}_{0}}^{t} + {β}_{{P}_{0}}^{t}} ) .$$

If the network user Pⱼ has behavior of falsifying information during response to the requesting user P₀, a reputation value of the network user is reduced as a penalty. A formula for measuring an instantaneous reputation value X_{P}_{ⱼ}(t) of the network user Pⱼ at the moment t is as follows:

$${χ}_{{P}_{j}} ( t ) = max ( 0 , {χ}_{{P}_{j}} ( t - 1 ) - n * \frac{{β}_{{P}_{j}}^{t}}{{α}_{{P}_{j}}^{t} + {β}_{{P}_{j}}^{t}} ) .$$

If the collaborative user Aᵢ leaks the specific collaboration task dᵢ(Aᵢ→Aᵢ₊₁) issued by the requesting user P₀, or delays or interrupts execution of the collaboration task, a reputation value of the collaborative user is reduced as a penalty. If the collaborative user honestly executes the collaboration task, the reputation value of the collaborative user is increased as a reward. A formula for measuring an instantaneous reputation value X_{A}_{ᵢ}(t) of the collaborative user Aᵢ at the moment t is as follows:

$${χ}_{{A}_{i}} ( t ) = \{ \begin{matrix}min ( 1 , {χ}_{{A}_{i}} ( t - 1 ) + p * \frac{{α}_{{A}_{i}}^{t}}{{α}_{{A}_{i}}^{t} + {β}_{{A}_{i}}^{t}} ) \\ max ( 0 , {χ}_{{A}_{i}} ( t - 1 ) - n * \frac{{β}_{{A}_{i}}^{t}}{{α}_{{A}_{i}}^{t} + {β}_{{A}_{i}}^{t}} )\end{matrix} ,$$

p is an incentive factor. n is a penalty factor. α_{P}^{t} is a cumulative quantity of times the user honestly participates in anonymous transactions by t. B_{P}^{t} is a cumulative quantity of times the user has bad behavior by t. 0<p«n<1, and a self-interested user is prompted to adhere to rational consensus by increasing a penalty. The instantaneous reputation value of the user meets a condition 0≤X_{P}(t)≤1. An initial reputation value X_{P}(0) of the user is 0.5.

Each instantaneous reputation value X_{P}(t) of the user in the anonymous transaction process is fused to calculate a comprehensive reputation value of the user. A quadratic decreasing function is used to define a weight of each instantaneous reputation value X_{P}(t) of the user in the comprehensive reputation value as follows:

$$ω ( {χ}_{P} ( t ) ) = \{ \begin{matrix}{( 1 - \frac{T - t}{Γ} )}^{2} , & T - Γ < t \leq T \\ 0 , & 0 \leq t \leq T - Γ\end{matrix} ,$$

where T is a current moment, and Γ is a validity period of the reputation value. When t=T, ω(X_{P}(t))=1. That is, when X_{P}(t) is a reputation value at the current moment, a weight of the reputation value in the comprehensive reputation value is 1. When 0≤t≤T−Γ, ω(X_{P}t))=0, indicating that a reputation value at a moment with an interval to the current moment T exceeding the validity period Γ is not used for evaluation. The comprehensive reputation value of the user is finally obtained through a weighted average sum method as follows:

$${χ}_{P} = {\sum }_{T - Γ < t \leq T} ( {χ}_{P} ( t ) * \frac{ω ( {χ}_{P} ( t ) )}{{\sum }_{T - Γ < t \leq T} ω ( {χ}_{P} ( t ) )} ) .$$

A double auction mechanism includes: In the network, n requesting users U={P₀,P₁,P₂, . . . , Pₙ} are waiting for anonymous services and m network users U′={Pₙ₊₁, Pₙ₊₂, . . . , Pₙ₊ₘ} are waiting to receive collaboration tasks. Each requesting user Pᵢ∈U broadcasts a collaboration request Q_{P}_{ᵢ}=(X_{P}_{ᵢ}, M, Δt, O_{P}_{ᵢ}) to the other user Pⱼ∈U′ in the network. X_{P}_{ᵢ} is a comprehensive reputation value of the requesting user. M is an actual transaction amount of the requesting user. Δt is an acceptable anonymous transaction execution delay of the requesting user. O_{P}_{ᵢ} is a bid base of the auction.

The bid base of the requesting user is

$${O}_{{P}_{i}} = \frac{M * φ ( Δ t )}{{χ}_{{P}_{i}}} .$$

φ(Δt) is a decreasing function. A bid O_{P}_{ⱼ} of the network user Pⱼ needs to have a positive correlation with the bid base of the requesting user. The bid of the network user is O_{P}_{ⱼ}=O_{P}_{ᵢ}*X_{P}_{ⱼ}*ρ. ρ is a control coefficient used to limit overbidding. After receiving the collaboration request Q_{P}_{ᵢ}, the network user Pⱼ∈U′ ranks the requesting user in ascending order of the bid base O_{P}_{ᵢ} and the comprehensive reputation value X_{P}_{ᵢ}, and determines, based on a comprehensive ranking of the bid base and the comprehensive reputation value of the requesting user Pᵢ, whether to accept the request. If the network user accepts the request, the network user sends a reply R_{P}_{ⱼ}=(X_{P}_{ⱼ}, O_{P}_{ⱼ}) to the requesting user; or if the network user rejects the request, the network user does not respond. The network user selectively accepts collaboration requests of a plurality of requesting users based on a capability of the network user, and establish a to-be-executed task set W_{P}_{ⱼ}={w₁, w₂, . . . , wₙ}. The requesting user Pᵢ arranges the candidate collaborative users in ascending order of comprehensive reputation value and in descending order of bid, and determines that k users whose comprehensive ranking is the highest constitute the anonymous set Set={A₁ . . . , Aᵢ, . . . , Aₖ}.

Further, the method for protecting location privacy in mobile payment includes the following steps:
step 1: in an anonymous set generation phase, describing a mutual relationship between users from a perspective of a supply-demand relationship, and generating the anonymous set for the requesting user through a double auction mechanism;
step 2: in a transaction execution phase, executing an anonymous transaction based on the anonymous transaction model; and
step 3: in a reputation update phase, updating reputations of the users based on the reputation evaluation scheme and bad user behavior defined in the anonymous set generation phase and the transaction execution phase.

Further, the anonymous set generation phase in step 1 includes:

(1) before executing a mobile payment transaction, broadcasting, by the requesting user P₀, a collaboration request Q_{P}_{₀}=(X_{P}_{₀}, M, Δt, O_{P}_{₀}, Sign_{P}_{₀}(X_{P}_{₀}∥M∥Δt∥O_{P}_{₀})) to the other users in a network, where Sign(·) is a secure signature function, and Sign_{P}_{₀}(X_{P}_{₀}∥M∥Δt∥O_{P}_{₀}) indicates that the requesting user P₀ signs information such as a comprehensive reputation value, a transaction amount, and an acceptable task execution delay by using a private key;

(2) after receiving the collaboration request Q_{P}_{₀}=(X_{P}_{₀}, M, Δt, O_{P}_{₀}, Sign_{P}_{₀}(X_{P}_{₀}∥M∥Δt∥O_{P}_{₀})) sent by the requesting user P₀, verifying, by the network user Pⱼ, correctness of the signature information Sign_{P}_{₀}(X_{P}_{₀}∥M∥Δt∥O_{P}_{₀}) and the comprehensive reputation value X_{P}_{₀} of the requesting user P₀ in the collaboration request Q_{P}_{₀}:

1) if Ver_{P}_{₀}(Sign_{P}_{₀}(X_{P}_{₀}∥M∥Δt∥O_{P}_{₀}))=Sign_{P}_{₀}(X_{P}_{₀}∥M∥Δt∥O_{P}_{₀}), indicating that an identity of the requesting user passes the verification, verifying the comprehensive reputation value X_{P}_{₀} of the requesting user;

if

$$Ver ( {χ}_{{P}_{0}} ) = {\sum }_{T - Γ < t \leq T} ( {χ}_{{P}_{0}} ( t ) * \frac{ω ( {χ}_{{P}_{0}} ( t ) )}{{\sum }_{T - Γ < t \leq T} ω ( {χ}_{{P}_{0}} ( t ) )} ) ,$$

indicating that the identity and the comprehensive reputation value of the requesting user both pass the verification, determining, by the network user based on a bid base O_{P}_{₀} given by and the comprehensive reputation value X_{P}_{₀} of the requesting user, whether to accept the collaboration request; if the network user Pⱼ accepts the collaboration request of the requesting user P₀, sending a reply R_{P}_{ⱼ}=(X_{P}_{ⱼ},O_{P}_{ⱼ}, add(Pⱼ), Sign_{P}_{ⱼ}(X_{P}_{ⱼ}∥O_{P}_{ⱼ}∥add(Pⱼ))) to the requesting user P₀, where add(Pⱼ) is an account address of the network user Pⱼ; otherwise, not responding; and accepting, by the network user, collaboration requests of a plurality of requesting users based on a capability of the network user, to form a to-be-executed task set W_{P}_{ⱼ}={w₁, w₂, . . . , wₙ}; or

if

$$Ver ( {χ}_{{P}_{0}} ) \neq {\sum }_{T - Γ < t \leq T} ( {χ}_{{P}_{0}} ( t ) * \frac{ω ( {χ}_{{P}_{0}} ( t ) )}{{\sum }_{T - Γ < t \leq T} ω ( {χ}_{{P}_{0}} ( t ) )} ) ,$$

indicating that the comprehensive reputation value of the requesting user fails the verification, broadcasting, by the network user Pⱼ, information message_{P}_{ⱼ}(¬X_{P}_{₀}); or

2) if Ver_{P}_{₀}(Sign_{P}_{₀}(X_{P}_{₀}∥M∥Δt∥O_{P}_{₀}))≠Sign_{P}_{₀}(X_{P}_{₀}∥M∥Δt∥O_{P}_{₀}), indicating that an identity of the requesting user fails the verification, broadcasting, by the network user Pⱼ, information message_{P}_{ⱼ}(¬P₀) without verifying the comprehensive reputation value X_{P}_{₀} of the requesting user, where Ver(·) is a verification function, Ver_{P}_{₀}(Sign_{P}_{₀}(X_{P}_{₀}∥M∥Δt∥O_{P}_{₀})) indicates verification of correctness of the signature information Sign_{P}_{₀}(X_{P}_{₀}∥M∥Δt∥O_{P}_{₀}) by using a public key of the requesting user P₀, and if the verification fails, Sign_{P}_{₀}(X_{P}_{₀}∥M∥Δt∥O_{P}_{₀}) is not a signature generated through encryption performed by using the private key of P₀, and the identity of the requesting user is likely to be forged;

(3) verifying, by the requesting user P₀, correctness of the reply R_{P}_{ⱼ}=(X_{P}_{ⱼ}, O_{P}_{ⱼ}, add(Pⱼ), Sign_{P}_{ⱼ}(X_{P}_{ⱼ}∥O_{P}_{ⱼ}∥add(Pⱼ))) of the network user Pⱼ:

1) if Ver_{P}_{ⱼ}Sign_{P}_{ⱼ}(X_{P}_{ⱼ}∥O_{P}_{ⱼ}∥add(Pⱼ)))=Sign_{P}_{ⱼ}(X_{P}_{ⱼ}∥O_{P}_{ⱼ}∥add(Pⱼ)), indicating that an identity of the network user passes the verification, verifying a comprehensive reputation value of the network user; and

if

$$Ver ( {χ}_{{P}_{j}} ) = {\sum }_{T - Γ < t \leq T} ( {χ}_{{P}_{j}} ( t ) * \frac{ω ( {χ}_{{P}_{j}} ( t ) )}{{\sum }_{T - Γ < t \leq T} ω ( {χ}_{{P}_{j}} ( t ) )} ) ,$$

indicating that the comprehensive reputation value of the network user passes the verification, taking the network user Pⱼ as a candidate collaborative user; or

if

$$Ver ( {χ}_{{P}_{j}} ) \neq {\sum }_{T - Γ < t \leq T} ( {χ}_{{P}_{j}} ( t ) * \frac{ω ( {χ}_{{P}_{j}} ( t ) )}{{\sum }_{T - Γ < t \leq T} ω ( {χ}_{{P}_{j}} ( t ) )} ) ,$$

indicating that the comprehensive reputation value of the network user fails the verification, broadcasting, by the requesting user P₀, information message_{P}_{₀}(¬X_{P}_{ⱼ}); or

2) if Ver_{P}_{ⱼ}(Sign_{P}_{ⱼ}(X_{P}_{ⱼ}∥O_{P}_{ⱼ}∥add(Pⱼ)))≠Sign_{P}_{ⱼ}(X_{P}_{ⱼ}∥O_{P}_{ⱼ}∥add(Pⱼ)), indicating that an identity of the network user fails the verification, broadcasting, by the requesting user P₀, information message_{P}_{₀}(¬Pⱼ) without verifying the comprehensive reputation value X_{P}_{ⱼ} of the network user; and

(4) ranking, by the requesting user P₀, the candidate collaborative user in ascending order of the comprehensive reputation value X_{P}_{ⱼ} and in descending order of a bid O_{P}_{ⱼ} to obtain a comprehensive reputation value ranking N_{X}(Pⱼ) and a bid ranking N_{O}(Pⱼ) of the candidate collaborative user Pⱼ, where a comprehensive ranking of the candidate collaborative user is N(Pⱼ)=N_{X}(Pⱼ)+N_{O}(Pⱼ); selecting k users whose comprehensive ranking N(Pⱼ) is the highest from all candidate collaborative users to form the anonymous set Set={A₁ . . . , Aᵢ, . . . , Aₖ}; and if a current size k of the anonymous set does not meet a privacy protection requirement of the requesting user, continuing to wait for the other network users to reply.

In the anonymous set generation phase, after the network user Pⱼ receives the collaboration request O_{P}_{₀} sent by the requesting user P₀ or after the requesting user P₀ receives the reply R_{P}_{ⱼ} sent by the network user, the correctness of the signature information and the comprehensive reputation value is verified to confirm authenticity of the identity and the comprehensive reputation value of the user.

Further, the transaction execution phase in step 2 includes:

(1) executing, by the requesting user P₀, a fund transfer transaction d₀(P₀ [symbol] A₁), and sending a transaction credential

$${V}_{{P}_{0}} = ( {Num}_{{d}_{0}}^{{P}_{0}} , {Sign}_{{P}_{0}} ( {Num}_{{d}_{0}}^{{P}_{0}} ) )$$

to the collaborative user A₁, where

$${Num}_{{d}_{0}}^{{P}_{0}}$$

represents a transaction number obtained after the requesting user P₀ executes d₀(P₀ [symbol] A₁); and sending a collaboration task

$${w}_{{P}_{0}}^{{A}_{i}} = ( M , Δ t , add ( {A}_{i + 1} ) , {Sign}_{{P}_{0}} ( M ‖ Δ t ‖ add ( {A}_{i + 1} ) ) )$$

to the collaborative user Aᵢ, where add(Aᵢ₊₁) represents a target address of a transaction to be executed by the collaborative user Aᵢ;

(2) after receiving the transaction credential

$${V}_{{P}_{0}} = ( {Num}_{{d}_{0}}^{{P}_{0}} , {Sign}_{{P}_{0}} ( {Num}_{{d}_{0}}^{{P}_{0}} ) )$$

sent by the requesting user P₀, verifying, by the collaborative user A₁, authenticity of the transaction credential:

1) if

$$Ver ( {Num}_{{d}_{0}}^{{P}_{0}} ) = 1 ,$$

verifying the signature information

$${Sign}_{{P}_{0}} ( {Num}_{{d}_{0}}^{{P}_{0}} ) ;$$

and

if

$$Ver ( {Sign}_{{P}_{0}} ( {Num}_{{d}_{0}}^{{P}_{0}} ) ) = {Sign}_{{P}_{0}} ( {Num}_{{d}_{0}}^{{P}_{0}} ) ,$$

indicating that an identity of and the transaction number transmitted by the requesting user P₀ are both true, broadcasting no information; or if

$$Ver ( {Sign}_{{P}_{0}} ( {Num}_{{d}_{0}}^{{P}_{0}} ) ) \neq {Sign}_{{P}_{0}} ( {Num}_{{d}_{0}}^{{P}_{0}} ) ,$$

indicating that an identity of the requesting user P₀ is forged, broadcasting information message_{A}_{₁}(¬P₀); or

2) if

$$Ver ( {Num}_{{d}_{0}}^{{P}_{0}} ) = 0 ,$$

indicating that the transaction number transmitted by the requesting user P₀ is not true or valid, broadcasting, by the collaborative user A₁, information

$${message}_{{A}_{1}} ( {}^{¬} {Num}_{{d}_{0}}^{{P}_{0}} )$$

without verifying the signature information

$${Sign}_{{P}_{0}} ( {Num}_{{d}_{0}}^{{P}_{0}} ) ;$$

and

immediately terminating, by the remaining collaborative users who receive the broadcast information message_{A}_{₁}(¬P₀) or message_{A}_{₁}(¬Num_{d}_{₀}^{P}^{₀}), a collaboration task related to the requesting user;

(3) after receiving the collaboration task

$${w}_{{P}_{0}}^{{A}_{i}} = ( M , Δ t , add ( {A}_{i + 1} ) , {Sign}_{{P}_{0}} ( M ‖ Δ t ‖ add ( {A}_{i + 1} ) ) )$$

send by the requesting user P₀, checking, by the collaborative user Aᵢ, whether the information message_{A}_{₁}(¬P₀) or message_{A}_{₁}(¬Num_{d}_{₀}^{P}^{₀}) exists; and if the information exists, terminating the collaboration task; or if the information does not exist, verifying correctness of the signature information Sign_{P}_{₀}(M∥Δt∥add(Aᵢ₊₁)) of the requesting user P₀ in the collaboration task

$${w}_{{P}_{0}}^{{A}_{i}} :$$

1) if Ver_{P}_{₀}(Sign_{P}_{₀}(M∥Δt∥add(Aᵢ₊₁)))=Sign_{P}_{₀}(M∥Δt∥add(Aᵢ₊₁)), indicating that an identity of the requesting user passes the verification, executing, by the collaborative user Aᵢ, a transaction dᵢ(Aᵢ [symbol] Aᵢ₊₁) based on content in the collaboration task

$${w}_{{P}_{0}}^{{A}_{i}} :$$

and after executing the transaction dᵢ(Aᵢ [symbol] Aᵢ₊₁), sending a collaboration credential

$${V}_{{A}_{i}} = ( {Num}_{{d}_{i}}^{{A}_{i}} , {Sign}_{{A}_{i}} ( {Num}_{{d}_{i}}^{{A}_{i}} ) )$$

to the requesting user P₀ to obtain remuneration for executing the anonymous transaction; or

2) if Ver_{P}_{₀}(Sign_{P}_{₀}(M∥Δt∥add(Aᵢ₊₁))≠Sign_{P}_{₀}(M∥Δt∥add(Aᵢ₊₁)), indicating that an identity of the requesting user P₀ is forged, refusing, by the collaborative user Aᵢ, to execute the collaboration task, and broadcasting information message_{A}_{ᵢ}(¬P₀); where

execution of an actual transaction D(P₀→S) of the requesting user is completed only after all collaborative users Aᵢ in the anonymous set execute the transaction dᵢ, that is, ∀Aᵢ∈Set, Aᵢ has executed dᵢ(Aᵢ [symbol] Aᵢ₊₁)⇔D(P₀→S) is completed;

(4) after receiving the collaboration credential

$${V}_{{A}_{i}} = ( {Num}_{{d}_{i}}^{{A}_{i}} , {Sign}_{{A}_{i}} ( {Num}_{{d}_{i}}^{{A}_{i}} ) )$$

sent by the collaborative user Aᵢ, verifying, by the requesting user P₀, the collaboration credential:

1) if

$$Ver ( {Num}_{{d}_{i}}^{{A}_{i}} ) = 1 ,$$

verifying the signature information

$${Ver}_{{A}_{i}} ( {Sign}_{{A}_{i}} ( {Num}_{{d}_{i}}^{{A}_{i}} ) ) ;$$

and

if

$${Ver}_{{A}_{i}} ( {Sign}_{{A}_{i}} ( {Num}_{{d}_{i}}^{{A}_{i}} ) ) = {Sign}_{{A}_{i}} ( {Num}_{{d}_{i}}^{{A}_{i}} ) ,$$

indicating that a transaction number transmitted by the collaborative user Aᵢ is true and valid and an identity of the collaborative user passes the verification, executing, by the requesting user, a remuneration transaction

$${f}_{i} = ( {P}_{0} {\to }^{{O}_{{A}_{i}}} {A}_{i} ) ,$$

and sending a payment credential

$${\tilde{V}}_{{P}_{0}}^{{A}_{i}} = ( {Num}_{{f}_{i}}^{{P}_{0}} , {Sign}_{{P}_{0}} ( {Num}_{{f}_{i}}^{{P}_{0}} ) )$$

to the collaborative user Aᵢ; or

if

$${Ver}_{{A}_{i}} ( {Sign}_{{A}_{i}} ( {Num}_{{d}_{i}}^{{A}_{i}} ) ) \neq {Sign}_{{A}_{i}} ( {Num}_{{d}_{i}}^{{A}_{i}} ) ,$$

indicating that an identity of the collaborative user Aᵢ is forged, broadcasting information message_{P}_{₀}(¬Aᵢ); or

2) if

$$Ver ( {Num}_{{d}_{i}}^{{A}_{i}} ) = 0 ,$$

indicating that a transaction number transmitted by the collaborative user Aᵢ is not true or valid, broadcasting, by the requesting user P₀, information

$${message}_{{P}_{0}} ( ¬ {Num}_{{d}_{i}}^{{A}_{i}} )$$

without verifying the signature information

$${Sign}_{{A}_{i}} ( {Num}_{{d}_{i}}^{{A}_{i}} ) ;$$

and

if the anonymous transaction is successfully completed but the collaborative user Aᵢ does not finish executing the transaction within a time period Δt specified by the requesting user, broadcasting information message_{P}_{₀}(¬Δt_{A}_{ᵢ}); if a collaborative user in the anonymous set does not execute the transaction, indicating that the execution of the actual transaction D(P₀→S) of the requesting user is not completed, that is, ∃Aᵢ∈Set, Aᵢ was not executed dᵢ(Aᵢ [symbol] Aᵢ₊₁)⇔D(P₀→S) is not completed, broadcasting, by the requesting user, a collaborative user who fails verification or even does not send a collaboration credential; and

(5) after receiving the payment credential

$${\tilde{V}}_{{P}_{o}}^{{A}_{i}} = ( {Num}_{{f}_{i}}^{{P}_{0}} , {Sign}_{{P}_{0}} ( {Num}_{{f}_{i}}^{{P}_{0}} ) )$$

sent by the requesting user P₀, responding, by the collaborative user Aᵢ, based on whether the corresponding remuneration is received: if the collaborative user Aᵢ does not receive anonymous transaction remuneration O_{A}_{ᵢ} paid by the requesting user, broadcasting information

$${message}_{{A}_{i}} ( ¬ {Num}_{{f}_{i}}^{{P}_{0}} ) ,$$

and ending an anonymous transaction process.

Further, the reputation update phase in step 3 includes:

storing information message(·) through a blockchain, jointly verifying, by all nodes in the blockchain, the information by using a consensus characteristic of blockchain nodes, and storing message(·) that passes the verification as reputation evaluation evidence in a block.

A set of the bad user behavior defined in the anonymous set generation phase and the transaction is execution phase is Act={message(¬Δt), message(¬mes), message(¬P), message(¬X), message(¬Num)}. message(¬Δt) indicates that the collaborative user does not finish executing the transaction within the specified time period. message(¬mes) indicates that the user maliciously broadcasts information. message(¬P) indicates that an identity of the user fails verification. message(¬X) indicates that a comprehensive reputation value of the user fails verification. message(¬Num) indicates that a transaction number transmitted by the requesting user or the collaborative user is not true or valid, that is, the requesting user does not transfer anonymous transaction funds, the collaborative user does not execute the anonymous transaction, or the requesting user does not pay remuneration to the collaborative user.

An incentive factor p and a penalty factor n are set to be constant. α_{P}^{t} increases by 1 when a user honestly participates in an anonymous transaction as a collaborative user. However, a cumulative quantity of times of β_{P}^{t} is determined based on impact of bad behavior of the user on the anonymous transaction. message(¬Δt) has minimum impact because the collaborative user honestly executes the anonymous transaction but does not finish executing the anonymous transaction within a time period given by the requesting user, and is regarded as one time of bad behavior. message(¬mes) indicates that the user maliciously slanders another user and is regarded as two times of bad behavior. The bad behavior message(¬P) or message(¬X) has relatively small impact because the bad behavior occurs before the anonymous set is generated, the requesting user has not paid an anonymous transaction amount, and the collaborative user has not executed the anonymous transaction, and is regarded as two times of bad behavior. The bad behavior message(¬Num) has large impact because the bad behavior occurs in a process of executing the anonymous transaction, and is regarded as three times of bad behavior; and

An instantaneous reputation value X_{P}_{₀}(t) of the requesting user, an instantaneous reputation value X_{P}_{ⱼ}(t) of a network user, and an instantaneous reputation value X_{A}_{ᵢ}(t) of the collaborative user are respectively calculated through a formula

$${χ}_{{P}_{0}} ( t ) = max ( 0 , {χ}_{{P}_{0}} ( t - 1 ) - n * \frac{{β}_{{P}_{0}}^{t}}{{α}_{{P}_{0}}^{t} + {β}_{{P}_{0}}^{t}} )$$

for calculating the instantaneous reputation value of the requesting user, a formula

$${χ}_{{P}_{j}} ( t ) = max ( 0 , {χ}_{{P}_{j}} ( t - 1 ) - n * \frac{{β}_{{P}_{j}}^{t}}{{α}_{{P}_{j}}^{t} + {β}_{{P}_{j}}^{t}} )$$

for calculating the instantaneous reputation value of the network user, and a formula

$${χ}_{{A}_{i}} ( t ) = \{ \begin{matrix}min ( 1 , {χ}_{{A}_{i}} ( t - 1 ) + p * \frac{{α}_{{A}_{i}}^{t}}{{α}_{{A}_{i}}^{t} + {β}_{{A}_{i}}^{t}} ) \\ max ( 0 , {χ}_{{A}_{i}} ( t - 1 ) - n * \frac{{β}_{{A}_{i}}^{t}}{{α}_{{A}_{i}}^{t} + {β}_{{A}_{i}}^{t}} )\end{matrix}$$

for calculating the instantaneous reputation value of the collaborative user in the reputation evaluation model, and uploaded to the blockchain to update the reputation values of the users.

Another objective of the present disclosure is to provide a system for protecting location privacy in mobile payment, using the method for protecting location privacy in mobile payment and including:
an anonymous set generation module, configured to describe a mutual relationship between users from a perspective of a supply-demand relationship, and generate an anonymous set for a requesting user through a double auction mechanism;
a transaction execution module, configured to execute an anonymous transaction based on an anonymous transaction model; and
a reputation update module, configured to update reputations of the users based on a reputation evaluation scheme and bad user behavior defined in an anonymous set generation phase and a transaction execution phase.

Another objective of the present disclosure is to provide a computer device. The computer device includes a memory and a processor. The memory stores a computer program. The computer program, when executed by the processor, enables the processor to perform steps of the method for protecting location privacy in mobile payment.

Another objective of the present disclosure is to provide a computer-readable storage medium, storing a computer program. The computer program, when executed by a processor, enables the processor to perform steps of the method for protecting location privacy in mobile payment.

Another objective of the present disclosure is to provide an information data processing terminal. The information data processing terminal is configured to implement the system for protecting location privacy in mobile payment.

In combination with the foregoing technical solutions and the technical problems to be resolved, the technical solutions provided in the present disclosure have the following advantages and positive effects:

Firstly, in view of the foregoing technical problems in the prior art and difficulties in resolving the problems, in close combination with the technical solutions provided in the present disclosure and results, data, and the like in research and development processes, detailed and profound analysis is made on how to resolve the technical problems through the technical solutions of the present disclosure and some creative technical effects after the problems are resolved. The specific description is as follows:

Mobile payment has quickly become a mainstream payment method in society with its own convenience. However, because a mobile payment platform grasps a large amount of user transaction information and store location information, the platform can determine a specific consumption location of a user. Therefore, when users enjoy the convenience of mobile payment, there are leakage risks of location privacy. However, location privacy protection technologies for mobile payment are quite scarce. Most of existing location privacy protection methods are oriented toward LBS scenarios and are not suitable for mobile payment environments. To resolve the problem, the present disclosure introduces the decentralized coin mixing idea into mobile payment, and inserts the anonymous set constructed by the collaborative users between the user and the merchant to cut off the direct transaction association between the user and the merchant and implement transaction anonymization. This further disturbs a mapping relationship between the user and the consumption location thereof, and protects location information security of the user. In addition, in view of a deficiency of an existing decentralized coin mixing scheme in generating an anonymous set, the anonymous transaction scheme based on reputation evaluation and a double auction is designed in the present disclosure to resolve a problem of lack of trust commonly existing in decentralized structures. The present disclosure can help the requesting user construct the anonymous set that meets the privacy requirement and the reputation requirement of the requesting user while effectively promoting users to participate in anonymous transactions, to improve transaction anonymity and practicability of the scheme. Theoretical analysis and experimental results both show that the scheme for protecting location privacy in mobile payment proposed in the present disclosure can implement both anonymity and practicality, and effectively protect location privacy and security of mobile payment users.

In the present disclosure, the anonymous transaction model in the mobile payment environment is constructed based on the decentralized coin mixing idea. The anonymous set constructed by the collaborative users is introduced to help the user complete account payment, to cut off a direct transaction association between the user and the merchant, implement transaction anonymization of mobile payment, and protect user location information security. The present disclosure proposes the anonymous transaction scheme based on reputation evaluation and a double auction and provides the user reputation evaluation model. A relationship chain is established among user behavior, user reputations, and user profits and losses. If the user has bad behavior, the reputation value of the user is reduced. The lower the reputation value, the more difficult it is for the collaborative user to obtain the collaboration task in the double auction. Even if the task is completed, less remuneration can be obtained. When the collaborative user serves as a requesting user, it is difficult to generate an anonymous set through a double auction. Even if the anonymous set is generated, higher fees need to be paid to a collaborative user who provides help. Therefore, the anonymous transaction scheme proposed in the present disclosure can improve participation enthusiasm and honesty of users, help the requesting user construct the anonymous set that meets the privacy requirement, the reputation requirement, and the bid standard of the requesting user, and improve transaction anonymity, to effectively protect location information security of the users.

In view of a problem that location privacy leakage of mobile payment users cannot be resolved in the prior art, the anonymous transaction model in the mobile payment environment is constructed based on the decentralized coin mixing idea in the present disclosure. Location privacy and security of users is protected by implementing transaction anonymization. However, in the existing decentralized coin mixing scheme, because reputations of the collaborative users are not measured when the anonymous set is constructed, the final generated anonymous set may include low-reputation collaborative users. Existence of the low-reputation collaborative user increases leakage risks of the requesting user's information, greatly reduces transaction anonymity, and even exposes actual transaction information of the requesting user. Therefore, the existing decentralized coin mixing scheme cannot effectively protect location privacy of mobile payment users. To resolve the problem, the present disclosure first proposes the user reputation evaluation scheme to help the requesting user identify the low-reputation collaborative users and avoid selecting such collaborative users to construct the anonymous set. Then, the anonymous transaction scheme based on reputation evaluation and a double auction is proposed to promote users to actively participate in anonymous transactions and honestly execute collaboration tasks by establishing the relationship between the user reputation and the auction bid. A double auction is used to help the requesting user construct the anonymous set that meets the privacy requirement, the reputation requirement, and the bid standard of the requesting user. This improves anonymity of the requesting user's transaction and effectively resolves the location privacy leakage problem caused by exposure of transaction information of the requesting user. It can be found from theoretical analysis of the scheme and a large quantity of experimental results that the present disclosure can not only efficiently help the requesting user generate the anonymous set, but also improve transaction anonymity and protect location privacy and security of users.

Secondly, the technical solutions are considered as a whole or from the perspective of a product, and technical effects and advantages of the technical solutions provided in the present disclosure are specifically described as follows:

The present disclosure is the first location privacy protection scheme proposed for the mobile payment environment, innovatively introduces the decentralized coin mixing idea into the mobile payment environment, proposes that a physical relation between the user and the consumption location thereof is removed through the anonymous transaction such that the mobile payment platform cannot speculate, through information already grasped, who is the user who consumes at the store location, to protect location information security of mobile payment users. To resolve the deficiency of the existing decentralized coin mixing scheme in constructing the anonymous set, the anonymous transaction scheme based on reputation evaluation and a double auction is designed in the present disclosure to resolve a problem of lack of trust commonly existing in distributed system structures. While users are effectively promoted to participate in anonymous transactions, user behavior is restricted, and anonymity and practicability of the scheme are improved. Theoretical analysis and experimental results both show that the privacy protection scheme proposed in the present disclosure can implement both anonymity and practicality, and effectively protect location privacy of mobile payment users.

Thirdly, auxiliary evidence for inventiveness of claims of the present disclosure is further reflected in important aspects as follows:

(1) The expected profits and commercial value of the technical solutions of the present disclosure after transformation are as follow:

At present, mobile payment has become the mainstream payment method in the current society. According to the latest data released by China Internet Network Information Center (CNNIC) and People's Bank of China, by December 2022, a quantity of online payment users in China has reached 911 million, with a total of 158.507 billion mobile payment transactions and a total transaction amount of 499.62 trillion yuan. Apparently, mobile payment has become the most commonly used means of payment in people's daily lives. In addition, people's awareness and demand for personal privacy protection are growing with promulgation and implementation of the Personal Information Protection Law of the People's Republic of China, the Data Security Law, and the Regulations on the Security Protection of Critical Information Infrastructure. Therefore, a potential location privacy leakage issue in the mobile payment environment has received widespread attention, which is one of key issues restricting sustainable and healthy development of the mobile payment industry. The present disclosure can effectively protect location privacy and security of a user when mobile payment is used, can be widely used in the mobile payment industry, and has high expected profits and commercial value.

(2) The technical solutions of the present disclosure fill the technical gap in the industry throughout the world:

The technical solutions provided in the present disclosure fills a gap of a location privacy protection technology in the mobile payment field around the world, breaks through defects and deficiencies in the existing anonymous transaction scheme, and provides an effective solution to the location privacy leakage problem of mobile payment users. In the present disclosure, the anonymous transaction model in the mobile payment environment is constructed based on the decentralized coin mixing idea. Location privacy and security of users is protected by implementing transaction anonymization. In addition, in view of the deficiency of the existing decentralized coin mixing scheme in constructing the anonymous set, the anonymous transaction scheme based on reputation evaluation and a double auction is designed in the present disclosure to resolve the problem of lack of trust in a distributed system architecture. The method can effectively promote users to participate in anonymous transactions, restrict user behavior, improve anonymity and practicability of the scheme, and effectively protect location privacy and security of mobile payment users.

(3) The technical solutions of the present disclosure resolve the technical problems that people have been eager to resolve but have not been successfully resolved:

Anonymous cryptocurrency relies on the complex cryptography technology, making overall efficiency of the scheme low. The centralized coin mixing scheme with the introduction of a third-party mixing server has the problems of a single point of failure and a performance bottleneck. In contrast, the decentralized coin mixing scheme has advantages of simple deployment and good performance. However, although a corresponding accountability mechanism is designed in the existing decentralized coin mixing scheme to restrict behavior of nodes, credibility of the nodes is not measured when an anonymous set is constructed. If a node with low credibility is introduced to participate in coin mixing, risks of the node maliciously leaking user information increase. This reduces anonymity of the scheme. Therefore, in view of the problem that the existing anonymous transaction schemes cannot effectively implement anonymous transactions of mobile payment users, in the present disclosure, the user reputation evaluation scheme is first designed, and the functional relationship between the historical behavior of the user and the reputation value of the user is established. The anonymous set generation scheme based on reputation evaluation and a double auction is proposed to help the user select collaborative users with high reputations and low bids to construct the anonymous set. The present disclosure uses the foregoing method to help the requesting user construct the anonymous set that meets the privacy requirement, the reputation requirement, and the bid standard of the requesting user, restrict behavior of collaborative users when the collaborative users participating in anonymous transactions, and improve anonymity and practicability of the scheme, to effectively protect location privacy of mobile payment users.

(4) The technical solutions of the present disclosure overcome the following technical prejudice:

The existing decentralized coin mixing schemes consider possible bad behavior of users when the users participating in anonymous transactions, and design a corresponding accountability mechanism. However, because the reputations of the collaborative users are not evaluated when the anonymous set is constructed, the final generated anonymous set still includes low-reputation collaborative users. This increases the the risk of malicious leakage of user transaction information and reduces the anonymity of the scheme. In the present disclosure, the user reputation evaluation scheme is first designed, and the functional relationship between the historical behavior of the user and the reputation value of the user is established. A relationship between user reputations and user profits and losses is established in the auction mechanism. If a user has bad behavior, a reputation value of the user is reduced. The lower the reputation value, the more difficult it is for a collaborative user to obtain a collaboration task in the double auction. Even if the task is completed, less remuneration can be obtained. When the collaborative user serves as a requesting user, it is difficult to generate an anonymous set through a double auction. Even if the anonymous set is generated, higher fees need to be paid to a collaborative user who provides help. Therefore, the scheme proposed in the present disclosure can improve participation enthusiasm and honesty of users, help the requesting user construct the anonymous set that meets the privacy requirement, the reputation requirement, and the bid standard of the requesting user, and improve transaction anonymity, to effectively protect location information security of the users.

### BRIEF DESCRIPTION OF THE DRAWINGS

To more clearly describe the technical solutions in the embodiments of the present disclosure, a brief introduction to the accompanying drawings required for the embodiments will be provided below. Apparently, the accompanying drawings in the following description show merely some embodiments of the present disclosure. Those of ordinary skill in the art may still derive other drawings from these accompanying drawings without creative efforts.

FIG. 1 is a flowchart of a method for protecting location privacy in mobile payment according to an embodiment of the present disclosure;

FIG. 2 is a principle diagram of an anonymous transaction based on reputation evaluation and a double auction according to an embodiment of the present disclosure;

FIG. 3 is an information interaction diagram of a system for protecting location privacy in mobile payment according to an embodiment of the present disclosure;

FIG. 4 is a schematic diagram of an anonymous transaction model according to an embodiment of the present disclosure;

FIG. 5 is a schematic diagram of an anonymous set generation phase according to an embodiment of the present disclosure;

FIG. 6 is a schematic diagram of a transaction execution phase according to an embodiment of the present disclosure;

FIG. 7 is a schematic diagram of an average computation delay required to generate an anonymous set according to an embodiment of the present disclosure;

FIG. 8 is a schematic diagram of an average communication overhead required to generate an anonymous set according to an embodiment of the present disclosure;

FIG. 9 is a schematic diagram of an average communication overhead required for transaction execution according to an embodiment of the present disclosure;

FIG. 10 is a diagram of impact of a quantity of users in a network on a success rate of generating an anonymous set according to an embodiment of the present disclosure; and

FIG. 11 is a diagram of impact of an automatic response condition on a success rate of generating an anonymous set according to an embodiment of the present disclosure.

### DETAILED DESCRIPTION OF THE EMBODIMENTS

To make the objectives, technical solutions, and advantages of the present disclosure clearer and more comprehensible, the present disclosure will be further described below in detail in conjunction with embodiments. It should be understood that the specific embodiments described herein are only intended to explain the present disclosure and are not intended to limit the present disclosure.

In view of the problems in the prior art, the present disclosure provides a method and system for protecting location privacy in mobile payment, a medium, a device, and a terminal.

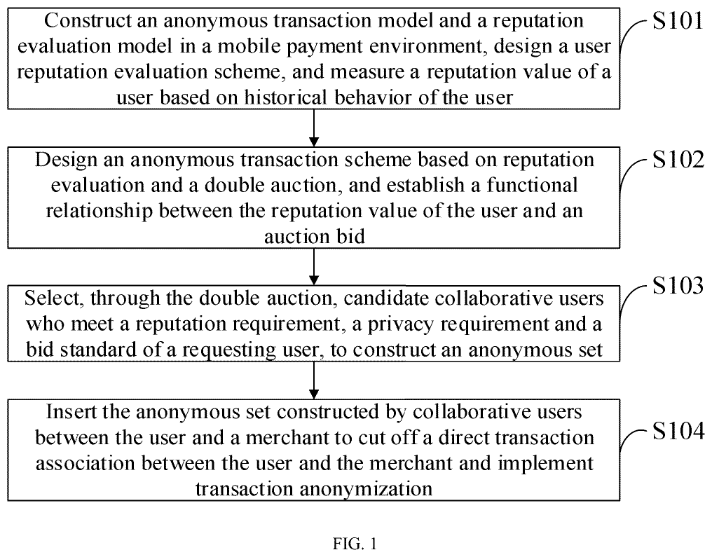

As shown in FIG. 1, the method for protecting location privacy in mobile payment provided in the embodiments of the present disclosure includes the following steps:

S101: An anonymous transaction model and a reputation evaluation model in a mobile payment environment are constructed, a user reputation evaluation scheme is designed, and a reputation value of a user is measured based on historical behavior of the user.

S102: An anonymous transaction scheme based on reputation evaluation and a double auction is designed, and a functional relationship between the reputation value of the user and an auction bid is established.

S103: Candidate collaborative users who meet a reputation requirement, a privacy requirement and a bid standard of a requesting user are selected through the double auction to construct an anonymous set.

S104: The anonymous set constructed by collaborative users is inserted between the user and a merchant to cut off a direct transaction association between the user and the merchant and implement transaction anonymization.

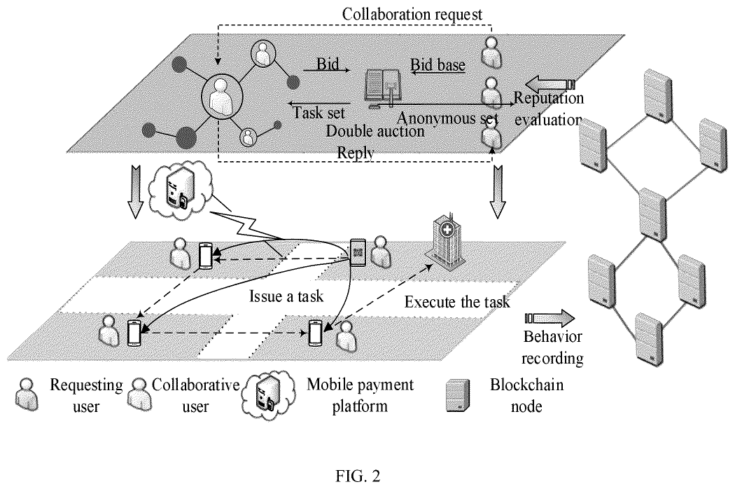

As a preferred embodiment, as shown in FIG. 2, the method for protecting location privacy in mobile payment provided in the embodiments of the present disclosure specifically includes the following steps:

Step 1: In an anonymous set generation phase, a mutual relationship between users is described from a perspective of a supply-demand relationship, and the anonymous set is generated for the requesting user through a double auction mechanism in the present disclosure.

Step1: Before executing a mobile payment transaction, the requesting user P₀ broadcasts a collaboration request Q_{P}_{₀}=(X_{P}_{₀}, M, Δt, O_{P}_{₀}, Sign_{P}_{₀}(X_{P}_{₀}∥M∥Δt∥O_{P}_{₀})) to the other users in a network. Sign(·) is a secure signature function. Sign_{P}_{₀}(X_{P}_{₀}∥M∥Δt∥O_{P}_{₀}) indicates that the requesting user P₀ signs information, such as a comprehensive reputation value, a transaction amount, and an acceptable task execution delay, of the requesting user by using a private key of the requesting user.

Step2: After receiving the collaboration request Q_{P}_{₀}(X_{P}_{₀}, M, Δt, O_{P}_{₀}, Sign_{P}_{₀}(X_{P}_{₀}∥M∥Δt∥O_{P}_{₀}) sent by the requesting user P₀, the network user Pⱼ verifies correctness of the signature information Sign_{P}_{₀}(X_{P}_{₀}∥M∥Δt∥O_{P}_{₀}) and the comprehensive reputation value X_{P}_{₀} of the requesting user P₀ in the collaboration request Q_{P}_{₀}:

(1) If Ver_{P}_{₀}(Sign_{P}_{₀}(X_{P}_{₀}∥M∥Δt∥O_{P}_{₀})=Sign_{P}_{₀}(X_{P}_{₀}∥M∥Δt∥O_{P}_{₀}), indicating that an identity of the requesting user passes the verification, the network user verifies the comprehensive reputation value X_{P}_{₀} of the requesting user.

If

$$Ver ( {χ}_{{P}_{0}} ) = {\sum }_{T - Γ < t \leq T} ( {χ}_{{P}_{0}} ( t ) * \frac{ω ( {χ}_{{P}_{0}} ( t ) )}{{\sum }_{T - Γ < t \leq T} ω ( {χ}_{{P}_{0}} ( t ) )} ) ,$$

indicating that the identity and the comprehensive reputation value of the requesting user both pass the verification, the network user may determine, based on a bid base O_{P}_{₀} given by and the comprehensive reputation value X_{P}_{₀} of the requesting user, whether to accept the collaboration request. If the network user Pⱼ accepts the collaboration request of the requesting user P₀, the network user sends a reply R_{P}_{ⱼ}=(X_{P}_{ⱼ}, O_{P}_{ⱼ}, add(Pⱼ), Sign_{P}_{ⱼ}(X_{P}_{ⱼ}∥O_{P}_{ⱼ}∥add(Pⱼ))) to the requesting user P₀. add(Pⱼ) is an account address of the network user Pⱼ. Otherwise, the network user does not respond. The network user may accept collaboration requests of a plurality of requesting users based on a capability of the network user, to form a to-be-executed task set W_{P}_{ⱼ}={w₁, w₂, . . . , wₙ}.

If

$$Ver ( {χ}_{{P}_{0}} ) \neq {\sum }_{T - Γ < t \leq T} ( {χ}_{{P}_{0}} ( t ) * \frac{ω ( {χ}_{{P}_{0}} ( t ) )}{{\sum }_{T - Γ < t \leq T} ω ( {χ}_{{P}_{0}} ( t ) )} ) ,$$

indicating that the comprehensive reputation value of the requesting user fails the verification, the network user Pⱼ broadcasts information message_{P}_{ⱼ}(¬X_{P}_{₀}).

(2) If Ver_{P}_{₀}(Sign_{P}_{₀}(X_{P}_{₀}∥M∥Δt∥O_{P}_{₀})≠Sign_{P}_{₀}(X_{P}_{₀}∥M∥Δt∥O_{P}_{₀}), indicating that an identity of the requesting user fails the verification, the network user Pⱼ may broadcast information message_{P}_{ⱼ}(¬P₀) without verifying the comprehensive reputation value X_{P}_{₀} of the requesting user.

Ver(·) is a verification function. Ver_{P}_{₀}(Sign_{P}_{₀}(X_{P}_{₀}∥M∥Δt∥O_{P}_{₀}) indicates verification of correctness of the signature information Sign_{P}_{₀}(X_{P}_{₀}∥M∥Δt∥O_{P}_{₀}) by using a public key of the requesting user P₀. If the verification fails, Sign_{P}_{₀}(X_{P}_{₀}∥M∥Δt∥O_{P}_{₀}) is not a signature generated through encryption performed by using the private key of P₀, and the identity of the requesting user is likely to be forged.

Step3: The requesting user P₀ verifies correctness of the reply R_{P}_{ⱼ}=(X_{P}_{ⱼ}, O_{P}_{ⱼ}, add(Pⱼ), Sign_{P}_{ⱼ}(X_{P}_{_{j∥O}}_{P}_{ⱼ}∥add(Pⱼ))) of the network user Pⱼ.

(1) If Ver_{P}_{ⱼ}(Sign_{P}_{ⱼ}(X_{P}_{ⱼ}∥O_{P}_{ⱼ}∥add(Pⱼ)))=Sign_{P}_{ⱼ}(X_{P}_{ⱼ}∥O_{P}_{ⱼ}∥add(Pⱼ)), indicating that an identity of the network user passes the verification, the requesting user verifies a comprehensive reputation value of the network user.

If

$$Ver ( {χ}_{{P}_{j}} ) = {\sum }_{T - Γ < t \leq T} ( {χ}_{{P}_{j}} ( t ) * \frac{ω ( {χ}_{{P}_{j}} ( t ) )}{{\sum }_{T - Γ < t \leq T} ω ( {χ}_{{P}_{j}} ( t ) )} ) ,$$

indicating that the comprehensive reputation value of the network user also passes the verification, the requesting user takes the network user Pⱼ as a candidate collaborative user.

If

$$Ver ( {χ}_{{P}_{j}} ) \neq {\sum }_{T - Γ < t \leq T} ( {χ}_{{P}_{j}} ( t ) * \frac{ω ( {χ}_{{P}_{j}} ( t ) )}{{\sum }_{T - Γ < t \leq T} ω ( {χ}_{{P}_{j}} ( t ) )} ) ,$$

indicating that the comprehensive reputation value of the network user fails the verification, the requesting user P₀ broadcasts information message_{P}_{₀}(¬X_{P}_{ⱼ}).

(2) If Ver_{P}_{ⱼ}(Sign_{P}_{ⱼ}(X_{P}_{ⱼ}∥O_{P}_{ⱼ}∥add(Pⱼ))≠Sign_{P}_{ⱼ}(X_{P}_{ⱼ}∥O_{P}_{ⱼ}∥add(Pⱼ)), indicating that an identity of the network user fails the verification, the requesting user P₀ broadcasts information message_{P}_{₀}(¬Pⱼ) without verifying the comprehensive reputation value X_{P}_{ⱼ} of the network user.

Step4: The requesting user P₀ ranks the candidate collaborative user in ascending order of the comprehensive reputation value X_{P}_{ⱼ} and in descending order of a bid O_{P}_{ⱼ} to obtain a comprehensive reputation value ranking N_{X}(Pⱼ) and a bid ranking N_{O}(Pⱼ) of the candidate collaborative user Pⱼ, where a comprehensive ranking of the candidate collaborative user is N(Pⱼ)=N_{X}(Pⱼ)+N_{O}(Pⱼ); selects k users whose comprehensive ranking N(Pⱼ) is the highest from all candidate collaborative users to form the anonymous set Set={A₁ . . . , Aᵢ, . . . , Aₖ}; and if a current size k of the anonymous set does not meet a privacy protection requirement of the requesting user, continues to wait for the other network users to reply.

In the anonymous set generation phase, after the network user Pⱼ receives the collaboration request Q_{P}_{₀} sent by the requesting user P₀ or after the requesting user P₀ receives the reply R_{P}_{ⱼ} sent by the network user, a main purpose of verifying the correctness of the signature information and the comprehensive reputation value is to confirm authenticity of the identity and the comprehensive reputation value of the user, that is, to prevent malicious users from forging identities of others or tampering with their own reputation values.

Step 2: In a transaction execution phase, an anonymous transaction is executed based on the anonymous transaction model, which specifically includes:

Step1: The requesting user P₀ executes a fund transfer transaction d₀(P₀ [symbol] A₁) and sends a transaction credential

$${V}_{{P}_{0}} = ( {Num}_{{d}_{0}}^{{P}_{0}} , {Sign}_{{P}_{0}} ( {Num}_{{d}_{0}}^{{P}_{0}} ) )$$

to the collaborative user A₁, where

$${Num}_{{d}_{0}}^{{P}_{0}}$$

represents a transaction number obtained after the requesting user P₀ executes d₀(P₀ [symbol] A₁); and sends a collaboration task

$${w}_{{P}_{0}}^{{A}_{i}} = ( M , Δ t , add ( {A}_{i + 1} ) , {Sign}_{{P}_{0}} ( M ‖ Δ t ‖ add ( {A}_{i + 1} ) ) )$$

to the collaborative user Aᵢ. add(Aᵢ₊₁) represents a target address of a transaction to be executed by the collaborative user Aᵢ.

Step2: After receiving the transaction credential

$${V}_{{P}_{0}} = ( {Num}_{{d}_{0}}^{{P}_{0}} , {Sign}_{{P}_{0}} ( {Num}_{{d}_{0}}^{{P}_{0}} ) )$$

sent by the requesting user P₀, the collaborative user A₁ verifies authenticity of the transaction credential:

(1) If

$$Ver ( {Num}_{{d}_{0}}^{{P}_{0}} ) = 1 ,$$

the collaborative user verifies the signature information

$${Sign}_{{P}_{0}} ( {Num}_{{d}_{0}}^{{P}_{0}} ) .$$

If

$$Ver ( {Sign}_{{P}_{0}} ( {Num}_{{d}_{0}}^{{P}_{0}} ) ) = {Sign}_{{P}_{0}} ( {Num}_{{d}_{0}}^{{P}_{0}} ) ,$$

indicating that an identity of and the transaction number transmitted by the requesting user P₀ are both true, the collaborative user broadcasts no information; or if

$$Ver ( {Sign}_{{P}_{0}} ( {Num}_{{d}_{0}}^{{P}_{0}} ) ) \neq {Sign}_{{P}_{0}} ( {Num}_{{d}_{0}}^{{P}_{0}} ) ,$$

indicating that an identity of the requesting user P₀ is forged, the collaborative user broadcasts information message_{A}_{₁}(¬P₀).

(2) If

$$Ver ( {Num}_{{d}_{0}}^{{P}_{0}} ) = 0 ,$$

indicating that the transaction number transmitted by the requesting user P₀ is not true or valid, the collaborative user A₁ broadcasts information

$${message}_{{A}_{1}} ( {}_{}^{¬} {Num}_{{d}_{0}}^{{P}_{0}} )$$

without verifying the signature information

$${Sign}_{{P}_{0}} ( {Num}_{{d}_{0}}^{{P}_{0}} ) .$$

The remaining collaborative users who receive the broadcast information message_{A}_{₁}(¬P₀) or

$${message}_{{A}_{1}} ( {}_{}^{¬} {Num}_{{d}_{0}}^{{P}_{0}} )$$

may immediately terminate a collaboration task related to the requesting user.

Step3: After receiving the collaboration task

$${w}_{{P}_{0}}^{{A}_{i}} = ( M , Δ t , add ( {A}_{i + 1} ) , {Sign}_{{P}_{0}} ( M ‖ Δ t ‖ add ( {A}_{i + 1} ) ) )$$

sent by the requesting user P₀, the collaborative user Aᵢ checks whether the information message_{A}_{₁}(¬P₀) or

$${message}_{{A}_{1}} ( {}_{}^{¬} {Num}_{{d}_{0}}^{{P}_{0}} )$$

exists; and if the information exits, terminates the collaboration task; or if the information does not exist, verifies correctness of the signature information Sign_{P}_{₀}(M∥Δt∥add(Aᵢ₊₁)) of the requesting user P₀ in the collaboration task

$${w}_{{P}_{0}}^{{A}_{i}} :$$

(1) If Ver_{P}_{₀}(Sig_{P}_{₀}(M∥Δt∥add(Aᵢ₊₁)))=Sign_{P}_{₀}(M∥Δt∥add(Aᵢ₊₁)), indicating that an identity of the requesting user passes the verification, the collaborative user Aᵢ executes a transaction dᵢ(Aᵢ [symbol] Aᵢ₊₁) based on content in the collaboration task

$${w}_{{P}_{0}}^{{A}_{i}} ;$$

and after executing the transaction dᵢ(Aᵢ [symbol] Aᵢ₊₁), sends a collaboration credential

$${V}_{{A}_{i}} = ( {Num}_{{d}_{i}}^{{A}_{i}} , {Sign}_{{A}_{i}} ( {Num}_{{d}_{i}}^{{A}_{i}} ) )$$

to the requesting user P₀ to obtain remuneration for executing the anonymous transaction.

(2) If Ver_{P}_{₀}(Sign_{P}_{₀}(M∥Δt∥add(Aᵢ₊₁1)))≠Sign_{P}_{₀}(M∥Δt∥add(Aᵢ₊₁1)), indicating that an identity of the requesting user P₀ is forged, the collaborative user Aᵢ refuses to execute the collaboration task, and broadcasts information message_{A}_{ᵢ}(¬P₀).

Execution of an actual transaction D(P₀→S) of the requesting user is completed only after all collaborative users Aᵢ in the anonymous set execute the transaction dᵢ. That is, ∀Aᵢ∈Set, Aᵢ has executed dᵢ(Aᵢ [symbol] Aᵢ₊₁)⇔D(P₀ΔS) is completed.

Step4: After receiving the collaboration credential

$${V}_{{A}_{i}} = ( {Num}_{{d}_{i}}^{{A}_{i}} , {Sign}_{{A}_{i}} ( {Num}_{{d}_{i}}^{{A}_{i}} ) )$$

sent by the collaborative user Aᵢ, the requesting user P₀ verifies the collaboration credential:

(1) If

$$Ver ( {Num}_{{d}_{i}}^{{A}_{i}} ) = 1 ,$$

the requesting user verifies the signature information

$${Ver}_{{A}_{i}} ( {Sign}_{{A}_{i}} ( {Num}_{{d}_{i}}^{{A}_{i}} ) ) .$$

If

$${Ver}_{{A}_{i}} ( {Sign}_{{A}_{i}} ( {Num}_{{d}_{i}}^{{A}_{i}} ) ) = {Sign}_{{A}_{i}} ( {Num}_{{d}_{i}}^{{A}_{i}} ) ,$$

indicating that a transaction number transmitted by the collaborative user Aᵢ is true and valid and an identity of the collaborative user passes the verification, the requesting user executes a remuneration transaction

$${f}_{i} = ( {P}_{0} {\to }^{{O}_{{A}_{i}}} {A}_{i} )$$

and sends a payment credential

$${\tilde{V}}_{{P}_{0}}^{{A}_{i}} = ( {Num}_{{f}_{i}}^{{P}_{0}} , {Sign}_{{P}_{0}} ( {Num}_{{f}_{i}}^{{P}_{0}} ) )$$

to the collaborative user Aᵢ.

If

$${Ver}_{{A}_{i}} ( {Sign}_{{A}_{i}} ( {Num}_{{d}_{i}}^{{A}_{i}} ) ) \neq {Sign}_{{A}_{i}} ( {Num}_{{d}_{i}}^{{A}_{i}} ) ,$$

indicating that an identity of the collaborative user Aᵢ is forged, the requesting user broadcasts information message_{P}_{₀}(¬Aᵢ).

(2) If

$$Ver ( {Num}_{{d}_{i}}^{{A}_{i}} ) = 0 ,$$

indicating that a transaction number transmitted by the collaborative user Aᵢ is not true or valid, the requesting user P₀ broadcasts information

$${message}_{{P}_{0}} ( {}_{}^{¬} {Num}_{{d}_{i}}^{{A}_{i}} )$$

without verifying the signature information

$${Sign}_{{A}_{i}} ( {Num}_{{d}_{i}}^{{A}_{i}} ) .$$

If the anonymous transaction is successfully completed but the collaborative user Aᵢ does not finish executing the transaction within a time period Δt specified by the requesting user, the requesting user broadcasts information message_{P}_{₀}(¬Δt_{A}_{ᵢ}). If a collaborative user in the anonymous set does not execute the transaction, indicating that the execution of the actual transaction D(P₀→S) of the requesting user is not completed, that is, ∃Aᵢ∈Set, Aᵢ was not executed dᵢ(Aᵢ [symbol] Aᵢ₊₁)⇔D(P₀→S) is not completed, the requesting user broadcasts a collaborative user who fails verification or even does not send a collaboration credential.

Step5: After receiving the payment credential

$${\tilde{V}}_{{P}_{0}}^{{A}_{i}} = ( {Num}_{{f}_{i}}^{{P}_{0}} , {Sign}_{{P}_{0}} ( {Num}_{{f}_{i}}^{{P}_{0}} ) )$$

sent by the requesting user P₀, the collaborative user Aᵢ responds based on whether the corresponding remuneration is received: if the collaborative user Aᵢ does not receive anonymous transaction remuneration O_{A}_{ᵢ} paid by the requesting user, broadcasts information

$${message}_{{A}_{i}} ( {}^{¬} {Num}_{{f}_{i}}^{{P}_{0}} ) .$$

An anonymous transaction process ends when the foregoing 5 steps are smoothly performed.

Step 3: Reputation update phase

Reputations of the users are updated based on the reputation evaluation scheme and bad user behavior defined in the anonymous set generation phase and the transaction execution phase. Considering a problem that the requesting user P₀, network user Pⱼ, or collaborative user Aᵢ may maliciously broadcast information message(·) in practical application, the information message(·) is stored through a blockchain. All nodes in the blockchain jointly verify the information by using a consensus characteristic of blockchain nodes. Only message(·) that passes the verification can be stored as reputation evaluation evidence in a block.

A set of the bad user behavior defined in the anonymous set generation phase and the transaction is execution phase

Act={message(¬Δt), message(¬mes), message(¬P), message(¬X), message(¬Num)}. message(¬Δt) indicates that the collaborative user does not finish executing the transaction within the specified time period. message(¬mes) indicates that the user maliciously broadcasts information. message(¬P) indicates that an identity of the user fails verification. message(¬X) indicates that a comprehensive reputation value of the user fails verification. message(¬Num) indicates that a transaction number transmitted by the requesting user or the collaborative user is not true or valid, that is, the requesting user does not transfer anonymous transaction funds, the collaborative user does not execute the anonymous transaction, or the requesting user does not pay remuneration to the collaborative user.

In the present disclosure, an incentive factor p and a penalty factor n are set to be constant. α_{P}^{t} increases by 1 when a user as a collaborative user honestly participates in an anonymous transaction. However, a cumulative quantity of times of β_{P}^{t} is determined based on impact of bad behavior of the user on the anonymous transaction. Apparently, message(¬Δt) has minimum impact because the collaborative user honestly executes the anonymous transaction but does not finish executing the anonymous transaction within a time period given by the requesting user, and is regarded as one time of bad behavior. message(¬mes) indicates that the user maliciously slanders another user and is regarded as two times of bad behavior. The bad behavior such as message(¬P) or message(¬X) has relatively small impact because the bad behavior occurs before the anonymous set is generated, the requesting user has not paid an anonymous transaction amount, and the collaborative user has not executed the anonymous transaction, and is regarded as two times of bad behavior. The bad behavior message(¬Num) occurs in a process of executing the anonymous transaction, brings very bad consequences regardless of whether the requesting user or the collaborative user has the bad behavior, and is regarded as three times of bad behavior.

Finally, an instantaneous reputation value X_{P}_{₀}(t) of the requesting user, an instantaneous reputation value X_{P}_{ⱼ}(t) of the network user, and an instantaneous reputation value X_{A}_{ᵢ}(t) of the collaborative user are respectively calculated through a formula

$${χ}_{{P}_{0}} ( t ) = max ( 0 , {χ}_{{P}_{0}} ( t - 1 ) - n * \frac{{β}_{{P}_{0}}^{t}}{{α}_{{P}_{0}}^{t} + {β}_{{P}_{0}}^{t}} )$$

for calculating the instantaneous reputation value of the requesting user, a formula

$${χ}_{{P}_{j}} ( t ) = max ( 0 , {χ}_{{P}_{j}} ( t - 1 ) - n * \frac{{β}_{{P}_{j}}^{t}}{{α}_{{P}_{j}}^{t} + {β}_{{P}_{j}}^{t}} )$$

for calculating the instantaneous reputation value of the network user, and a formula

$${χ}_{{A}_{i}} ( t ) = \{ \begin{matrix}min ( 0 , {χ}_{{A}_{i}} ( t - 1 ) - p * \frac{{α}_{{A}_{i}}^{t}}{{α}_{{A}_{i}}^{t} + {β}_{{A}_{i}}^{t}} ) \\ max ( 0 , {χ}_{{A}_{i}} ( t - 1 ) - n * \frac{{β}_{{A}_{i}}^{t}}{{α}_{{A}_{i}}^{t} + {β}_{{A}_{i}}^{t}} )\end{matrix}$$

for calculating the instantaneous reputation value of the collaborative user in the reputation evaluation model, and uploaded to the blockchain to update the reputation values of the users.

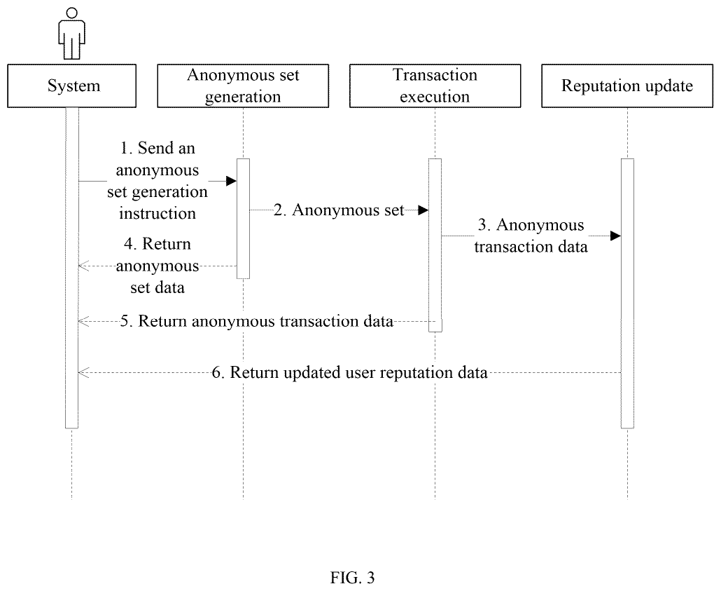

As shown in FIG. 3, the system for protecting location privacy in mobile payment provided in the embodiments of the present disclosure includes:
an anonymous set generation module, configured to describe a mutual relationship between users from a perspective of a supply-demand relationship, and generate an anonymous set for a requesting user through a double auction mechanism;
a transaction execution module, configured to execute an anonymous transaction based on an anonymous transaction model; and
a reputation update module, configured to update reputations of the users based on a reputation evaluation scheme and bad user behavior defined in an anonymous set generation phase and a transaction execution phase.

### 1. Preliminary Knowledge

### 1.1 System Model

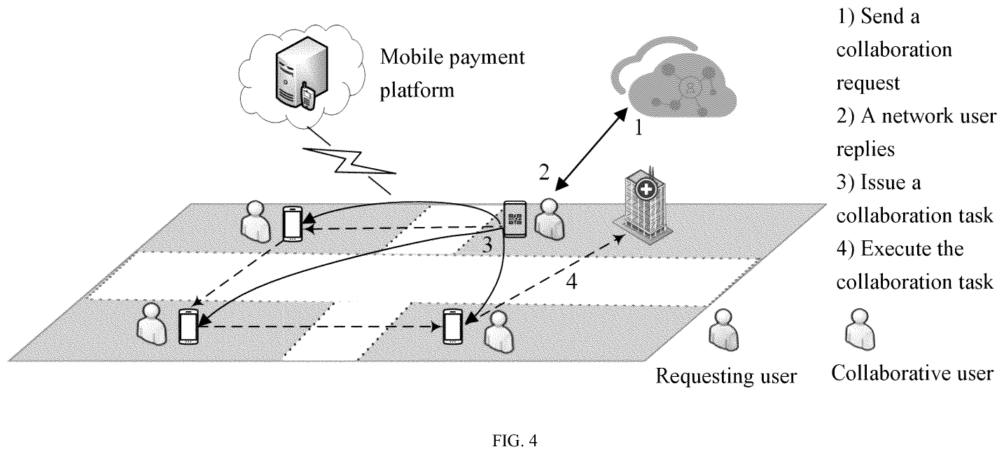

In the present disclosure, an anonymous transaction model in a mobile payment environment is constructed based on a decentralized coin mixing idea, as shown in FIG. 4. The model includes three entities: a requesting user, a collaborative user, and a merchant. The present disclosure assumes that a secure communication link exists between the requesting user and the collaborative user.

A set of all users in a network is U={P₀, P₁, P₂, . . . , Pₙ, . . . , Pₘ}. The requesting user P₀ is an initiator of an anonymous transaction. To protect location information of the requesting user from being leaked in a transaction process, the requesting user sends an anonymous transaction collaboration request Q_{P}_{₀} to the other users U′={P₁, P₂, . . . , Pₙ, . . . , Pₘ} in the network, and selects k users from n candidate collaborative users who accept the collaboration request, to construct an anonymous set Set={A₁ . . . , Aᵢ, . . . , Aₖ}. k is a privacy requirement of the requesting user P₀. The anonymous set Set is introduced to transform an actual transaction D(P₀→S) into D(P₀→S)⇒D₀(P₀→Aₛₑₜ)·D₁(A_{Set}→S). D₀(P₀→A_{Set}) is used to cut off a direct transaction association between the requesting user P₀ and the merchant S. D₁(A_{Set}→S) is used to ensure that funds are transferred to a correct merchant account. After the anonymous set is successfully constructed, the requesting user P₀ divides the original transaction as follows: D(P₀→S)⇒d₀(P₀→A₁)·d₁(A₁→A₂)· . . . ·dₖ₋₁(Aₖ₋₁→Aₖ)·dₖ(Aₖ→S). Each transaction dᵢ(Aᵢ→Aᵢ₊₁) obtained after the division is executed by a collaborative user Aᵢ to implement a flow of the funds of the requesting user.

The collaborative user Aᵢ is a participant in the anonymous transaction and obtains remuneration by providing a collaboration service to the requesting user. After receiving the specific collaboration task dᵢ(Aᵢ→Aᵢ₊₁) sent by the requesting user P₀, the collaborative user Aᵢ transfers a fixed amount of funds to an account of Aᵢ₊₁ based on collaboration content. The collaborative user of the current transaction may be a requesting user of a next transaction. The merchant S is an actual recipient of the anonymous transaction, does not participate in a specific execution process of the anonymous transaction, and serves only as a final recipient of the funds.

### 1.2 Reputation Evaluation Model

In the present disclosure, the reputation evaluation model is designed to comprehensively consider impact of the historical behavior of the user in an anonymous transaction process on the reputation value of the user and improve reliability of a decentralized system.

It is assumed that within a discrete time period T={1, 2, . . . , t, . . . }, the requesting user P₀ broadcasts the collaboration request Q_{P}_{₀} in expectation of a response from the network user Pⱼ, to generate the anonymous set Set. If the requesting user has malicious behavior such as falsifying information, deceiving the collaborative user into executing a false anonymous transaction, or not paying remuneration to the collaborative user who executes a transaction in the anonymous transaction process, a reputation value of the requesting user should be reduced as a penalty. A formula for measuring an instantaneous reputation value X_{P}_{₀}(t) of the requesting user P₀ at a moment t is as follows:

$${χ}_{{P}_{0}} ( t ) = max ( 0 , {χ}_{{P}_{0}} ( t - 1 ) - n * \frac{{β}_{{P}_{0}}^{t}}{{α}_{{P}_{0}}^{t} + {β}_{{P}_{0}}^{t}} ) .$$

If the network user Pⱼ has behavior of falsifying information during response to the requesting user P₀, a reputation value of the network user should be reduced as a penalty. A formula for measuring an instantaneous reputation value X_{P}_{ⱼ}(t) of the network user Pⱼ at the moment t is as follows:

$${χ}_{{P}_{j}} ( t ) = max ( 0 , {χ}_{{P}_{j}} ( t - 1 ) - n * \frac{{β}_{{P}_{j}}^{t}}{{α}_{{P}_{j}}^{t} + {β}_{{P}_{j}}^{t}} ) .$$

If the collaborative user Aᵢ leaks the specific collaboration task dᵢ(Aᵢ→Aᵢ₊₁) issued by the requesting user P₀, or delays or interrupts execution of the collaboration task, a reputation value of the collaborative user should be reduced as a penalty. If the collaborative user honestly executes the collaboration task, the reputation value of the collaborative user should be increased as a reward. A formula for measuring an instantaneous reputation value X_{A}_{ᵢ}(t) of the collaborative user Aᵢ at the moment t is as follows:

$${χ}_{{A}_{i}} ( t ) = \{ \begin{matrix}min ( 0 , {χ}_{{A}_{i}} ( t - 1 ) - p * \frac{{α}_{{A}_{i}}^{t}}{{α}_{{A}_{i}}^{t} + {β}_{{A}_{i}}^{t}} ) \\ max ( 0 , {χ}_{{A}_{i}} ( t - 1 ) - n * \frac{{β}_{{A}_{i}}^{t}}{{α}_{{A}_{i}}^{t} + {β}_{{A}_{i}}^{t}} )\end{matrix} ,$$

p is an incentive factor. n is a penalty factor. α_{P}^{t} is a cumulative quantity of times the user honestly participates in anonymous transactions by t. β_{P}^{t} is a cumulative quantity of times the user has bad behavior by t. To further prevent users from having bad behavior, let 0<p«n<1, and prompt a self-interested user to adhere to rational consensus by increasing a penalty. It can be learned from the formula that the instantaneous reputation value of the user meets a condition 0≤X_{P}(t)≤1. Therefore, an initial reputation value X_{P}(0) of the user can be set to 0.5.

To improve accuracy of evaluating the historical behavior of the user, each instantaneous reputation value X_{P}(t) of the user in the anonymous transaction process should be fused to calculate a comprehensive reputation value. Because importance of each instantaneous reputation value X_{P}(t) decreases over time t, the closer the instantaneous reputation value is to a current moment, the more it reflects a true reputation of the user. Therefore, in the present disclosure, a quadratic decreasing function is used to define a weight of each instantaneous reputation value X_{P}(t) of the user in the comprehensive reputation value as follows:

$$ω ( {χ}_{P} ( t ) ) = \{ \begin{matrix}{( 1 - \frac{T - t}{Γ} )}^{2} & , T - Γ < t \leq T \\ 0 & , 0 \leq t \leq T - Γ\end{matrix} ,$$

where T is the current moment, and Γ is a validity period of the reputation value. When t=T, ω(X_{P}(t))=1. When X_{P}(t) is a reputation value at the current moment, a weight of the reputation value in the comprehensive reputation value is 1. When 0≤t≤T−Γ, ω(X_{P}(t))=0, indicating that a reputation value at a moment with an interval to the current moment T exceeding the validity period Γ is not used for evaluation, to improve accuracy of real-time user reputation evaluation. The comprehensive reputation value of the user is finally obtained through a weighted average sum method as follows:

$${χ}_{P} = {\sum }_{T - Γ < t \leq T} ( {χ}_{P} ( t ) * \frac{ω ( {χ}_{P} ( t ) )}{{\sum }_{T - Γ < t \leq T} ω ( {χ}_{P} ( t ) )} ) .$$

### 1.3 Double Auction Mechanism

It is assumed that in the network, n requesting users U={P₀, P₁, P₂, . . . , Pₙ} are waiting for anonymous services and m network users U′={Pₙ₊₁, Pₙ₊₂, . . . , Pₙ₊ₘ} are waiting to receive collaboration tasks. Each requesting user Pᵢ∈U broadcasts a collaboration request Q_{P}_{ᵢ}=(X_{P}_{ᵢ}, M, Δt, O_{P}_{ᵢ}) to the other user Pⱼ∈U′ in the network. X_{P}_{ᵢ} is a comprehensive reputation value of the requesting user. M is an amount of funds in an actual transaction of the requesting user. Δt is an execution delay of the anonymous transaction acceptable to the requesting user. O_{P}_{ᵢ} is a bid base of the auction.

The bid base O_{P}_{ᵢ} of the requesting user is determined by the comprehensive reputation value, actual transaction amount, and acceptable task execution delay of the requesting user. As the actual transaction amount increases and the execution delay decreases, there is a higher requirement for the collaborative user and more remuneration should be paid. In addition, a requesting user with a better reputation should dominate the auction and pay less remuneration. Therefore, the bid base of the requesting user is set to

$${O}_{{P}_{i}} = \frac{M * φ ( Δ t )}{{χ}_{{P}_{i}}} .$$

φ(Δt) is a decreasing function. A bid O_{P}_{ⱼ} of the network user Pⱼ should have a positive correlation with the bid base of the requesting user, and a network user with a better reputation should obtain more remuneration. The bid of the network user is set to O_{P}_{ⱼ}=O_{P}_{ᵢ}*X_{P}_{ⱼ}*ρ. ρ is a control coefficient used to limit overbidding.

After receiving the collaboration request Q_{P}_{ᵢ}, the network user Pⱼ∈U′ may rank the requesting user in ascending order of the bid base O_{P}_{ᵢ} and the comprehensive reputation value X_{P}_{ᵢ}, and determine, based on a comprehensive ranking of the bid base and the comprehensive reputation value of the requesting user Pᵢ, whether to accept the request. If the network user accepts the request, the network user sends a reply R_{P}_{ⱼ}=(X_{P}_{ⱼ}, O_{P}_{ⱼ}) to the requesting user. If the network user rejects the request, the network user does not respond. The network user may selectively accept collaboration requests of a plurality of requesting users based on a capability of the network user, and establish a to-be-executed task set W_{P}_{ⱼ}={w₁, w₂, . . . , wₙ}. The requesting user Pᵢ arranges the candidate collaborative users in ascending order of comprehensive reputation value and in descending order of bid, and determines that k users whose comprehensive ranking is the highest constitute the anonymous set Set={A₁ . . . , Aᵢ, . . . , Aₖ}.

### 2. Anonymous Transaction Scheme Based on Reputation Evaluation and a Double Auction

When an anonymous set is generated through an existing decentralized coin mixing scheme, due to a lack of reputation measurement for collaborative users, the generated anonymous set may include low-reputation collaborative users. The low-reputation collaborative users are very likely to leak transaction information of a requesting user for their own interests, or even attempt to steal funds of the requesting user. If the requesting user executes a transaction mixing process by using the anonymous set generated through the existing scheme, existence of the low-reputation collaborative users greatly reduces transaction anonymity, and may even expose actual transaction parties. To resolve this problem, as shown in FIG. 2, a reputation evaluation scheme is designed in the present disclosure. A reputation value of a user is measured based on historical behavior of the user to help a requesting user determine whether to add a candidate collaborative user to the anonymous set. A functional relationship between a user reputation and a bid is established. Candidate collaborative users who meet a reputation requirement and a bid standard of the requesting user are selected through a double auction to construct the anonymous set.

### 2.1 Anonymous Set Generation Phase

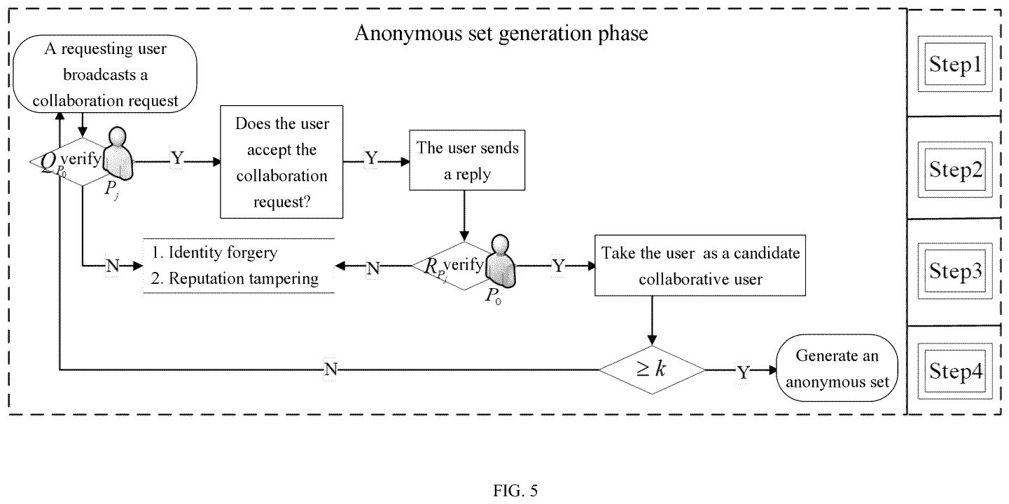

In the present disclosure, a mutual relationship between users is described from a perspective of a supply-demand relationship, and an anonymous set is generated for a requesting user through a double auction mechanism, as shown in FIG. 5.

Step1: Before executing a mobile payment transaction, the requesting user P₀ broadcasts a collaboration request Q_{P}_{₀}=(X_{P}_{₀}, M, Δt, O_{P}_{₀}, Sign_{P}_{₀}(X_{P}_{₀}∥M∥Δt∥O_{P}_{₀}) to the other users in a network. Sign(·) is a secure signature function. Sign_{P}_{₀}(X_{P}_{₀}∥M∥Δt∥O_{P}_{₀}) indicates that the requesting user P₀ signs information, such as a comprehensive reputation value, a transaction amount, and an acceptable task execution delay, of the requesting user by using a private key of the requesting user.

Step2: After receiving the collaboration request Q_{P}_{₀}=(X_{P}_{₀}, M, Δt, O_{P}_{₀}, Sign_{P}_{₀}(X_{P}_{₀}∥M∥Δt∥O_{P}_{₀}) sent by the requesting user P₀, the network user Pⱼ verifies correctness of the signature information Sign_{P}_{₀}(X_{P}_{₀}∥M∥Δt∥O_{P}_{₀}) and the comprehensive reputation value X_{P}_{₀} of the requesting user P₀ in the collaboration request Q_{P}_{₀}:

(1) If Ver_{P}_{₀}(Sign_{P}_{₀}(X_{P}_{₀}∥M∥Δt∥O_{P}_{₀})=Sign_{P}_{₀}(X_{P}_{₀}∥M∥Δt∥O_{P}_{₀}), indicating that an identity of the requesting user passes the verification, the network user verifies the comprehensive reputation value X_{P}_{₀} of the requesting user.

If

$$Ver ( {χ}_{{P}_{0}} ) = {\sum }_{T - Γ < t \leq T} ( {χ}_{{P}_{0}} ( t ) * \frac{ω ( {χ}_{{P}_{0}} ( t ) )}{{\sum }_{T - Γ < t \leq T} ω ( {χ}_{{P}_{0}} ( t ) )} ) ,$$

indicating that the identity and the comprehensive reputation value of the requesting user both pass the verification, the network user may determine, based on a bid base O_{P}_{₀} given by and the comprehensive reputation value X_{P}_{₀} of the requesting user, whether to accept the collaboration request. If the network user Pⱼ accepts the collaboration request of the requesting user P₀, the network user sends a reply R_{P}_{ⱼ}=(X_{P}_{ⱼ},O_{P}_{ⱼ}, add(Pⱼ), Sign_{P}_{ⱼ}(X_{P}_{ⱼ}∥O_{P}_{ⱼ}∥add(Pⱼ))) to the requesting user P₀. add(Pⱼ) is an account address of the network user Pⱼ. Otherwise, the network user does not respond. The network user may accept collaboration requests of a plurality of requesting users based on a capability of the network user, to form a to-be-executed task set W_{P}_{ⱼ}={w₁, w₂, . . . , wₙ}.

If

$$Ver ( {χ}_{{P}_{0}} ) \neq {\sum }_{T - Γ < t \leq T} ( {χ}_{{P}_{0}} ( t ) * \frac{ω ( {χ}_{{P}_{0}} ( t ) )}{{\sum }_{T - Γ < t \leq T} ω ( {χ}_{{P}_{0}} ( t ) )} ) ,$$

indicating that the comprehensive reputation value of the requesting user fails the verification, the network user Pⱼ broadcasts information message_{P}_{ⱼ}(¬X_{P}_{₀}).

(2) If Ver_{P}_{₀}(Sign_{P}_{₀}(X_{P}_{₀}∥M∥Δt∥O_{P}_{₀})≠Sign_{P}_{₀}(XP_{P}_{₀}∥M∥Δt∥O_{P}_{₀}), indicating that an identity of the requesting user fails the verification, the network user Pⱼ may broadcast information message_{P}_{ⱼ}(¬P₀) without verifying the comprehensive reputation value X_{P}_{₀} of the requesting user.

Ver(·) is a verification function. Ver_{P}_{₀}(Sign_{P}_{₀}(X_{P}_{₀}∥Δt∥∥O_{P}_{₀}) indicates verification of correctness of the signature information Sign_{P}_{₀}(X_{P}_{₀}M∥Δt∥O_{P}_{₀}) by using a public key of the requesting user P₀. If the verification fails, Sign_{P}_{₀}(X_{P}_{₀}M∥Δt∥O_{P}_{₀}) is not a signature generated through encryption performed by using the private key of P₀, and the identity of the requesting user is likely to be forged.

Step3: The requesting user P₀ verifies correctness of the reply R_{P}_{ⱼ}=(X_{P}_{ⱼ}, O_{P}_{ⱼ}, add(Pⱼ), Sign_{P}_{ⱼ}(X_{P}_{ⱼ}∥O_{P}_{ⱼ}∥add(Pⱼ))) of the network user Pⱼ.

(1) If Ver_{P}_{ⱼ}(Sign_{P}_{ⱼ}(X_{P}_{ⱼ}∥O_{P}_{ⱼ}∥add(Pⱼ)))=Sign_{P}_{ⱼ}(X_{P}_{ⱼ}∥O_{P}_{ⱼ}∥add(Pⱼ)), indicating that an identity of the network user passes the verification, the requesting user verifies a comprehensive reputation value of the network user.

If

$$Ver ( {χ}_{{P}_{j}} ) = {\sum }_{T - Γ < t \leq T} ( {χ}_{{P}_{j}} ( t ) * \frac{ω ( {χ}_{{P}_{j}} ( t ) )}{{\sum }_{T - Γ < t \leq T} ω ( {χ}_{{P}_{j}} ( t ) )} ) ,$$

indicating that the comprehensive reputation value of the network user also passes the verification, the requesting user takes the network user Pⱼ as a candidate collaborative user.

If

$$Ver ( {χ}_{{P}_{j}} ) \neq {\sum }_{T - Γ < t \leq T} ( {χ}_{{P}_{j}} ( t ) * \frac{ω ( {χ}_{{P}_{j}} ( t ) )}{{\sum }_{T - Γ < t \leq T} ω ( {χ}_{{P}_{j}} ( t ) )} ) ,$$

indicating that the comprehensive reputation value of the network user fails the verification, the requesting user P₀ broadcasts information message_{P}_{₀}(¬X_{P}_{ⱼ}).

(2) If Ver_{P}_{ⱼ}(Sign_{P}_{ⱼ}(X_{P}_{ⱼ}∥O_{P}_{ⱼ}∥add(Pⱼ)))≠Sign_{P}_{ⱼ}(X_{P}_{ⱼ}∥O_{P}_{ⱼ}∥add(Pⱼ)), indicating that an identity of the network user fails the verification, the requesting user P₀ broadcasts information message_{P}_{₀}(¬Pⱼ) without verifying the comprehensive reputation value X_{P}_{ⱼ} of the network user.

Step4: The requesting user P₀ ranks the candidate collaborative user in ascending order of the comprehensive reputation value X_{P}_{ⱼ} and in descending order of a bid O_{P}_{ⱼ} to obtain a comprehensive reputation value ranking N_{X}(Pⱼ) and a bid ranking N_{O}(Pⱼ) of the candidate collaborative user Pⱼ, where a comprehensive ranking of the candidate collaborative user is N(Pⱼ)=N_{X}(Pⱼ)+N_{O}(Pⱼ); selects k users whose comprehensive ranking N(Pⱼ) is the highest from all candidate collaborative users to form the anonymous set Set={A₁ . . . , Aᵢ, . . . , Aₖ}; and if a current size k of the anonymous set does not meet a privacy protection requirement of the requesting user, continues to wait for the other network users to reply.

In the anonymous set generation phase, after the network user Pⱼ receives the collaboration request Q_{P}_{₀} sent by the requesting user P₀ or after the requesting user P₀ receives the reply R_{P}_{ⱼ} sent by the network user, a main purpose of verifying the correctness of the signature information and the comprehensive reputation value is to confirm authenticity of the identity and the comprehensive reputation value of the user, that is, to prevent malicious users from forging identities of others or tampering with their own reputation values.

### 2.2 Transaction Execution Phase

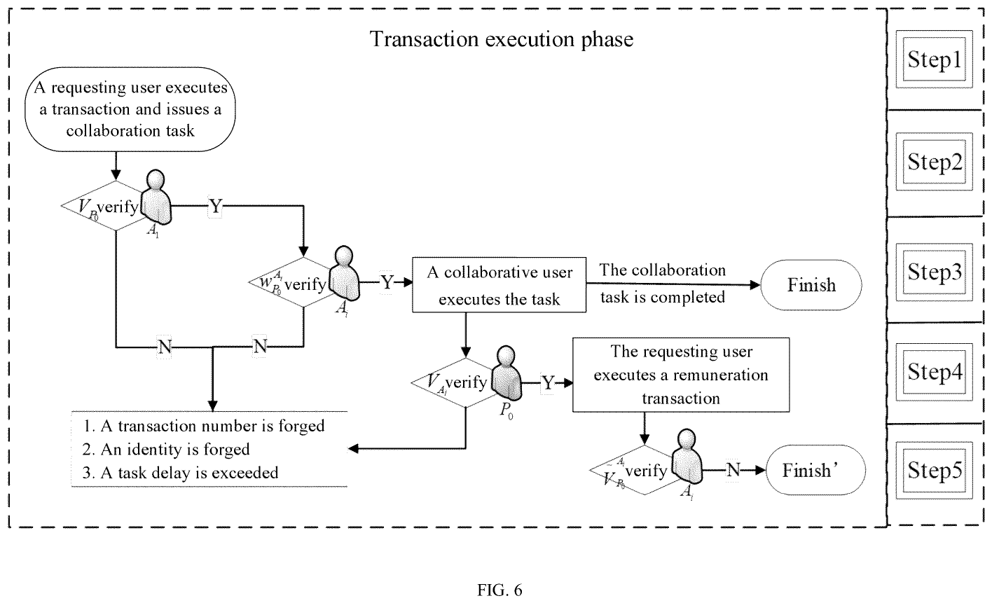

Based on an anonymous transaction model, an anonymous transaction execution phase mainly includes the following 5 steps. An execution process is shown in FIG. 6.

Step1: The requesting user P₀ executes a fund transfer transaction d₀(P₀ [symbol] A₁) and sends a transaction credential

$${V}_{{P}_{0}} = ( {Num}_{{d}_{0}}^{{P}_{0}} , {Sign}_{{P}_{0}} ( {Num}_{{d}_{0}}^{{P}_{0}} ) )$$

to the collaborative user A₁, where

$${Num}_{{d}_{0}}^{{P}_{0}}$$

represents a transaction number obtained after the requesting user P₀ executes d₀(P₀ [symbol] A₁); and sends a collaboration task

$${w}_{{P}_{0}}^{{A}_{i}} = ( M , Δ t , add ( {A}_{i + 1} ) , {Sign}_{{P}_{0}} ( M ‖ Δ t ‖ add ( {A}_{i + 1} ) ) )$$

to the collaborative user Aᵢ, add(Aᵢ₊₁) represents a target address of a transaction to be executed by the collaborative user Aᵢ.

Step2: After receiving the transaction credential

$${V}_{{P}_{0}} = ( {Num}_{{d}_{0}}^{{P}_{0}} , {Sign}_{{P}_{0}} ( {Num}_{{d}_{0}}^{{P}_{0}} ) )$$

sent by the requesting user P₀, the collaborative user A₁ verifies authenticity of the transaction credential:

(1) If

$$Ver ( {Num}_{{d}_{0}}^{{P}_{0}} ) = 1 ,$$

the collaborative user verifies the signature information

$${Sign}_{{P}_{0}} ( {Num}_{{d}_{0}}^{{P}_{0}} ) .$$

If

$$Ver ( {Sign}_{{P}_{0}} ( {Num}_{{d}_{0}}^{{P}_{0}} ) ) = {Sign}_{{P}_{0}} ( {Num}_{{d}_{0}}^{{P}_{0}} ) ,$$

indicating that an identity of and the transaction number transmitted by the requesting user P₀ are both true, the collaborative user broadcasts no information; or if

$$Ver ( {Sign}_{{P}_{0}} ( {Num}_{{d}_{0}}^{{P}_{0}} ) ) \neq {Sign}_{{P}_{0}} ( {Num}_{{d}_{0}}^{{P}_{0}} ) ,$$

indicating that an identity of the requesting user P₀ is forged, the collaborative user broadcasts information message_{A}_{₁}(¬P₀).

(2) If

$$Ver ( {Num}_{{d}_{0}}^{{P}_{0}} ) = 0 ,$$

indicating that the transaction number transmitted by the requesting user P₀ is not true or valid, the collaborative user A₁ broadcasts information

$${message}_{{A}_{1}} ( {}^{¬} {Num}_{{d}_{0}}^{{P}_{0}} )$$

without verifying the signature information

$${Sign}_{{P}_{0}} ( {Num}_{{d}_{0}}^{{P}_{0}} ) .$$

The remaining collaborative users who receive the broadcast information message_{A}_{₁}(¬P₀) or

$${message}_{{A}_{1}} ( {}^{¬} {Num}_{{d}_{0}}^{{P}_{0}} )$$

may immediately terminate a collaboration task related to the requesting user.

Step3: After receiving the collaboration task

$${w}_{{P}_{0}}^{{A}_{i}} = ( M , Δ t , add ( {A}_{i + 1} ) , {Sign}_{{P}_{0}} ( M ‖ Δ t ‖ add ( {A}_{i + 1} ) ) )$$

sent by the requesting user P₀, the collaborative user Aᵢ checks whether the information message_{A}_{₁}(¬P₀) or

$${message}_{{A}_{1}} ( {}^{¬} {Num}_{{d}_{0}}^{{P}_{0}} )$$

exists; and if the information exists, terminates the collaboration task; or if the information does not exist, verifies correctness of the signature information Sign_{P}_{₀}(M∥Δt∥add(Aᵢ₊₁)) of the requesting user P₀ in the collaboration task

$${w}_{{P}_{0}}^{{A}_{i}} :$$

(1) If Ver_{P}_{₀}(Sign_{P}_{₀}(M∥Δt∥add(Aᵢ₊₁)))=Sign_{P}_{₀}(M∥Δt∥add(Aᵢ₊₁)), indicating that an identity of the requesting user passes the verification, the collaborative user Aᵢ executes a transaction dᵢ(A₁ [symbol] Aᵢ₊₁) based on content in the collaboration task

$${w}_{{P}_{0}}^{{A}_{i}} ;$$

and after executing the transaction dᵢ(Aᵢ [symbol] Aᵢ₊₁), sends a collaboration credential

$${V}_{{A}_{i}} = ( {Num}_{{d}_{i}}^{{A}_{i}} , {Sign}_{{A}_{i}} ( {Num}_{{d}_{i}}^{{A}_{i}} ) )$$

to the requesting user P₀ to obtain remuneration for executing the anonymous transaction.

(2) If Ver_{P}_{₀}(Sign_{P}_{₀}(M∥Δt∥add(Aᵢ₊₁)))≠Sign_{P}_{₀}(M∥Δt∥add(Aᵢ₊₁)), indicating that an identity of the requesting user P₀ is forged, the collaborative user Aᵢ refuses to execute the collaboration task, and broadcasts information message_{A}_{ᵢ}(¬P₀).

Execution of an actual transaction D(P₀→S) of the requesting user is completed only after all collaborative users Aᵢ in the anonymous set execute the transaction dᵢ. That is, ∀Aᵢ∈Set, Aᵢ has executed dᵢ(Aᵢ [symbol] Aᵢ₊₁)⇔D(P₀→S) is completed.

Step4: After receiving the collaboration credential

$${V}_{{A}_{i}} = ( {Num}_{{d}_{i}}^{{A}_{i}} , {Sign}_{{A}_{i}} ( {Num}_{{d}_{i}}^{{A}_{i}} ) )$$

sent by the collaborative user Aᵢ, the requesting user P₀ verifies the collaboration credential:

(1) If

$$Ver ( {Num}_{{d}_{i}}^{{A}_{i}} ) = 1 ,$$

the requesting user verifies the signature information

$${Ver}_{{A}_{i}} ( {Sign}_{{A}_{i}} ( {Num}_{{d}_{i}}^{{A}_{i}} ) ) .$$

If

$${Ver}_{{A}_{i}} ( {Sign}_{{A}_{i}} ( {Num}_{{d}_{i}}^{{A}_{i}} ) ) = {Sign}_{{A}_{i}} ( {Num}_{{d}_{i}}^{{A}_{i}} ) ,$$

indicating that a transaction number transmitted by the collaborative user Aᵢ is true and valid and an identity of the collaborative user passes the verification, the requesting user executes a remuneration transaction

$${f}_{i} = ( {P}_{0} {\to }^{{O}_{{A}_{i}}} {A}_{i} )$$

and sends a payment credential

$${\tilde{V}}_{{P}_{0}}^{{A}_{i}} ( {Num}_{{f}_{i}}^{{P}_{0}} , {Sign}_{{P}_{0}} ( {Num}_{{f}_{i}}^{{P}_{0}} ) )$$

to the collaborative user Aᵢ.

If

$${Ver}_{{A}_{i}} ( {Sign}_{{A}_{i}} ( {Num}_{{d}_{i}}^{{A}_{i}} ) ) \neq {Sign}_{{A}_{i}} ( {Num}_{{d}_{i}}^{{A}_{i}} ) ,$$

indicating that an identity of the collaborative user Aᵢ is forged, the requesting user broadcasts information message_{P}_{₀}(¬Aᵢ).

(2) If

$$Ver ( {Num}_{{d}_{i}}^{{A}_{i}} ) = 0 ,$$

indicating that a transaction number transmitted by the collaborative user Aᵢ is not true or valid, the requesting user P₀ broadcasts information

$${message}_{{P}_{0}} {(}^{¬} {Num}_{{d}_{i}}^{{A}_{i}} )$$

without verifying the signature information

$${Sign}_{{A}_{i}} ( {Num}_{{d}_{i}}^{{A}_{i}} ) .$$

If the anonymous transaction is successfully completed but the collaborative user Aᵢ does not finish executing the transaction within a time period Δt specified by the requesting user, the requesting user broadcasts information message_{P}_{₀}(¬Δt_{A}_{ᵢ}). If a collaborative user in the anonymous set does not execute the transaction, indicating that the execution of the actual transaction D(P₀→S) of the requesting user is not completed, that is, ∃Aᵢ∈Set, Aᵢ was not executed dᵢ(Aᵢ [symbol] Aᵢ₊₁)⇔D(P₀→S) is not completed, the requesting user broadcasts a collaborative user who fails verification or even does not send a collaboration credential.

Step5: After receiving the payment credential

$${\tilde{V}}_{{P}_{0}}^{{A}_{i}} ( {Num}_{{f}_{i}}^{{P}_{0}} , {Sign}_{{P}_{0}} ( {Num}_{{f}_{i}}^{{P}_{0}} ) )$$

sent by the requesting user P₀, the collaborative user Aᵢ responds based on whether the corresponding remuneration is received: if the collaborative user Aᵢ does not receive anonymous transaction remuneration O_{A}_{ᵢ} paid by the requesting user, broadcasts information

$${message}_{{A}_{i}} {(}^{¬} {Num}_{{f}_{i}}^{{P}_{0}} ) .$$

An anonymous transaction process ends when the foregoing 5 steps are smoothly performed.

### 2.3 Reputation Update Phase

Update reputations of the users based on the reputation evaluation scheme and bad user behavior defined in the anonymous set generation phase and the transaction execution phase. Considering a problem that the requesting user P₀, network user Pⱼ, or collaborative user Aᵢ may maliciously broadcast information message(·) in practical application, the information message(·) is stored through a blockchain in the present disclosure. All nodes in the blockchain jointly verify the information by using a consensus characteristic of blockchain nodes. Only message(·) that passes the verification can be stored as reputation evaluation evidence in a block.

A set of the bad user behavior defined in the anonymous set generation phase and the transaction execution phase is

Act={message(¬Δt), message(¬mes), message(¬P), message(¬X), message(¬Num)}. message(¬Δt) indicates that the collaborative user does not finish executing the transaction within the specified time period. message(¬mes) indicates that the user maliciously broadcasts information. message(¬P) indicates that an identity of the user fails verification. message(¬X) indicates that a comprehensive reputation value of the user fails verification. message(¬Num) indicates that a transaction number transmitted by the requesting user or the collaborative user is not true or valid, that is, the requesting user does not transfer anonymous transaction funds, the collaborative user does not execute the anonymous transaction, or the requesting user does not pay remuneration to the collaborative user.

In the present disclosure, an incentive factor p and a penalty factor n are set to be constant. α_{P}^{t} increases by 1 when a user as a collaborative user honestly participates in an anonymous transaction. However, a cumulative quantity of times of β_{P}^{t} is determined based on impact of bad behavior of the user on the anonymous transaction. Apparently, message(¬Δt) has minimum impact because the collaborative user honestly executes the anonymous transaction but does not finish executing the anonymous transaction within a time period given by the requesting user, and is regarded as one time of bad behavior. message(¬mes) indicates that the user maliciously slanders another user and is regarded as two times of bad behavior. The bad behavior such as message(¬P) or message(¬X) has relatively small impact because the bad behavior occurs before the anonymous set is generated, the requesting user has not paid an anonymous transaction amount, and the collaborative user has not executed the anonymous transaction, and is regarded as two times of bad behavior. The bad behavior message(¬Num) occurs in a process of executing the anonymous transaction, brings very bad consequences regardless of whether the requesting user or the collaborative user has the bad behavior, and is regarded as three times of bad behavior.

Finally, an instantaneous reputation value X_{P}_{₀}(t) of the requesting user, an instantaneous reputation value X_{P}_{ⱼ}(t) of the network user, and an instantaneous reputation value X_{A}_{ᵢ}(t) of the collaborative user are calculated respectively through a formula

$${χ}_{{P}_{0}} ( t ) = max ( 0 , {χ}_{{P}_{0}} ( t - 1 ) - n ⋆ \frac{{β}_{{P}_{0}}^{t}}{{α}_{{P}_{0}}^{t} + {β}_{{P}_{0}}^{t}} )$$

for calculating the instantaneous reputation value of the requesting user, a formula

$${χ}_{{P}_{j}} ( t ) = max ( 0 , {χ}_{{P}_{j}} ( t - 1 ) - n ⋆ \frac{{β}_{{P}_{j}}^{t}}{{α}_{{P}_{j}}^{t} + {β}_{{P}_{j}}^{t}} )$$

for calculating the instantaneous reputation value of the network user, and a formula

$${χ}_{{A}_{i}} ( t ) = \{ \begin{matrix}min ( 1 , {χ}_{{A}_{i}} ( t - 1 ) + p * \frac{{α}_{{A}_{i}}^{t}}{{α}_{{A}_{i}}^{t} + {β}_{{A}_{i}}^{t}} ) \\ max ( 0 , {χ}_{{A}_{i}} ( t - 1 ) - n * \frac{{β}_{{A}_{i}}^{t}}{{α}_{{A}_{i}}^{t} + {β}_{{A}_{i}}^{t}} )\end{matrix}$$

for calculating the instantaneous reputation value of the collaborative user in the reputation evaluation model, and uploaded to the blockchain to update the reputation values of the users.

### 3. Scheme Analysis

### 3.1 Incentive Compatibility

In the present disclosure, the requesting user P₀, network user Pⱼ, and collaborative user Aᵢ are all set as rational and self-interested users based on an individual rationality principle. That is, the requesting user, network user, and collaborative user always select a strategy of a utility function Uti_{P}≥0 when participating in an anonymous transaction, and all strive to maximize the utility function Uti_{P}. Therefore, in the present disclosure, the utility function Uti_{P} of the user when different strategies are used is calculated to analyze whether the scheme satisfies an incentive compatibility constraint, to ensure that each user can obtain maximum profits only when honestly participating in the anonymous transaction.

A profit of the requesting user P₀ for a successful anonymous transaction T(P₀→S) is F. A loss for an unsuccessful anonymous transaction ¬T(P₀→S) is F. A profit of the collaborative user for leaking transaction information of the requesting user is L. That is, a loss when the transaction information of the requesting user is leaked is L. A cost of the collaborative user for executing the anonymous transaction is J. Remuneration of the collaborative user for executing the anonymous transaction is a bid O_{A}_{ᵢ} of the collaborative user. It is assumed that the profit of the requesting user for the successful anonymous transaction is much greater than the remuneration that the requesting user needs to pay to the collaborative user, the loss when the information is leaked is much greater than the loss for the unsuccessful anonymous transaction, and the remuneration of the collaborative user for executing the anonymous transaction is greater than the cost of the collaborative user: k*O_{A}_{ᵢ}«F«L and O_{A}_{ᵢ}<J.

### (1) Requesting User

Lemma 1: The requesting user P₀ can obtain the maximum utility function Uti_{P}_{₀} only when honestly participating in the anonymous transaction.

Proof: Analyze, based on the foregoing scheme execution process, strategies C_{P}_{₀}={c_{P}_{₀}¹, c_{P}_{₀}², c_{P}_{₀}³, c_{P}_{₀}⁴, c_{P}_{₀}⁵} that the requesting user P₀ may use in the anonymous transaction process, and utility functions Uti_{P}_{₀}={u_{P}_{₀}¹, u_{P}_{₀}², u_{P}_{₀}³, u_{P}_{₀}⁴, u_{P}_{₀}⁵} corresponding to different strategies. The utility functions u_{P}_{₀}¹, u_{P}_{₀}², u_{P}_{₀}³, u_{P}_{₀}⁴, and u_{P}_{₀}⁵ respectively represent profits obtained when the requesting user uses the strategies c_{P}_{₀}¹, c_{P}_{₀}², c_{P}_{₀}³, c_{P}_{₀}⁴, and c_{P}_{₀}⁵.

The strategy c_{P}_{₀}¹ indicates that the requesting user honestly participates in the anonymous transaction without any bad behavior. In this case, u_{P}_{₀}¹=F−k*O_{A}_{ᵢ}. The strategy c_{P}_{₀}² indicates that the requesting user forges the identity or tampers with the comprehensive reputation value of the requesting user when broadcasting the collaboration request. The strategy c_{P}_{₀}³ indicates that the requesting user does not execute the fund transfer transaction after generating the anonymous set. The strategy c_{P}_{₀}⁴ indicates that the requesting user forges an identity of another user to issue the collaboration task. According to the execution process of the anonymous transaction scheme, when the requesting user uses the foregoing strategies, penalty information is broadcast and the anonymous transaction cannot be completed. Therefore, u_{P}_{₀}², u_{P}_{₀}³, and u_{P}_{₀}⁴ are all −F. The strategy c_{P}_{₀}⁵ indicates that the requesting user does not pay corresponding remuneration after the collaborative user completes the collaboration task. In this case, if k collaborative users all complete collaboration tasks

$${u}_{{P}_{0}}^{{5}^{k}} = F .$$

If only m (m<k) collaborative users complete collaboration tasks, u_{P}_{₀}⁵^{ₘ}=−F. It can be learned that

$${u}_{{P}_{0}}^{{5}^{k}} > {u}_{{P}_{0}}^{1} > {u}_{{P}_{0}}^{2} = {u}_{{P}_{0}}^{3} = {u}_{{P}_{0}}^{4} = {u}_{{P}_{0}}^{{5}^{m}} .$$

Apparently, through analysis only of single-round profits, the requesting user can obtain the greatest profit when using the strategy c_{P}_{₀}⁵, followed by the strategy c_{P}_{₀}¹.

However, when the requesting user P₀ initiates another collaboration request, it is difficult to generate an anonymous set because the reputation value of the requesting user is reduced due to the bad behavior. In this case, u_{P}_{₀}ⁱ′=−F regardless of the strategy used by the requesting user. If the requesting user P₀ still generates an anonymous set, due to the low reputation value of the requesting user, the generated anonymous set is very likely to include a low-reputation collaborative user such that a possibility of information leakage is extremely high. In this case,

$${u}_{{P}_{0}}^{i ′} = \{ \begin{matrix}F - L & , T ( {P}_{0} \to S ) \\ - ( F + L ) , & {}^{¬} T ( {P}_{0} \to S )\end{matrix} .$$

An occurrence probability of T(P₀→S) is much lower than an occurrence probability of ¬T(P₀→S). It can be learned through analysis of two rounds of profits that u_{P}_{₀}¹+u_{P}_{₀}¹′=2(F−k*O_{A}_{ᵢ}) and

$${u}_{{P}_{0}}^{{5}^{k}} + max ( {u}_{{P}_{0}}^{i ′} ) = 2 F - L .$$

It can be learned based on k*O_{A}_{ᵢ}«F«L that

$${u}_{{P}_{0}}^{1} + {u}_{{P}_{0}}^{1 ′} > {u}_{{P}_{0}}^{{5}^{k}} + max ( {u}_{{P}_{0}}^{i ′} ) .$$

That is, the requesting user obtains maximum profits if the requesting user honestly executes anonymous transactions.

In conclusion, the lemma 1 is proved.

### (2) Network User

Lemma 2: The network user Pⱼ can obtain the maximum utility function Uti_{P}_{ⱼ} only when honestly participating in the anonymous transaction.

Proof: Analyze, based on the foregoing scheme execution process, strategies C_{P}_{ⱼ}={c_{P}_{ⱼ}¹, c_{P}_{ⱼ}²} that the network user Pⱼ may use in the anonymous transaction process, and utility functions Uti_{P}_{ⱼ}={u_{P}_{ⱼ}¹, u_{P}_{ⱼ}²} corresponding to different strategies. The utility functions u_{P}_{ⱼ}¹ and u_{P}_{ⱼ}² respectively represent profits obtained when the requesting user uses the strategies c_{P}_{ⱼ}¹ and c_{P}_{ⱼ}².

The strategy c_{P}_{ⱼ}¹ indicates that the network user honestly participates in the anonymous transaction without any bad behavior. If the network user Pⱼ is added to the anonymous set, u_{P}_{₀}¹=O_{P}_{ⱼ}−J. If the network user Pⱼ is not added to the anonymous set, u_{P}_{₀}¹=0. The strategy c_{P}_{₀}² indicates that the requesting user forges the identity or tampers with the comprehensive reputation value of the requesting user when broadcasting the collaboration request. In this case, the network user cannot join the anonymous set, and the reputation value of the network user is reduced. u_{P}_{₀}²=0. Apparently, u_{P}_{₀}¹≥u_{P}_{₀}². That is, the strategy c_{P}_{ⱼ}¹ is the best strategy of the network user Pⱼ.

In conclusion, the lemma 2 is proved.

### (3) Collaborative User

Lemma 3: The collaborative user Aᵢ can obtain the maximum utility function Uti_{A}_{ᵢ} only when honestly participating in the anonymous transaction.

Proof: Analyze, based on the foregoing scheme execution process, strategies C_{A}_{ᵢ}={c_{A}_{ᵢ}¹, c_{A}_{ᵢ}², c_{A}_{ᵢ}³, c_{A}_{ᵢ}⁴, c_{A}_{ᵢ}⁵} that the collaborative user Aᵢ may use in the anonymous transaction process, and utility functions Uti_{A}_{ᵢ}={u_{A}_{ᵢ}¹, u_{A}_{ᵢ}², u_{A}_{ᵢ}³, u_{A}_{ᵢ}⁴, u_{A}_{ᵢ}⁵} corresponding to different strategies. The utility functions u_{A}_{ᵢ}¹, u_{A}_{ᵢ}², u_{A}_{ᵢ}³, u_{A}_{ᵢ}⁴, and u_{A}_{ᵢ}⁵ respectively represent profits obtained when the network user uses the strategies c_{A}_{ᵢ}¹, c_{A}_{ᵢ}², c_{A}_{ᵢ}³, c_{A}_{ᵢ}⁴, and c_{A}_{ᵢ}⁵.

The strategy c_{A}_{ᵢ}¹ indicates that the collaborative user Aᵢ honestly participates in the anonymous transaction without any bad behavior. In this case, u_{A}_{ᵢ}¹=O_{A}_{ᵢ}−J. The strategy c_{A}_{ᵢ}² indicates that although the collaborative user completes the collaboration task, the execution delay required by the requesting user is exceeded. In this case, u_{A}_{ᵢ}² is still O_{A}_{ᵢ}−J, but the reputation value of the collaborative user is reduced. The strategy c_{A}_{ᵢ}³ indicates that the collaborative user leaks the transaction information of the requesting user when executing the collaboration task, and cannot obtain remuneration because the collaborative user leaks the information of the requesting user. Therefore, u_{A}_{ᵢ}³=L−J. The strategy c_{A}_{ᵢ}⁴ indicates that the collaborative user does not execute the collaboration task sent by the requesting user. In this case, the collaborative user Aᵢ cannot obtain remuneration, and the reputation value of the collaborative user is reduced. u_{A}_{ᵢ}⁴=0. The strategy c_{A}_{ᵢ}⁵ indicates that the collaborative user does not execute the collaboration task issued by the requesting user, and leaks the information of the requesting user. In this case, u_{A}_{ᵢ}⁵=L. It can be learned from L»O_{A}_{ᵢ}>J that u_{A}_{ᵢ}⁵>u_{A}_{ᵢ}³>u_{A}_{ᵢ}¹=u_{A}_{ᵢ}²>u_{A}_{ᵢ}⁴. For single-round profits, the greatest profit is obtained when the strategy c_{A}_{ᵢ}⁵ is used, followed by the strategies c_{A}_{ᵢ}³, c_{A}_{ᵢ}¹, and c_{A}_{ᵢ}².

According to the lemma 1, when the collaborative user who uses the strategy c_{A}_{ᵢ}¹ participates in another anonymous transaction as a requesting user, a profit obtained by using the strategy u_{A}_{ᵢ}_{→P}_{₀}¹′ is maximum. u_{A}_{ᵢ}¹+u_{A}_{ᵢ}_{→P}_{₀}¹′=F−(k−1)*O_{A}_{ᵢ}−J>0. When the collaborative user who uses another strategy participates in another anonymous transactions as a requesting user, the previous bad behavior reduces the reputation value of the collaborative user such that an actual occurrence probability of T(P₀→S) is much lower than an occurrence probability of ¬T(P₀→S) during the anonymous transaction. Assuming that the probabilities are equal, it can be learned based on the utility function

$${u}_{{A}_{i} \to {P}_{0}}^{i ′} = \{ \begin{matrix}F - L & , T ( {P}_{0} \to S ) \\ - ( F + L ) , & {}^{¬} T ( {P}_{0} \to S )\end{matrix}$$

that mid(u_{A}_{ᵢ}_{→P}_{₀}ⁱ′)=−L and real(u_{A}_{ᵢ}_{→P}_{₀}ⁱ′)<mid(u_{A}_{ᵢ}_{→P}_{₀}ⁱ′). It can be calculated that combined profits of the two rounds are u_{A}_{ᵢ}⁵+mid(u_{A}_{ᵢ}_{→P}_{₀}ⁱ′)=0. u_{A}_{ᵢ}³+mid(u_{A}_{ᵢ}_{→P}_{₀}ⁱ′)=O_{A}_{ᵢ}−J−L<0, and u_{A}_{ᵢ}²+mid(u_{A}_{ᵢ}_{→P}_{₀}ⁱ′)=O_{A}_{ᵢ}−J−L<0. Therefore, u_{A}_{ᵢ}¹+u_{A}_{ᵢ}_{→P}_{₀}¹′>u_{A}_{ᵢ}⁵+real(u_{A}_{ᵢ}_{→P}_{₀}ⁱ′)>u_{A}_{ᵢ}²+real(u_{A}_{ᵢ}_{→P}_{₀}ⁱ′). Therefore, in the long run, honest participation in anonymous transactions is a better strategy for the collaborative user.

In conclusion, the lemma 3 is proved.

The following theorem can be obtained by proving the lemmas 1, 2, and 3.

Theorem 1: When the requesting user P₀, network user Pⱼ, and collaborative user Aᵢ are rational and self-interested users, honestly participating in anonymous transactions is the best strategy they can select. Therefore, the scheme proposed in the present disclosure satisfies the incentive compatibility constraint. The network user can be promoted to positively respond to the collaboration request of the requesting user. The requesting user is helped to construct the anonymous set that meets the privacy requirement and reputation requirement of the requesting user. In addition, behavior of the user in the anonymous transaction process is restricted and honesty of the user is improved.

### 3.2 Security

This section mainly analyzes an ability of the scheme to respond to an attack. Attacks may be classified into an internal attack, an external attack, a collusion attack, free-rider behavior induced by an incentive mechanism, and the like based on sources and properties of the attacks.

### (1) Internal Attack

The collaborative user Aᵢ in the anonymous transaction model is untrusted and even likely to be malicious. To maximize profits of the collaborative user, the collaborative user may leak the collaboration task

$${w}_{{P}_{0}}^{{A}_{i}} = ( M , Δ t , add ( {A}_{i + 1} ) , {Sign}_{{P}_{0}} ( M ‖ Δ t ‖ add ( {A}_{i + 1} ) ) )$$

sent by the requesting user to the collaborative user, for an additional profit L; or may steal funds M transferred by the requesting user to an account of the collaborative user, without providing any service. In addition, a lazy collaborative user may intentionally delay a service time to reduce execution efficiency of the scheme. Based on incentive compatibility, the collaborative user harms the interests of the collaborative user when taking these malicious actions. Reduction in the reputation of the collaborative user also puts the collaborative user at a disadvantage in a double auction. Therefore, the anonymous transaction scheme based on reputation evaluation and a double auction proposed in the present disclosure can restrict behavior of collaborative users, to better resist internal attacks.

### (2) External Attack

A malicious attacker may forge identities of a plurality of network users to receive collaboration requests from a target user, hoping to join an anonymous set to obtain collaboration task information

$${w}_{{P}_{0}}^{{A}_{i}} = ( M , Δ t , add ( {A}_{i + 1} ) , {Sign}_{{P}_{0}} ( M ‖ Δ t ‖ add ( {A}_{i + 1} ) ) )$$

issued by a requesting user, and recover actual transaction information D(P₀→S) of the requesting user by obtaining as much collaboration task information as possible. Apparently, a possibility that the malicious attacker identifies both parties of the actual transaction is affected by a privacy requirement k of the requesting user P₀. When k=1, the actual transaction D(P₀→S) may be transformed into d₀(P₀→A₁)·d₁(A₁→S). The attacker only needs to forge an identity of a collaborative user A₁ to easily obtain information about both parties of the actual transaction. Assuming that a cost of the attacker in this case is H, a possibility of forging an identity to become the collaborative user A₁ is h⁻¹. When k=n, the attacker needs to forge identities of n collaborative users to break transaction anonymity. A cost nH of the attacker is huge and a possibility h⁻ⁿ is very low. Therefore, as the privacy requirement k of the requesting user increases, the attacker needs to pay more to launch a Sybil attack, and a possibility of success of the attack is lower. In addition, the double auction mechanism makes generation of the anonymous set Set more random, resulting in a very low possibility that the attacker can join the anonymous set of the target user. Therefore, the scheme proposed in the present disclosure can effectively handle Sybil attacks.

### (3) Collusion Attack

### 1) Collusion Between Collaborative Users

A single collaborative user Aᵢ can obtain only some transaction information dᵢ(Aᵢ [symbol] Aᵢ₊₁). Therefore, the collaborative user tries to collude with other collaborative users, integrate information obtained by the collaborative users to infer an actual transaction T(P₀→S) of a requesting user P₀, and destroy transaction anonymity. However, only the requesting user P₀ knows which collaborative users are included in an anonymous set Set and where the collaborative users are located in a transaction link. The collaborative user Aᵢ knows only an account address of Aᵢ₊₁. Therefore, it is difficult for collaborative users to reach collusion. In addition, as a privacy requirement k of the requesting user increases, a possibility of collusion among the collaborative users further decreases.

### 2) Collusion Between an Attacker and a Collaborative User

Based on the foregoing analysis, it is difficult for an attacker to steal information by forging an identity to join an anonymous set of a target user. It is also difficult for collaborative users to reach collusion. However, when an attacker colludes with a collaborative user, the attacker can obtain some transaction information dᵢ(Aᵢ [symbol] Aᵢ₊₁) obtained after division by a requesting user P₀, without joining the anonymous set. Because an actual transaction T(P₀→S) is divided into k+1 transactions, the attacker needs to collude with k collaborative users to break transaction anonymity. However, the double auction mechanism makes this unlikely to happen. In addition, the scheme in the present disclosure satisfies the incentive compatibility constraint. The collaborative users all choose to honestly participate in anonymous transactions to obtain maximum profits. Therefore, it is extremely unlikely that the attacker can collude with the collaborative users and obtain actual transaction information of the requesting user.

### 3) Collusion Between a Requesting User and A₁

The requesting user P₀ may collude with the collaborative user A₁ to deceive the other collaborative users into helping the requesting user complete an anonymous transaction without transferring anonymous transaction funds M. Because the collaborative user A₁ needs to verify a fund transfer transaction d₀(P₀ [symbol] A₁) of the requesting user P₀, if the collaborative user colludes with the requesting user, the collaborative user broadcasts a false message to deceive the other collaborative users {A₂ . . . , Aᵢ, . . . , Aₖ} into executing collaboration tasks issued by the requesting user. In this case, D(P₀→S)⇔d₀(P₀⊗A₁)·d₁(A₁⊗A₂)· . . . ·dₖ₋₁(Aₖ₋₁→Aₖ)·dₖ(Aₖ→S). However, because broadcast information message(·) needs to be jointly verified by blockchain nodes, it is apparent that false information cannot pass verification. In addition, information verified as false information is used as a credential for punishing the requesting user P₀ and the collaborative user A₁. Therefore, the rational requesting user P₀ and collaborative user A₁ do not choose to launch a collusion attack in order not to reduce their reputations.

### (4) Free-Rider Behavior

Free-rider behavior means that a user can enjoy a same service as the other users without any costs. In the present disclosure, free-rider behavior means that a user can generate an anonymous set as a requesting user without serving as a collaborative user to help a requesting user execute an anonymous transaction. The anonymous transaction scheme based on reputation evaluation and a double auction provided in the present disclosure can effectively reduce occurrence of free-rider behavior. If a user does not participate in construction of an anonymous set, a reputation value of the user is always in an initial state. When the user broadcasts a collaboration request as a requesting user, it is difficult to generate an anonymous set that meets a privacy requirement and a reputation requirement of the user. Even if the anonymous set is generated, the user needs to pay high remuneration to collaborative users. If a low-reputation collaborative user in the anonymous set has bad behavior, the requesting user faces greater privacy leakage risks and economic losses. Therefore, rational users actively participate in anonymous transactions to enhance their reputation values to reduce risks they face in the anonymous transactions as much as possible.

In conclusion, the scheme provided in the present disclosure can effectively handle the foregoing possible attacks.

To prove the inventive step and the technical value of the technical solutions of the present disclosure, this section is an application embodiment of the technical solutions in the claims on specific products or related technologies.

With continuous popularization of intelligent terminal devices and development and innovation of a mobile payment technology, application scenarios of mobile payment gradually tend to be diversified and vertical, covering all aspects of people's daily lives, and mobile payment has become a mainstream payment method in society. However, privacy security issues of mobile payment are constantly emerging while the mobile payment industry is generally booming. In a real scenario, when a user uses mobile payment for account settlement in a store, because a geographical location of the store is relatively fixed, a payment platform can easily determine a physical relation between the user and the consumption location thereof based on user transaction information grasped by the payment platform and store location information provided by a merchant. Therefore, people are facing leakage risks of personal privacy information while enjoying convenience of mobile payment. Existing technical solutions cannot resolve a location privacy leakage problem in mobile payment. The anonymous set generation scheme based on reputation evaluation and a double auction in the present disclosure can help the requesting user construct the anonymous set that meets the privacy requirement, reputation requirement, and bid standard of the requesting user. The direct transaction association between the user and the merchant can be cut off by introducing the anonymous set constructed by collaborative users, to implement transaction anonymization of mobile payment and further protect location information security of the mobile payment user.

### 4. Experimental Analysis

In this experiment, an elliptic curve public key cryptographic algorithm SM2 issued by the State Cryptography Administration of China is used to encrypt and sign information in an anonymous transaction process. The Java programming language is used to implement the elliptic curve public key cryptographic algorithm SM2 based on elliptic curves and a distributed double auction algorithm. An experimental environment is 11th Gen Intel® Core™ i5-1135G7@2.40 GHz (8 CPUs),˜2.4 GHz 8192 MB RAM, and an operating system is Windows10-64 bit.

### 4.1 Anonymous Set Generation

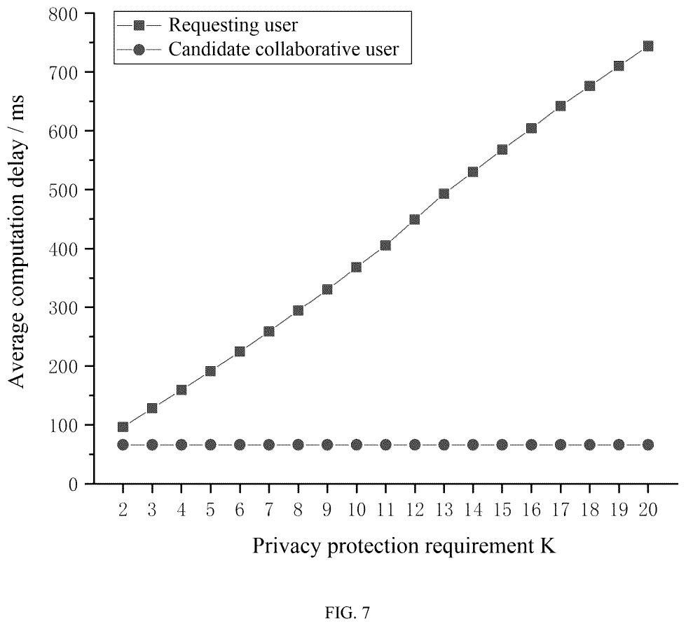

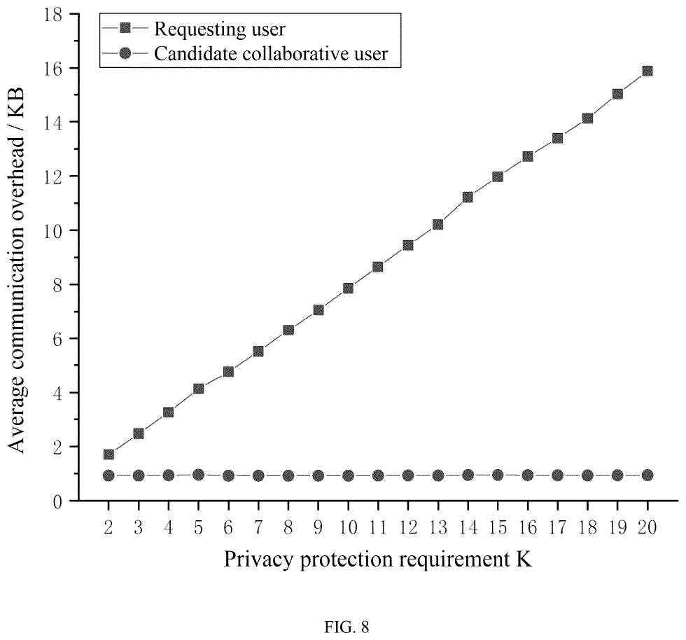

In this part of the experiment, a condition that a network user Pⱼ automatically responds to a requesting user Pᵢ is |X_{P}_{ⱼ}−X_{P}_{ᵢ}|≤0.1, a reputation value X_{P}_{ᵢ} of the requesting user Pᵢ is 0.6, and reputation values of the other users in a network are all an initial reputation value X_{P}_{ⱼ}=0.5. When the requesting user broadcasts an anonymous transaction collaboration request, all users in the network respond to the collaboration request of the requesting user based on the automatic response condition. When the requesting user receives replies of more than K network users, the requesting user selects K users from the candidate collaborative users to form an anonymous set. Average computation delays and communication overheads required by the requesting user and the candidate collaborative user in an anonymous set generation process are shown in FIG. 7 and FIG. 8, respectively.

When the requesting user implements an anonymous transaction through the scheme in the present disclosure, the average computation delay and communication overhead required to generate the anonymous set both increase as the privacy requirement K of the requesting user increases. However, the privacy requirement K of the requesting user does not affect the average computation delay and communication overhead required by the candidate collaborative user. A reason for the foregoing phenomenon is that as K increases, the requesting user needs to receive messages sent by more candidate collaborative users. In addition, a quantity of times decryption is performed to obtain message content of the candidate collaborative users and signature data of the candidate collaborative users is verified increase such that the computation delay and communication overhead of the requesting user increase. However, when the reputation value of the requesting user meets the automatic response condition, the candidate collaborative user only needs to generate ciphertext of reply content of the candidate collaborative user by using a public key of the requesting user, and then send the ciphertext and signature data corresponding to the ciphertext to the requesting user. Therefore, the average computation delay and communication overhead required by the candidate collaborative user in the anonymous set generation process are independent of K.

It can be found from experimental data that when the requesting user generates the anonymous set through the scheme in the present disclosure, the average computation delays and communication overheads required by the requesting user and the candidate collaborative user are limited. When K=20, the average computation delay and average communication overhead required by the requesting user are respectively 744.11 ms is 15.878 KB; and the average computation delay and average communication overhead of the candidate collaborative user are respectively 66.174 ms and 0.941 KB. Therefore, the scheme in the present disclosure can efficiently generate anonymous sets for requesting users.

### 4.2 Communication Overhead Required in the Transaction Execution Phase

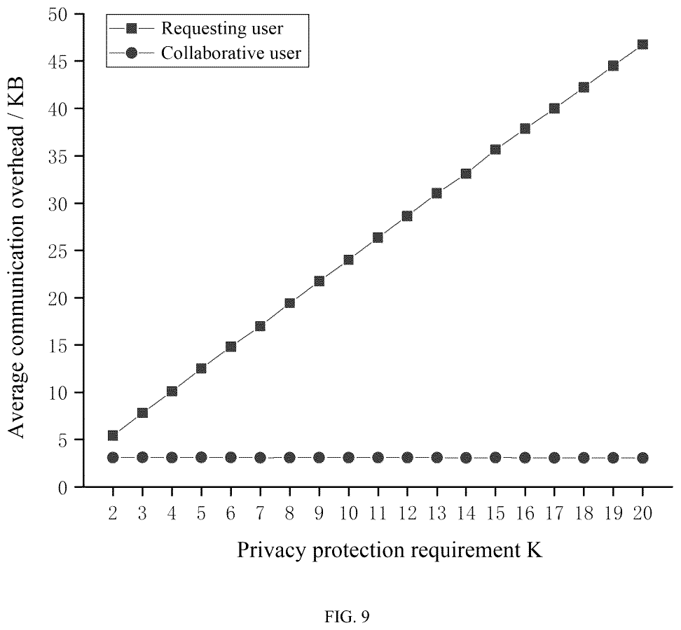

Average communication overheads required by the requesting user and the collaborative user in the transaction execution phase are analyzed below, as shown in FIG. 9. The average communication overhead required by the requesting user in the transaction execution phase increases as the privacy requirement K of the requesting user increases. A reason is that as K increases, the requesting user needs to send collaboration tasks to more collaborative users and receive more collaboration credentials, causing the communication overhead to increase. However, the average communication overhead of the collaborative user Aᵢ(1≤i≤K) does not significantly change when K varies. No matter how the privacy requirement K of the requesting user changes, quantities of collaboration tasks received and collaboration credentials sent by the collaborative user do not change. Therefore, the privacy requirement of the requesting user does not affect the average communication overhead of the collaborative user in the transaction execution phase.

### 4.3 Impact of a Quantity of Users in a Network on the Scheme

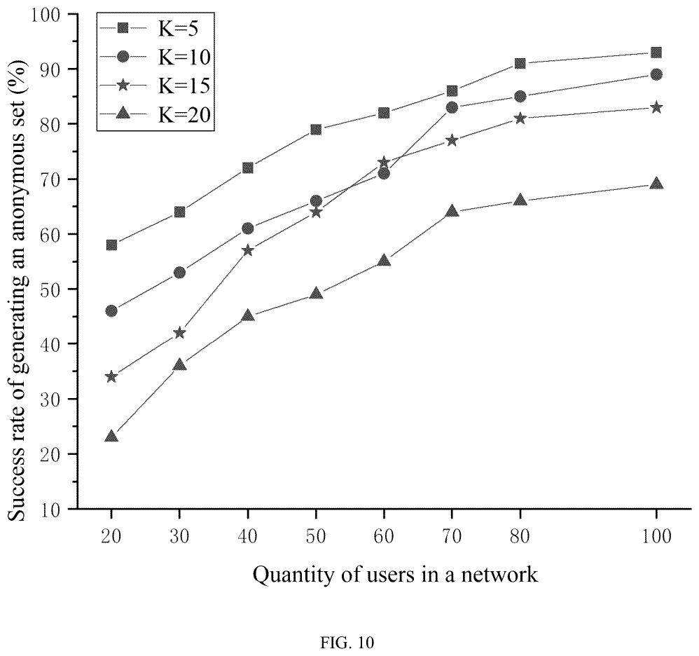

The present disclosure mainly analyzes impact of a quantity of users in a network on a success rate of generating an anonymous set through the scheme. In the experiment, a condition that a network user Pⱼ automatically responds to a requesting user Pᵢ is set to |X_{P}_{ⱼ}−X_{P}_{ᵢ}|≤0.1, and reputation values X_{P} of all users in the network are generated by generating random numbers. Then, the distributed double auction algorithm is repeatedly executed for different privacy requirements K of the requesting user. Experimental results are shown in FIG. 10.

### 4.4 Impact of an Automatic Response Condition on the Scheme

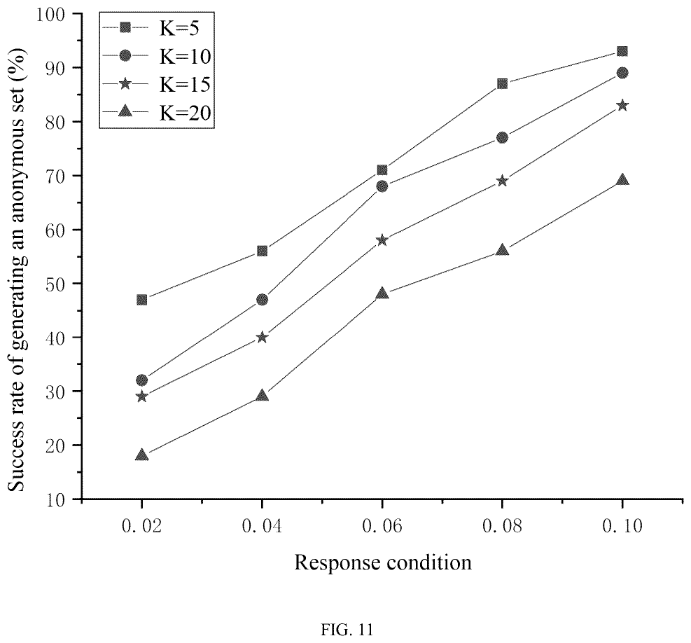

This experiment is used to analyze impact of an automatic response condition on a success rate of generating an anonymous set through the scheme. In the experiment, given that there are 100 users in a network, reputation values X_{P} of all users in the network are generated by generating random numbers. Then, different automatic response conditions |X_{P}_{ⱼ}−X_{P}_{ⱼ}|≤0.02, |X_{P}_{ⱼ}−X_{P}_{ᵢ}|≤0.04, |X_{P}_{ⱼ}−X_{P}_{ᵢ}|0.06, |X_{P}_{ⱼ}−X_{P}_{ᵢ}|≤0.08, and |X_{P}_{ⱼ}−X_{P}_{ᵢ}|≤0.1 are set to repeatedly execute the distributed double auction algorithm. Experimental results are shown in FIG. 11.

It should be noted that the embodiments of the present disclosure may be implemented by hardware, software, or a combination of software and hardware. The hardware part may be implemented through special logic. The software part may be stored in a memory and executed by a suitable instruction execution system, such as a microprocessor or specially designed hardware. Those of ordinary skill in the art can understand that the device and method described above may be implemented through computer-executable instructions and/or embodied in processor control code, and such code is provided, for example, on a carrier medium such as a disk, compact disc (CD) or digital video disc (DVD)-read-only memory (ROM), a programmable memory such as a ROM (firmware), or a data carrier such as an optical or electronic signal carrier. The device of the present disclosure and its modules may be implemented by hardware circuits such as very large-scale integrated circuits (VLSI) or gate arrays, semiconductors such as logic chips and transistors, or programmable hardware devices such as field programmable gate arrays and programmable logic devices, or by software executed by various types of processors, or by a combination of the foregoing hardware circuits and software, such as firmware.

The foregoing descriptions are merely descriptions of the specific embodiments of the present disclosure, and the protection scope of the present disclosure is not limited thereto. Any modification, equivalent replacement, improvement, and the like made within the technical scope of the present disclosure by those skilled in the art according to the spirit and principle of the present disclosure shall fall within the protection scope of the present disclosure.

What is claimed is:

1. A method for protecting location privacy in mobile payment, comprising: introducing a decentralized coin mixing idea into mobile payment, and constructing an anonymous transaction model and a reputation evaluation model in a mobile payment environment; designing a user reputation evaluation scheme, and measuring a reputation value of a user based on historical behavior of the user; designing an anonymous transaction scheme based on reputation evaluation and a double auction, and establishing a functional relationship between the reputation value of the user and an auction bid; selecting, through the double auction, candidate collaborative users who meet a reputation requirement, a privacy requirement and a bid standard of a requesting user, to construct an anonymous set; and inserting the anonymous set constructed by collaborative users between the user and a merchant to cut off a direct transaction association between the user and the merchant and implement transaction anonymization.

2. The method for protecting location privacy in mobile payment according to claim 1, wherein the anonymous transaction model in the mobile payment environment constructed based on the decentralized coin mixing idea comprises the requesting user, the collaborative users and the merchant, and a secure communication link exists between the requesting user and the collaborative user;
a set of all users in a network is U={P₀, P₁, P₂, . . . , Pₙ, . . . , Pₘ}, the requesting user P₀ is an initiator of an anonymous transaction, sends an anonymous transaction collaboration request Q_{P}_{₀} to the other users U′={P₁, P₂, . . . , Pₙ, . . . , Pₘ} in the network, and selects k users from n candidate collaborative users who accept the collaboration request, to construct the anonymous set Set={A₁ . . . , Aᵢ, . . . ,Aₖ}, and k is the privacy requirement of the requesting user P₀; the anonymous set Set is introduced to transform an actual transaction D(P₀→S) into D(P₀→S)⇒D₀(P₀→A_{Set})·D₁(A_{Set}→S), wherein D₀(P₀→A_{Set}) is used to cut off the direct transaction association between the requesting user P₀ and the merchant S, and D₁(A_{Set}→S) is used to ensure that funds are transferred to a correct merchant account; after the anonymous set is successfully constructed, the requesting user P₀ divides the original transaction as follows: D(P₀→S)⇒d₀(P₀→A₁)·d₁(A₁→A₂)· . . . ·dₖ₋₁(Aₖ₋₁→Aₖ)·dₖ(Aₖ→S), and each transaction dᵢ(Aᵢ→Aᵢ₊₁) obtained after the division is executed by a collaborative user Aᵢ to implement a flow of the funds of the requesting user; the collaborative user Aᵢ is a participant in the anonymous transaction and obtains remuneration by providing a collaboration service to the requesting user; after receiving a collaboration task dᵢ(Aᵢ→Aᵢ₊₁) sent by the requesting user P₀, the collaborative user Aᵢ transfers a fixed amount of funds to an account of Aᵢ₊₁ based on collaboration content, and the collaborative user of the current transaction is a requesting user of a next transaction; and the merchant S is an actual recipient of the anonymous transaction, does not participate in a specific execution process of the anonymous transaction, and serves only as a final recipient of the funds;
impact of the historical behavior of the user in an anonymous transaction process on the reputation value of the user is analyzed through the reputation evaluation model; within a discrete time period T={1, 2, . . . , t, . . . }, the requesting user P₀ broadcasts the collaboration request Q_{P}_{₀} in expectation of a response from the network user Pⱼ, to generate the anonymous set Set; if the requesting user has malicious behavior of falsifying information, deceiving the collaborative user into executing a false anonymous transaction, or not paying remuneration to the collaborative user who executes a transaction in the anonymous transaction process, a reputation value of the requesting user is reduced as a penalty; and a formula for measuring an instantaneous reputation value X_{P}_{₀}(t) of the requesting user P₀ at a moment t is as follows:
$${χ}_{{P}_{0}} ( t ) = max ( 0 , {χ}_{{P}_{0}} ( t - 1 ) - n * \frac{{β}_{{P}_{0}}^{t}}{{α}_{{P}_{0}}^{t} + {β}_{{P}_{0}}^{t}} ) ,$$
if the network user Pⱼ has behavior of falsifying information during response to the requesting user P₀, a reputation value of the network user is reduced as a penalty; and a formula for measuring an instantaneous reputation value X_{P}_{ⱼ}(t) of the network user Pⱼ at the moment t is as follows:
$${χ}_{{P}_{j}} ( t ) = max ( 0 , {χ}_{{P}_{j}} ( t - 1 ) - n * \frac{{β}_{{P}_{j}}^{t}}{{α}_{{P}_{j}}^{t} + {β}_{{P}_{j}}^{t}} ) ,$$
if the collaborative user Aᵢ leaks the specific collaboration task dᵢ(Aᵢ→Aᵢ₊₁) issued by the requesting user P₀, or delays or interrupts execution of the collaboration task, a reputation value of the collaborative user is reduced as a penalty; if the collaborative user honestly executes the collaboration task, the reputation value of the collaborative user is increased as a reward; and a formula for measuring an instantaneous reputation value X_{A}_{ᵢ}(t) of the collaborative user Aᵢ at the moment t is as follows:
$${χ}_{{A}_{i}} ( t ) = \{ \begin{matrix}min ( 1 , {χ}_{{A}_{i}} ( t - 1 ) + p * \frac{{α}_{{A}_{i}}^{t}}{{α}_{{A}_{i}}^{t} + {β}_{{A}_{i}}^{t}} ) \\ max ( 0 , {χ}_{{A}_{i}} ( t - 1 ) - n * \frac{{β}_{{A}_{i}}^{t}}{{α}_{{A}_{i}}^{t} + {β}_{{A}_{i}}^{t}} )\end{matrix} ,$$
wherein p is an incentive factor, n is a penalty factor, α_{P}^{t} is a cumulative quantity of times the user honestly participates in anonymous transactions by t, and β_{P}^{t} is a cumulative quantity of times the user has bad behavior by t; 0<p«n<1, and a self-interested user is prompted to adhere to rational consensus by increasing a penalty; and the instantaneous reputation value of the user meets a condition 0≤X_{P}(t)≤1, and an initial reputation value X_{P}(0) of the user is 0.5;
each instantaneous reputation value X_{P}(t) of the user in the anonymous transaction process is fused to calculate a comprehensive reputation value of the user; and a quadratic decreasing function is used to define a weight of each instantaneous reputation value X_{P}(t) of the user in the comprehensive reputation value as follows:
$$ω ( {χ}_{P} ( t ) ) = \{ \begin{matrix}{( 1 - \frac{T - t}{Γ} )}^{2} & , T - Γ < t \leq T \\ 0 & , 0 \leq t \leq T - Γ\end{matrix} ,$$
wherein T is a current moment, and Γ is a validity period of the reputation value; when t=T, ω(X_{P}(t))=1, that is, when X_{P}(t) is a reputation value at the current moment, a weight of the reputation value in the comprehensive reputation value is 1; when 0≤t≤−Γ, ω(X_{P}(t))=0, indicating that a reputation value at a moment with an interval to the current moment T exceeding the validity period Γ is not used for evaluation; and the comprehensive reputation value of the user is finally obtained through a weighted average sum method as follows:
$${χ}_{P} = {\sum }_{T - Γ < t \leq T} ( {χ}_{P} ( t ) * \frac{ω ( {χ}_{P} ( t ) )}{{\sum }_{T - Γ < t \leq T} ω ( {χ}_{P} ( t ) )} ) ,$$
a double auction mechanism comprises: in the network, n requesting users U={P₀, P₁, P₂, . . . , Pₙ} are waiting for anonymous services and m network users U′={Pₙ₊₁, Pₙ₊₂, . . . , Pₙ₊ₘ} are waiting to receive collaboration tasks; and each requesting user Pᵢ∈U broadcasts a collaboration request Q_{P}_{ᵢ}=(X_{P}_{ᵢ}, M, Δt, O_{P}_{ᵢ}) to the other user Pⱼ∈U′ in the network, wherein X_{P}_{ᵢ} is a comprehensive reputation value of the requesting user, M is an actual transaction amount of the requesting user, Δt is an acceptable anonymous transaction execution delay of the requesting user, and O_{P}_{ᵢ} is a bid base of the auction; and
the bid base of the requesting user is
$${O}_{{P}_{i}} = \frac{M * φ ( Δ t )}{{χ}_{{P}_{i}}} ,$$
wherein φ(Δt) is a decreasing function; a bid O_{P}_{ⱼ} of the network user Pⱼ needs to have a positive correlation with the bid base of the requesting user, and the bid of the network user is O_{P}_{ⱼ}=O_{P}_{ᵢ}*X_{P}_{ⱼ}*ρ, wherein ρ is a control coefficient used to limit overbidding; after receiving the collaboration request Q_{P}_{ᵢ}, the network user Pⱼ∈U′ ranks the requesting user in ascending order of the bid base O_{P}_{ᵢ} and the comprehensive reputation value X_{P}_{ᵢ}, and determines, based on a comprehensive ranking of the bid base and the comprehensive reputation value of the requesting user Pᵢ, whether to accept the request; if the network user accepts the request, the network user sends a reply R_{P}_{ⱼ}=(X_{P}_{ⱼ}, O_{P}_{ⱼ}) to the requesting user; or if the network user rejects the request, the network user does not respond; the network user selectively accepts collaboration requests of a plurality of requesting users based on a capability of the network user, and establishes a to-be-executed task set W_{P}_{ⱼ}={w₁, w₂, . . . , wₙ}; and the requesting user Pᵢ arranges the candidate collaborative users in ascending order of comprehensive reputation value and in descending order of bid, and determines that k users whose comprehensive ranking is the highest constitute the anonymous set Set={A₁ . . . , Aᵢ, . . . , Aₖ}.

3. The method for protecting location privacy in mobile payment according to claim 1, comprising the following steps:
step 1: in an anonymous set generation phase, describing a mutual relationship between users from a perspective of a supply-demand relationship, and generating the anonymous set for the requesting user through a double auction mechanism;
step 2: in a transaction execution phase, executing an anonymous transaction based on the anonymous transaction model; and
step 3: in a reputation update phase, updating reputations of the users based on the reputation evaluation scheme and bad user behavior defined in the anonymous set generation phase and the transaction execution phase.

4. The method for protecting location privacy in mobile payment according to claim 3, wherein the anonymous set generation phase in step 1 comprises:
(1) before executing a mobile payment transaction, broadcasting, by the requesting user P₀, a collaboration request Q_{P}_{₀}=(X_{P}_{₀}, M, Δt, O_{P}_{₀}, Sign_{P}_{₀}(X_{P}_{₀}∥M∥Δt∥O_{P}_{₀})) to the other users in a network, wherein Sign(·) is a secure signature function, and Sign_{P}_{₀}(X_{P}_{₀}∥M∥Δt∥O_{P}_{₀}) indicates that the requesting user P₀ signs a comprehensive reputation value, a transaction amount, and an acceptable task execution delay by using a private key;
(2) after receiving the collaboration request Q_{P}_{₀}=(X_{P}_{₀}, M, Δt, O_{P}_{₀}, Sign_{P}_{₀}(X_{P}_{₀}∥M∥Δt∥O_{P}_{₀})) sent by the requesting user P₀, verifying, by the network user Pⱼ, correctness of the signature information Sign_{P}_{₀}(X_{P}_{₀}∥M∥Δt∥O_{P}_{₀}) and the comprehensive reputation value X_{P}_{₀} of the requesting user P₀ in the collaboration request Q_{P}_{₀}:
1) if Ver_{P}_{₀}(Sign_{P}_{₀}(X_{P}_{₀}∥M∥Δt∥O_{P}_{₀})=Sign_{P}_{₀}(X_{P}_{₀}∥M∥Δt∥O_{P}_{₀}), indicating that an identity of the requesting user passes the verification, verifying the comprehensive reputation value X_{P}_{₀} of the requesting user; and
if
$$Ver ( {χ}_{{P}_{0}} ) = {\sum }_{T - Γ < t \leq T} ( {χ}_{{P}_{0}} ( t ) * \frac{ω ( {χ}_{{P}_{0}} ( t ) )}{{\sum }_{T - Γ < t \leq T} ω ( {χ}_{{P}_{0}} ( t ) )} ) ,$$
indicating that the identity and the comprehensive reputation value of the requesting user both pass the verification, determining, by the network user based on a bid base O_{P}_{₀} given by and the comprehensive reputation value X_{P}_{₀} of the requesting user, whether to accept the collaboration request; if the network user Pⱼ accepts the collaboration request of the requesting user P₀, sending a reply R_{P}_{ⱼ}=(X_{P}_{ⱼ}, O_{P}_{ⱼ}, add(Pⱼ) ,Sign_{P}_{ⱼ}(X_{P}_{ⱼ}∥O_{P}_{ⱼ}∥add(Pⱼ))) to the requesting user P₀, wherein add(Pⱼ) is an account address of the network user Pⱼ; otherwise, not responding; and
accepting, by the network user, collaboration requests of a plurality of requesting users based on a capability of the network user, to form a to-be-executed task set W_{P}_{ⱼ}={w₁, w₂, . . . , wₙ}; or
if
$$Ver ( {χ}_{{P}_{0}} ) \neq {\sum }_{T - Γ < t \leq T} ( {χ}_{{P}_{0}} ( t ) * \frac{ω ( {χ}_{{P}_{0}} ( t ) )}{{\sum }_{T - Γ < t \leq T} ω ( {χ}_{{P}_{0}} ( t ) )} ) ,$$
indicating that the comprehensive reputation value of the requesting user fails the verification, broadcasting, by the network user Pⱼ, information message_{P}_{ⱼ}(¬X_{P}_{₀}); or
2) if Ver_{P}_{₀}(Sign_{P}_{₀}(X_{P}_{₀}∥M∥Δt∥O_{P}_{₀})≠Sign_{P}_{₀}(X_{P}_{₀}∥M∥Δt∥O_{P}_{₀}), indicating that an identity of the requesting user fails the verification, broadcasting, by the network user Pⱼ, information message_{P}_{ⱼ}(¬P₀) without verifying the comprehensive reputation value X_{P}_{₀} of the requesting user, wherein Ver(·) is a verification function, Ver_{P}_{₀}(Sign_{P}_{₀}(X_{P}_{₀}∥M∥Δt∥O_{P}_{₀})) indicates verification of correctness of the signature information Sign_{P}_{₀}(X_{P}_{₀}∥M∥Δt∥O_{P}_{₀}) by using a public key of the requesting user P₀, and if the verification fails, Sign_{P}_{₀}(X_{P}_{₀}∥M∥Δt∥O_{P}_{₀}) is not a signature generated through encryption performed by using the private key of P₀, and the identity of the requesting user is likely to be forged;
(3) verifying, by the requesting user P₀, correctness of the reply R_{P}_{ⱼ}=(X_{P}_{ⱼ},O_{P}_{ⱼ}, add(Pⱼ), Sign_{P}_{ⱼ}(X_{P}_{ⱼ}∥O_{P}_{ⱼ}∥add(Pⱼ))) of the network user Pⱼ:
1) if Ver_{P}_{ⱼ}(Sign_{P}_{ⱼ}(X_{P}_{ⱼ}∥O_{P}_{ⱼ}∥add(Pⱼ)))=Sign_{P}_{ⱼ}(X_{P}_{ⱼ}∥O_{P}_{ⱼ}∥add(Pⱼ)), indicating that an identity of the network user passes the verification, verifying a comprehensive reputation value of the network user; and
if
$$Ver ( {χ}_{{P}_{j}} ) = {\sum }_{T - Γ < t \leq T} ( {χ}_{{P}_{j}} ( t ) * \frac{ω ( {χ}_{{P}_{j}} ( t ) )}{{\sum }_{T - Γ < t \leq T} ω ( {χ}_{{P}_{j}} ( t ) )} ) ,$$
indicating that the comprehensive reputation value of the network user passes the verification, taking the network user Pⱼ as a candidate collaborative user; or
if
$$Ver ( {χ}_{{P}_{j}} ) \neq {\sum }_{T - Γ < t \leq T} ( {χ}_{{P}_{j}} ( t ) * \frac{ω ( {χ}_{{P}_{j}} ( t ) )}{{\sum }_{T - Γ < t \leq T} ω ( {χ}_{{P}_{j}} ( t ) )} ) ,$$
indicating that the comprehensive reputation value of the network user fails the verification, broadcasting, by the requesting user P₀, information message_{P}_{₀}(¬X_{P}_{ⱼ}); or
2) if Ver_{P}_{ⱼ}(Sign_{P}_{ⱼ}(X_{P}_{ⱼ}∥O_{P}_{ⱼ}∥add(Pⱼ)))≠Sign_{P}_{ⱼ}(X_{P}_{ⱼ}∥O_{P}_{ⱼ}∥add(Pⱼ)), indicating that an identity of the network user fails the verification, broadcasting, by the requesting user P₀, information message_{P}_{₀}(¬Pⱼ) without verifying the comprehensive reputation value X_{P}_{ⱼ} of the network user; and
(4) ranking, by the requesting user P₀, the candidate collaborative user in ascending order of the comprehensive reputation value X_{P}_{ⱼ} and in descending order of a bid O_{P}_{ⱼ} to obtain a comprehensive reputation value ranking N_{X}(Pⱼ) and a bid ranking N_{O}(Pⱼ) of the candidate collaborative user Pⱼ, wherein a comprehensive ranking of the candidate collaborative user is N(Pⱼ)=N_{X}(Pⱼ)+N_{O}(Pⱼ); selecting k users whose comprehensive ranking N(Pⱼ) is the highest from all candidate collaborative users to form the anonymous set Set={A₁ . . . , Aᵢ, . . . , Aₖ}; and if a current size k of the anonymous set does not meet a privacy protection requirement of the requesting user, continuing to wait for the other network users to reply;
wherein in the anonymous set generation phase, after the network user Pⱼ receives the collaboration request Q_{P}_{₀} sent by the requesting user P₀ or after the requesting user P₀ receives the reply R_{P}_{ⱼ} sent by the network user, the correctness of the signature information and the comprehensive reputation value is verified to confirm authenticity of the identity and the comprehensive reputation value of the user.

5. The method for protecting location privacy in mobile payment according to claim 3, wherein the transaction execution phase in step 2 comprises:
(1) executing, by the requesting user P₀, a fund transfer transaction d₀(P₀ [symbol] A₁), and sending a transaction credential
$${V}_{{P}_{0}} = ( {Num}_{{d}_{0}}^{{P}_{0}} , {Sign}_{{P}_{0}} ( {Num}_{{d}_{0}}^{{P}_{0}} ) )$$
to the collaborative user A₁, wherein
$${Num}_{{d}_{0}}^{{P}_{0}}$$
represents a transaction number obtained after the requesting user P₀ executes d₀(P₀ [symbol] A₁); and sending a collaboration task
$${w}_{{P}_{0}}^{{A}_{i}} = ( M , Δ t , add ( {A}_{i + 1} ) , {Sign}_{{P}_{0}} ( M ‖ Δ t ‖ ( {A}_{i + 1} ) ) )$$
to the collaborative user Aᵢ, wherein add(Aᵢ₊₁) represents a target address of a transaction to be executed by the collaborative user Aᵢ;
(2) after receiving the transaction credential
$${V}_{{P}_{0}} = ( {Num}_{{d}_{0}}^{{P}_{0}} , {Sign}_{{P}_{0}} ( {Num}_{{d}_{0}}^{{P}_{0}} ) )$$
sent by the requesting user P₀, verifying, by the collaborative user A₁, authenticity of the transaction credential:
1) if
$$Ver ( {Num}_{{d}_{0}}^{{P}_{0}} ) = 1 ,$$
verifying the signature information
$${Sign}_{{P}_{0}} ( {Num}_{{d}_{0}}^{{P}_{0}} ) ;$$
and
if
$$Ver ( {Sign}_{{P}_{0}} ( {Num}_{{d}_{0}}^{{P}_{0}} ) ) = {Sign}_{{P}_{0}} ( {Num}_{{d}_{0}}^{{P}_{0}} ) ,$$
indicating that an identity of and the transaction number transmitted by the requesting user P₀ are both true, broadcasting no information; or if
$$Ver ( {Sign}_{{P}_{0}} ( {Num}_{{d}_{0}}^{{P}_{0}} ) ) \neq {Sign}_{{P}_{0}} ( {Num}_{{d}_{0}}^{{P}_{0}} ) ,$$
indicating that an identity of the requesting user P₀ is forged, broadcasting information message_{A}_{₁}(¬P₀); or
2) if
$$Ver ( {Num}_{{d}_{0}}^{{P}_{0}} ) = 0 ,$$
indicating that the transaction number transmitted by the requesting user P₀ is not true or valid, broadcasting, by the collaborative user A₁, information
$${message}_{{A}_{1}} ( {}_{}^{¬} {Num}_{{d}_{0}}^{{P}_{0}} )$$
without verifying the signature information
$${Sign}_{{P}_{0}} ( {Num}_{{d}_{0}}^{{P}_{0}} ) ;$$
and
immediately terminating, by the remaining collaborative users who receive the broadcast information message_{A}_{₁}(¬P₀) or
$${message}_{{A}_{1}} ( {}_{}^{¬} {Num}_{{d}_{0}}^{{P}_{0}} ) ,$$
a collaboration task related to the requesting user;
(3) after receiving the collaboration task
$${w}_{{P}_{0}}^{{A}_{i}} = ( M , Δ t , add ( {A}_{i + 1} ) , {Sign}_{{P}_{0}} ( M ‖ Δ t ‖ add ( {A}_{i + 1} ) ) )$$
sent by the requesting user P₀, checking, by the collaborative user Aᵢ, whether the information message_{A}_{₁}(¬P₀) or
$${message}_{{A}_{1}} ( {}_{}^{¬} {Num}_{{d}_{0}}^{{P}_{0}} )$$
exists; and if the information exists, terminating the collaboration task; or if the information does not exist, verifying correctness of the signature information Sign_{P}_{₀}(M∥Δt∥add(Aᵢ₊₁)) of the requesting user P₀ in the collaboration task
$${w}_{{P}_{0}}^{{A}_{i}} :$$
1) if Ver_{P}_{₀}(Sign_{P}_{₀}(M∥Δt∥add(Aᵢ₊₁)))=Sign_{P}_{₀}(M∥Δt∥add(Aᵢ₊₁)), indicating that an identity of the requesting user passes the verification, executing, by the collaborative user Aᵢ, a transaction dᵢ(Aᵢ [symbol] Aᵢ₊₁) based on content in the collaboration task
$${w}_{{P}_{0}}^{{A}_{i}} ;$$
and after executing the transaction dᵢ(Aᵢ [symbol] Aᵢ₊₁), sending a collaboration credential
$${V}_{{A}_{i}} = ( {Num}_{{d}_{i}}^{{A}_{i}} , {Sign}_{{A}_{i}} ( {Num}_{{d}_{i}}^{{A}_{i}} ) )$$
to the requesting user P₀ to obtain remuneration for executing the anonymous transaction; or
2) if Ver_{P}_{₀}(Sign_{P}_{₀}(M∥Δt∥add(Aᵢ₊₁)))≠Sign_{P}_{₀}(M∥Δt∥add(Aᵢ₊₁)), indicating that an identity of the requesting user P₀ is forged, refusing, by the collaborative user Aᵢ, to execute the collaboration task, and broadcasting information message_{A}_{ᵢ}(¬P₀); wherein
execution of an actual transaction D(P₀→S) of the requesting user is completed only after all collaborative users Aᵢ in the anonymous set execute the transaction dᵢ, that is, ∀Aᵢ∈Set, Aᵢ has executed dᵢ(Aᵢ [symbol] Aᵢ₊₁)⇔D(P₀→S) is completed;
(4) after receiving the collaboration credential
$${V}_{{A}_{i}} = ( {Num}_{{d}_{i}}^{{A}_{i}} , {Sign}_{{A}_{i}} ( {Num}_{{d}_{i}}^{{A}_{i}} ) )$$
sent by the collaborative user Aᵢ, verifying, by the requesting user P₀, the collaboration credential:
1) if
$$Ver ( {Num}_{{d}_{i}}^{{A}_{i}} ) = 1 ,$$
verifying the signature information
$${Ver}_{{A}_{i}} ( {Sign}_{{A}_{i}} ( {Num}_{{d}_{i}}^{{A}_{i}} ) ) ;$$
and
if
$${Ver}_{{A}_{i}} ( {Sign}_{{A}_{i}} ( {Num}_{{d}_{i}}^{{A}_{i}} ) ) = {Sign}_{{A}_{i}} ( {Num}_{{d}_{i}}^{{A}_{i}} ) ,$$
indicating that a transaction number transmitted by the collaborative user Aᵢ is true and valid and an identity of the collaborative user passes the verification, executing, by the requesting user, a remuneration transaction
$${f}_{i} = ( {P}_{0} {\to }^{{O}_{Ai}} {A}_{i} ) ,$$
and sending a payment credential
$${\tilde{V}}_{{P}_{0}}^{{A}_{i}} = ( {Num}_{{f}_{i}}^{{P}_{0}} , {Sign}_{{P}_{0}} ( {Num}_{{f}_{i}}^{{P}_{0}} ) )$$
to the collaborative user Aᵢ; or
if
$${Ver}_{{A}_{i}} ( {Sign}_{{A}_{i}} ( {Num}_{{d}_{i}}^{{A}_{i}} ) ) \neq {Sign}_{{A}_{i}} ( {Num}_{{d}_{i}}^{{A}_{i}} ) ,$$
indicating that an identity of the collaborative user Aᵢ is forged, broadcasting information message_{P}_{₀}(¬Aᵢ); or
2) if
$$Ver ( {Num}_{{d}_{i}}^{{A}_{i}} ) = 0 ,$$
indicating that a transaction number transmitted by the collaborative user Aᵢ is not true or valid, broadcasting, by the requesting user P₀, information
$${message}_{{A}_{1}} ( {}_{}^{¬} {Num}_{{d}_{i}}^{{P}_{0}} )$$
without verifying the signature information
$${Sign}_{{A}_{i}} ( {Num}_{{d}_{i}}^{{A}_{i}} ) ;$$
and
if the anonymous transaction is successfully completed but the collaborative user Aᵢ does not finish executing the transaction within a time period Δt specified by the requesting user, broadcasting information message_{P}_{₀}(¬Δt_{A}_{ᵢ}); if a collaborative user in the anonymous set does not execute the transaction, indicating that the execution of the actual transaction D(P₀→S) of the requesting user is not completed, that is, ∃Aᵢ∈Set, Aᵢ was not executed dᵢ(Aᵢ [symbol] Aᵢ₊₁)⇔D(P₀→S) is not completed, broadcasting, by the requesting user, a collaborative user who fails verification or even does not send a collaboration credential; and
(5) after receiving the payment credential
$${\tilde{V}}_{{P}_{0}}^{{A}_{i}} = ( {Num}_{{f}_{i}}^{{P}_{0}} , {Sign}_{{P}_{0}} ( {Num}_{{f}_{i}}^{{P}_{0}} ) )$$
sent by the requesting user P₀, responding, by the collaborative user Aᵢ, based on whether the corresponding remuneration is received: if the collaborative user Aᵢ does not receive anonymous transaction remuneration O_{A}_{ᵢ} paid by the requesting user, broadcasting information
$${message}_{{A}_{i}} ( {}_{}^{¬} {Num}_{{f}_{i}}^{{P}_{0}} ) ,$$
and ending an anonymous transaction process.

6. The method for protecting location privacy in mobile payment according to claim 3, wherein the reputation update phase in step 3 comprises:
storing information message(·) through a blockchain, jointly verifying, by all nodes in the blockchain, the information by using a consensus characteristic of blockchain nodes, and storing message(·) that passes the verification as reputation evaluation evidence in a block; wherein
a set of the bad user behavior defined in the anonymous set generation phase and the transaction execution phase is Act={message(¬Δt), message(¬mes), message(¬P), message(¬X), message(¬Num)}, wherein message(¬Δt) indicates that the collaborative user does not finish executing the transaction within the specified time period; message(¬mes) indicates that the user maliciously broadcasts information; message¬(P) indicates that an identity of the user fails verification; message(¬X) indicates that a comprehensive reputation value of the user fails verification; message(¬Num) indicates that a transaction number transmitted by the requesting user or the collaborative user is not true or valid, that is, the requesting user does not transfer anonymous transaction funds, the collaborative user does not execute the anonymous transaction, or the requesting user does not pay remuneration to the collaborative user;
an incentive factor p and a penalty factor are set to be constant, and α_{P}^{t} increases by 1 when a user as a collaborative user honestly participates in an anonymous transaction, but a cumulative quantity of times of β_{P}^{t} is determined based on impact of bad behavior of the user on the anonymous transaction; message(¬Δt) has minimum impact because the collaborative user honestly executes the anonymous transaction but does not finish executing the anonymous transaction within a time period given by the requesting user, and is regarded as one time of bad behavior; message(¬mes) indicates that the user maliciously slanders another user and is regarded as two times of bad behavior; the bad behavior message(¬P) or message(¬X) has relatively small impact because the bad behavior occurs before the anonymous set is generated, the requesting user has not paid an anonymous transaction amount, and the collaborative user has not executed the anonymous transaction, and is regarded as two times of bad behavior; and the bad behavior message(¬Num) occurs in a process of executing the anonymous transaction, and is regarded as three times of bad behavior; and
an instantaneous reputation value X_{P}_{₀}(t) of the requesting user, an instantaneous reputation value X_{P}_{ⱼ}(t) of a network user, and an instantaneous reputation value X_{A}_{ᵢ}(t) of the collaborative user are respectively calculated through a formula
$${χ}_{{P}_{0}} ( t ) = max ( 0 , {χ}_{{P}_{0}} ( t - 1 ) - n * \frac{{β}_{{P}_{0}}^{t}}{{α}_{{P}_{0}}^{t} + {β}_{{P}_{0}}^{t}} )$$
for calculating the instantaneous reputation value of the requesting user, a formula
$${χ}_{{P}_{j}} ( t ) = max ( 0 , {χ}_{{P}_{j}} ( t - 1 ) - n * \frac{{β}_{{P}_{j}}^{t}}{{α}_{{P}_{j}}^{t} + {β}_{{P}_{j}}^{t}} )$$
for calculating the instantaneous reputation value of the network user, and a formula
$${χ}_{{A}_{i}} ( t ) = \{ \begin{matrix}min ( 1 , {χ}_{{A}_{i}} ( t - 1 ) + p * \frac{{α}_{{A}_{i}}^{t}}{{α}_{{A}_{i}}^{t} + {β}_{{A}_{i}}^{t}} ) \\ max ( 0 , {χ}_{{A}_{i}} ( t - 1 ) - n * \frac{{β}_{{A}_{i}}^{t}}{{α}_{{A}_{i}}^{t} + {β}_{{A}_{i}}^{t}} )\end{matrix}$$
for calculating the instantaneous reputation value of the collaborative user in the reputation evaluation model, and uploaded to the blockchain to update the reputation values of the users.

7. A system for protecting location privacy in mobile payment, using the method for protecting location privacy in mobile payment according to claim 1, and comprising:
an anonymous set generation module, configured to describe a mutual relationship between users from a perspective of a supply-demand relationship, and generate an anonymous set for a requesting user through a double auction mechanism;
a transaction execution module, configured to execute an anonymous transaction based on an anonymous transaction model; and
a reputation update module, configured to update reputations of the users based on a reputation evaluation scheme and bad user behavior defined in an anonymous set generation phase and a transaction execution phase.

8. A computer device, comprising a memory and a processor, wherein the memory stores a computer program, and the computer program, when executed by the processor, enables the processor to perform steps of the method for protecting location privacy in mobile payment according to claim 1.

9. A computer-readable storage medium, storing a computer program, wherein the computer program, when executed by a processor, enables the processor to perform steps of the method for protecting location privacy in mobile payment according to claim 1.

10. An information data processing terminal, wherein the information data processing terminal is configured to implement the system for protecting location privacy in mobile payment according to claim 7.

11. The system for protecting location privacy in mobile payment according to claim 7, wherein in the method for protecting location privacy in mobile payment, the anonymous transaction model in the mobile payment environment constructed based on the decentralized coin mixing idea comprises the requesting user, the collaborative users and the merchant, and a secure communication link exists between the requesting user and the collaborative user;
a set of all users in a network is U={P₀, P₁, P₂, . . . , Pₙ, . . . , Pₘ}, the requesting user P₀ is an initiator of an anonymous transaction, sends an anonymous transaction collaboration request Q_{P}_{₀} to the other users U′={₁, P₂, . . . , Pₙ, . . . , Pₘ} in the network, and selects k users from n candidate collaborative users who accept the collaboration request, to construct the anonymous set Set={A₁ . . . , Aᵢ, . . . , Aₖ}, and k is the privacy requirement of the requesting user P₀; the anonymous set Set is introduced to transform an actual transaction D(P₀→S) into D(P₀→S)⇒D₀(P₀→A_{Set})·D₁(A_{Set}→S), wherein D₀(P₀→A_{Set}) is used to cut off the direct transaction association between the requesting user P₀ and the merchant S, and D₁(A_{Set}→S) is used to ensure that funds are transferred to a correct merchant account; after the anonymous set is successfully constructed, the requesting user P₀ divides the original transaction as follows: D(P₀→S)⇒d₀(P₀→A₁)·d₁(A₁→A₂)· . . . ·dₖ₋₁(Aₖ₋₁→Aₖ)·dₖ(Aₖ→S), and each transaction dᵢ(Aᵢ→Aᵢ₊₁) obtained after the division is executed by a collaborative user Aᵢ to implement a flow of the funds of the requesting user; the collaborative user Aᵢ is a participant in the anonymous transaction and obtains remuneration by providing a collaboration service to the requesting user; after receiving a collaboration task dᵢ(Aᵢ→Aᵢ₊₁) sent by the requesting user P₀, the collaborative user Aᵢ transfers a fixed amount of funds to an account of Aᵢ₊₁ based on collaboration content, and the collaborative user of the current transaction is a requesting user of a next transaction; and the merchant S is an actual recipient of the anonymous transaction, does not participate in a specific execution process of the anonymous transaction, and serves only as a final recipient of the funds;
impact of the historical behavior of the user in an anonymous transaction process on the reputation value of the user is analyzed through the reputation evaluation model; within a discrete time period T={1, 2, . . . , t, . . . }, the requesting user P₀ broadcasts the collaboration request Q_{P}_{₀} in expectation of a response from the network user Pⱼ, to generate the anonymous set Set; if the requesting user has malicious behavior of falsifying information, deceiving the collaborative user into executing a false anonymous transaction, or not paying remuneration to the collaborative user who executes a transaction in the anonymous transaction process, a reputation value of the requesting user is reduced as a penalty; and a formula for measuring an instantaneous reputation value X_{P}_{₀}(t) of the requesting user P₀ at a moment t is as follows:
$${χ}_{{P}_{0}} ( t ) = max ( 0 , {χ}_{{P}_{0}} ( t - 1 ) - n * \frac{{β}_{{P}_{0}}^{t}}{{α}_{{P}_{0}}^{t} + {β}_{{P}_{0}}^{t}} ) ,$$
if the network user Pⱼ has behavior of falsifying information during response to the requesting user P₀, a reputation value of the network user is reduced as a penalty; and a formula for measuring an instantaneous reputation value X_{P}_{ⱼ}(t) of the network user Pⱼ at the moment t is as follows:
$${χ}_{{P}_{j}} ( t ) = max ( 0 , {χ}_{{P}_{j}} ( t - 1 ) - n * \frac{{β}_{{P}_{j}}^{t}}{{α}_{{P}_{j}}^{t} + {β}_{{P}_{j}}^{t}} ) ,$$
if the collaborative user Aᵢ leaks the specific collaboration task dᵢ(Aᵢ→Aᵢ₊₁) issued by the requesting user P₀, or delays or interrupts execution of the collaboration task, a reputation value of the collaborative user is reduced as a penalty; if the collaborative user honestly executes the collaboration task, the reputation value of the collaborative user is increased as a reward; and a formula for measuring an instantaneous reputation value X_{A}_{ᵢ}(t) of the collaborative user Aᵢ at the moment t is as follows:
$${χ}_{{A}_{i}} ( t ) = \{ \begin{matrix}min ( 1 , {χ}_{{A}_{i}} ( t - 1 ) + p * \frac{{α}_{{A}_{i}}^{t}}{{α}_{{A}_{i}}^{t} + {β}_{{A}_{i}}^{t}} ) \\ max ( 0 , {χ}_{{A}_{i}} ( t - 1 ) - n * \frac{{β}_{{A}_{i}}^{t}}{{α}_{{A}_{i}}^{t} + {β}_{{A}_{i}}^{t}} )\end{matrix} ,$$
wherein P is an incentive factor, n is a penalty factor, α_{P}^{t} is a cumulative quantity of times the user honestly participates in anonymous transactions by t, and β_{P}^{t} is a cumulative quantity of times the user has bad behavior by t; 0<p«n<1, and a self-interested user is prompted to adhere to rational consensus by increasing a penalty; and the instantaneous reputation value of the user meets a condition 0≤X_{P}(t)≤1, and an initial reputation value X_{P}(0) of the user is 0.5;
each instantaneous reputation value X_{P}(t) of the user in the anonymous transaction process is fused to calculate a comprehensive reputation value of the user; and a quadratic decreasing function is used to define a weight of each instantaneous reputation value X_{P}(t) of the user in the comprehensive reputation value as follows:
$$ω ( {χ}_{P} ( t ) ) = \{ \begin{matrix}{( 1 - \frac{T - t}{Γ} )}^{2} & , T - Γ < t \leq T \\ 0 & , 0 \leq t \leq T - Γ\end{matrix} ,$$
wherein T is a current moment, and Γ is a validity period of the reputation value; when t=T, ω(X_{P}(t))=1, that is, when X_{P}(t) is a reputation value at the current moment, a weight of the reputation value in the comprehensive reputation value is 1; when 0≤t≤T−Γ, ω(X_{P}(t))=0, indicating that a reputation value at a moment with an interval to the current moment T exceeding the validity period Γ is not used for evaluation; and the comprehensive reputation value of the user is finally obtained through a weighted average sum method as follows:
$${χ}_{P} = {\sum }_{T - Γ < t \leq T} ( {χ}_{P} ( t ) * \frac{ω ( {χ}_{P} ( t ) )}{{\sum }_{T - Γ < t \leq T} ω ( {χ}_{P} ( t ) )} ) ,$$
a double auction mechanism comprises: in the network, n requesting users U={P₀, P₁, P₂, . . . , Pₙ} are waiting for anonymous services and m network users U′={Pₙ₊₁, Pₙ₊₂, . . . , Pₙ₊ₘ} are waiting to receive collaboration tasks; and each requesting user Pᵢ∈U broadcasts a collaboration request Q_{P}_{ᵢ}=(X_{P}_{ᵢ}, M, Δt, O_{P}_{ᵢ}) to the other user Pⱼ∈U′ in the network, wherein X_{P}_{ᵢ} is a comprehensive reputation value of the requesting user, M is an actual transaction amount of the requesting user, Δt is an acceptable anonymous transaction execution delay of the requesting user, and O_{P}_{ᵢ} is a bid base of the auction; and
the bid base of the requesting user is
$${O}_{{P}_{i}} = \frac{M * φ ( Δ t )}{{χ}_{{P}_{i}}} ,$$
wherein φ(Δt) is a decreasing function; a bid O_{P}_{ⱼ} of the network user Pⱼ needs to have a positive correlation with the bid base of the requesting user, and the bid of the network user is O_{P}_{ⱼ}=O_{P}_{ᵢ}*X_{P}_{ⱼ}*ρ, wherein ρ is a control coefficient used to limit overbidding; after receiving the collaboration request Q_{P}_{ᵢ}, the network user Pⱼ∈U′ ranks the requesting user in ascending order of the bid base O_{P}_{ᵢ} and the comprehensive reputation value X_{P}_{ᵢ}, and determines, based on a comprehensive ranking of the bid base and the comprehensive reputation value of the requesting user Pᵢ, whether to accept the request; if the network user accepts the request, the network user sends a reply R_{P}_{ⱼ}=(X_{P}_{ⱼ}, O_{P}_{ᵢ}) to the requesting user; or if the network user rejects the request, the network user does not respond; the network user selectively accepts collaboration requests of a plurality of requesting users based on a capability of the network user, and establishes a to-be-executed task set W_{P}_{ⱼ}={w₁, w₂, . . . , wₙ}; and the requesting user Pᵢ arranges the candidate collaborative users in ascending order of comprehensive reputation value and in descending order of bid, and determines that k users whose comprehensive ranking is the highest constitute the anonymous set Set={A₁ . . . , Aᵢ, . . . , Aₖ}.

12. The system for protecting location privacy in mobile payment according to claim 7, wherein the method for protecting location privacy in mobile payment comprises the following steps:
step 1: in an anonymous set generation phase, describing a mutual relationship between users from a perspective of a supply-demand relationship, and generating the anonymous set for the requesting user through a double auction mechanism;
step 2: in a transaction execution phase, executing an anonymous transaction based on the anonymous transaction model; and
step 3: in a reputation update phase, updating reputations of the users based on the reputation evaluation scheme and bad user behavior defined in the anonymous set generation phase and the transaction execution phase.

13. The system for protecting location privacy in mobile payment according to claim 12, wherein the anonymous set generation phase in step 1 comprises:
(1) before executing a mobile payment transaction, broadcasting, by the requesting user P₀, a collaboration request Q_{P}_{₀}=(X_{P}_{₀}, M, Δt, O_{P}_{₀}, Sign_{P}_{₀}(X_{P}_{₀}∥M∥Δt∥O_{P}_{₀})) to the other users in a network, wherein Sign(·) is a secure signature function, and Sign_{P}_{₀}(X_{P}_{₀}∥M∥Δt∥O_{P}_{₀}) indicates that the requesting user P₀ signs a comprehensive reputation value, a transaction amount, and an acceptable task execution delay by using a private key;
(2) after receiving the collaboration request Q_{P}_{₀}=(X_{P}_{₀}, M, Δt, O_{P}_{₀}, Sign_{P}_{₀}(X_{P}_{₀}∥M∥Δt∥O_{P}_{₀})) sent by the requesting user P₀, verifying, by the network user Pⱼ, correctness of the signature information Sign_{P}_{₀}(X_{P}_{₀}∥M∥Δt∥O_{P}_{₀}) and the comprehensive reputation value X_{P}_{₀} of the requesting user P₀ in the collaboration request Q_{P}_{₀}:
1) if Ver_{P}_{₀}(Sign_{P}_{₀}(X_{P}_{₀}∥M∥Δt∥O_{P}_{₀}))=Sign_{P}_{₀}(X_{P}_{₀}∥M∥Δt∥O_{P}_{₀}), indicating that an identity of the requesting user passes the verification, verifying the comprehensive reputation value X_{P}_{₀} of the requesting user; and
if
$$Ver ( {χ}_{{P}_{0}} ) = {\sum }_{T - Γ < t \leq T} ( {χ}_{{P}_{0}} ( t ) * \frac{ω ( {χ}_{{P}_{0}} ( t ) )}{{\sum }_{T - Γ < t \leq T} ω ( {χ}_{{P}_{0}} ( t ) )} ) ,$$
indicating that the identity and the comprehensive reputation value of the requesting user both pass the verification, determining, by the network user based on a bid base O_{P}_{₀} given by and the comprehensive reputation value X_{P}_{₀} of the requesting user, whether to accept the collaboration request; if the network user Pⱼ accepts the collaboration request of the requesting user P₀, sending a reply R_{P}_{ⱼ}=(X_{P}_{ⱼ}, O_{P}_{ⱼ}, add(Pⱼ), Sign_{P}_{ⱼ}(X_{P}_{ⱼ}∥O_{P}_{ⱼ}∥add(Pⱼ))) to the requesting user P₀, wherein add(Pⱼ) is an account address of the network user Pⱼ; otherwise, not responding; and accepting, by the network user, collaboration requests of a plurality of requesting users based on a capability of the network user, to form a to-be-executed task set W_{P}_{ⱼ}={w₁, w₂, . . . , wₙ}; or
if
$$Ver ( {χ}_{{P}_{0}} ) \neq {\sum }_{T - Γ < t \leq T} ( {χ}_{{P}_{0}} ( t ) * \frac{ω ( {χ}_{{P}_{0}} ( t ) )}{{\sum }_{T - Γ < t \leq T} ω ( {χ}_{{P}_{0}} ( t ) )} ) ,$$
indicating that the comprehensive reputation value of the requesting user fails the verification, broadcasting, by the network user Pⱼ, information message_{P}_{ⱼ}(¬X_{P}_{₀}); or
2) if Ver_{P}_{₀}(Sign_{P}_{₀}(X_{P}_{₀}∥M∥Δt∥O_{P}_{₀})≠Sign_{P}_{₀}(X_{P}_{₀}∥M∥Δt∥O_{P}_{₀}), indicating that an identity of the requesting user fails the verification, broadcasting, by the network user Pⱼ, information message_{P}_{ⱼ}(¬P₀) without verifying the comprehensive reputation value X_{P}_{₀} of the requesting user, wherein Ver(·) is a verification function, Ver_{P}_{₀}(Sign_{P}_{₀}(X_{P}_{₀}∥M∥Δt∥O_{P}_{₀}) indicates verification of correctness of the signature information Sign_{P}_{₀}(X_{P}_{₀}∥M∥Δt∥O_{P}_{₀}) by using a public key of the requesting user P₀), and if the verification fails, Sign_{P}_{₀}(X_{P}_{₀}∥M∥Δt∥O_{P}_{₀}) is not a signature generated through encryption performed by using the private key of P₀, and the identity of the requesting user is likely to be forged;
(3) verifying, by the requesting user P₀, correctness of the reply R_{P}_{ⱼ}=(X_{P}_{ⱼ}, O_{P}_{ⱼ}, add(Pⱼ), Sign_{P}_{ⱼ}(X_{P}_{ⱼ}∥O_{P}_{ⱼ}∥add(Pⱼ))) of the network user Pⱼ:
1) if Ver_{P}_{ⱼ}(Sign_{P}_{ⱼ}(X_{P}_{ⱼ}∥O_{P}_{ⱼ}∥add(Pⱼ)))=Sign_{P}_{ⱼ}(X_{P}_{ⱼ}∥O_{P}_{ⱼ}∥add(Pⱼ)), indicating that an identity of the network user passes the verification, verifying a comprehensive reputation value of the network user; and
if
$$Ver ( {χ}_{{P}_{j}} ) = {\sum }_{T - Γ < t \leq T} ( {χ}_{{P}_{j}} ( t ) * \frac{ω ( {χ}_{{P}_{j}} ( t ) )}{{\sum }_{T - Γ < t \leq T} ω ( {χ}_{{P}_{j}} ( t ) )} ) ,$$
indicating that the comprehensive reputation value of the network user passes the verification, taking the network user Pⱼ as a candidate collaborative user; or
if
$$Ve r ( {χ}_{{P}_{j}} ) \neq {\sum }_{T - Γ < t \leq T} ( {χ}_{{P}_{j}} ( t ) * \frac{ω ( {χ}_{{P}_{j}} ( t ) )}{{\sum }_{T - Γ < t \leq T} ω ( {χ}_{{P}_{j}} ( t ) )} ) ,$$
indicating that the comprehensive reputation value of the network user fails the verification, broadcasting, by the requesting user P₀, information message_{P}_{₀}(¬X_{P}_{ⱼ}); or
2) if Ver_{P}_{ⱼ}(Sign_{P}_{ⱼ}(X_{P}_{ⱼ}∥O_{P}_{ⱼ}∥add(Pⱼ)))≠Sign_{P}_{ⱼ}(X_{P}_{ⱼ}∥O_{P}_{ⱼ}∥add(Pⱼ)), indicating that an identity of the network user fails the verification, broadcasting, by the requesting user P₀, information message_{P}_{₀}(¬Pⱼ) without verifying the comprehensive reputation value X_{P}_{ⱼ} of the network user; and
(4) ranking, by the requesting user P₀, the candidate collaborative user in ascending order of the comprehensive reputation value X_{P}_{ⱼ} and in descending order of a bid O_{P}_{ⱼ} to obtain a comprehensive reputation value ranking N_{X}(Pⱼ) and a bid ranking N_{O}(Pⱼ) of the candidate collaborative user Pⱼ, wherein a comprehensive ranking of the candidate collaborative user is N(Pⱼ)=N_{X}(Pⱼ)+N_{O}(Pⱼ); selecting k users whose comprehensive ranking N(Pⱼ) is the highest from all candidate collaborative users to form the anonymous set Set={A₁ . . . , Aᵢ, . . . , Aₖ}; and if a current size k of the anonymous set does not meet a privacy protection requirement of the requesting user, continuing to wait for the other network users to reply;
wherein in the anonymous set generation phase, after the network user Pⱼ receives the collaboration request Q_{P}_{₀} sent by the requesting user P₀ or after the requesting user P₀ receives the reply R_{P}_{ⱼ} sent by the network user, the correctness of the signature information and the comprehensive reputation value is verified to confirm authenticity of the identity and the comprehensive reputation value of the user.

14. The system for protecting location privacy in mobile payment according to claim 12, wherein the transaction execution phase in step 2 comprises:
(1) executing, by the requesting user P₀, a fund transfer transaction d₀(P₀ [symbol] A₁), and sending a transaction credential
$${V}_{{P}_{0}} = ( {Num}_{{d}_{0}}^{{P}_{0}} , {Sign}_{{P}_{0}} ( {Num}_{{d}_{0}}^{{P}_{0}} ) )$$
to the collaborative user A₁, wherein
$${Num}_{{d}_{0}}^{{P}_{0}}$$
represents a transaction number obtained after the requesting user P₀ executes d₀(P₀ [symbol] A₁); and sending a collaboration task
$${w}_{{P}_{0}}^{{A}_{i}} = ( M , Δ t , add ( {A}_{i + 1} ) , {Sign}_{{P}_{0}} ( M ‖ Δ t ‖ add ( {A}_{i + 1} ) ) )$$
to the collaborative user Aᵢ, wherein add(Aᵢ₊₁) represents a target address of a transaction to be executed by the collaborative user Aᵢ;
(2) after receiving the transaction credential
$${V}_{{P}_{0}} = ( {Num}_{{d}_{0}}^{{P}_{0}} , {Sign}_{{P}_{0}} ( {Num}_{{d}_{0}}^{{P}_{0}} ) )$$
sent by the requesting user P₀, verifying, by the collaborative user A₁, authenticity of the transaction credential:
1) if
$$Ver ( {Num}_{{d}_{0}}^{{P}_{0}} ) ) = 1 ,$$
verifying the signature information
$${Sign}_{{P}_{0}} ( {Num}_{{d}_{0}}^{{P}_{0}} ) ;$$
and
if
$$Ver ( {Sign}_{{P}_{0}} ( {Num}_{{d}_{0}}^{{P}_{0}} ) ) = {Sign}_{{P}_{0}} ( {Num}_{{d}_{0}}^{{P}_{0}} ) ,$$
indicating that an identity of and the transaction number transmitted by the requesting user P₀ are both true, broadcasting no information; or if
$$Ver ( {Sign}_{{P}_{0}} ( {Num}_{{d}_{0}}^{{P}_{0}} ) ) \neq {Sign}_{{P}_{0}} ( {Num}_{{d}_{0}}^{{P}_{0}} ) ,$$
indicating that an identity of the requesting user P₀ is forged, broadcasting information message_{A}_{₁}(¬P₀); or
2) if
$$Ver ( {Num}_{{d}_{0}}^{{P}_{0}} ) ) = 0 ,$$
indicating that the transaction number transmitted by the requesting user P₀ is not true or valid, broadcasting, by the collaborative user A₁, information
$${message}_{{A}_{1}} ( {}_{}^{¬} {Num}_{{d}_{0}}^{{P}_{0}} )$$
without verifying the signature information
$${Sign}_{{P}_{0}} ( {Num}_{{d}_{0}}^{{P}_{0}} ) ;$$
and
immediately terminating, by the remaining collaborative users who receive the broadcast information message_{A}_{₁}(¬P₀) or
$${message}_{{A}_{1}} ( {}_{}^{¬} {Num}_{{d}_{0}}^{{P}_{0}} ) ,$$
a collaboration task related to the requesting user;
(3) after receiving the collaboration task
$${w}_{{P}_{0}}^{{A}_{i}} = ( M , Δ t , add ( {A}_{i + 1} ) , {Sign}_{{P}_{0}} ( M ‖ Δ t ‖ add ( {A}_{i + 1} ) ) )$$
sent by the requesting user P₀, checking, by the collaborative user Aᵢ, whether the information message_{A}_{₁}(¬P₀) or
$${message}_{{A}_{1}} ( {}_{}^{¬} {Num}_{{d}_{0}}^{{P}_{0}} )$$
exists; and if the information exists, terminating the collaboration task; or if the information does not exist, verifying correctness of the signature information Sign_{P}_{₀}(M∥Δt∥add(Aᵢ₊₁)) of the requesting user P₀ in the collaboration task
$${w}_{{P}_{0}}^{{A}_{i}} :$$
1) if Ver_{P}_{₀}(Sign_{P}_{₀}(M∥Δt∥add(Aᵢ₊₁)))=Sign_{P}_{₀}(M∥Δt∥add(Aᵢ₊₁)), indicating that an identity of the requesting user passes the verification, executing, by the collaborative user Aᵢ, a transaction dᵢ(Aᵢ [symbol] Aᵢ₊₁) based on content in the collaboration task
$${w}_{{P}_{0}}^{{A}_{i}} ;$$
and after executing the transaction dᵢ(Aᵢ [symbol] Aᵢ₊₁), sending a collaboration credential
$${V}_{{A}_{i}} = ( {Num}_{{d}_{i}}^{{A}_{i}} , {Sign}_{{A}_{i}} ( {Num}_{{d}_{i}}^{{A}_{i}} ) )$$
to the requesting user P₀ to obtain remuneration for executing the anonymous transaction; or
2) if Ver_{P}_{₀}(Sign_{P}_{₀}(M∥Δt∥add(Aᵢ₊₁)))≠Sign_{P}_{₀}(M∥Δt∥add(Aᵢ₊₁)), indicating that an identity of the requesting user P₀ is forged, refusing, by the collaborative user Aᵢ, to execute the collaboration task, and broadcasting information message_{A}_{ᵢ}(¬P₀); wherein
execution of an actual transaction D(P₀→S) of the requesting user is completed only after all collaborative users Aᵢ in the anonymous set execute the transaction dᵢ, that is, ∀Aᵢ∈Set, Aᵢ has executed dᵢ(Aᵢ [symbol] Aᵢ₊₁)⇔D(P₀→S) is completed;
(4) after receiving the collaboration credential
$${V}_{{A}_{i}} = ( {Num}_{{d}_{i}}^{{A}_{i}} , {Sign}_{{A}_{i}} ( {Num}_{{d}_{i}}^{{A}_{i}} ) )$$
sent by the collaborative user Aᵢ, verifying, by the requesting user P₀, the collaboration credential:
1) if
$$Ver ( {Num}_{{d}_{i}}^{{A}_{i}} ) = 1 ,$$
verifying the signature information
$${Ver}_{{A}_{i}} = ( {Sign}_{{A}_{i}} ( {Num}_{{d}_{i}}^{{A}_{i}} ) ) ;$$
and
if
$${Ver}_{{A}_{i}} = ( {Sign}_{{A}_{i}} ( {Num}_{{d}_{i}}^{{A}_{i}} ) ) = {Sign}_{{A}_{i}} ( {Num}_{{d}_{i}}^{{A}_{i}} ) ,$$
indicating that a transaction number transmitted by the collaborative user Aᵢ is true and valid and an identity of the collaborative user passes the verification, executing, by the requesting user, a remuneration transaction
$${f}_{i} = ( {P}_{0} {\to }^{{O}_{{A}_{i}}} {A}_{i} ) ,$$
and sending a payment credential
$${\tilde{V}}_{{P}_{0}}^{{A}_{i}} = ( {Num}_{{f}_{i}}^{{P}_{0}} , {Sign}_{{P}_{0}} ( {Num}_{{f}_{i}}^{{P}_{0}} ) )$$
to the collaborative user Aᵢ; or
if
$${Ver}_{{A}_{i}} = ( {Sign}_{{A}_{i}} ( {Num}_{{d}_{i}}^{{A}_{i}} ) ) \neq {Sign}_{{A}_{i}} ( {Num}_{{d}_{i}}^{{A}_{i}} ) ,$$
indicating that an identity of the collaborative user Aᵢ is forged, broadcasting information message_{P}_{₀}(¬Aᵢ); or
2) if
$$Ver ( {Num}_{{d}_{i}}^{{A}_{i}} ) = 0 ,$$
indicating that a transaction number transmitted by the collaborative user Aᵢ is not true or valid, broadcasting, by the requesting user P₀, information
$${message}_{{P}_{0}} ( {}^{¬} {Num}_{{d}_{i}}^{{A}_{i}} )$$
without verifying the signature information
$${Sign}_{{A}_{i}} ( {Num}_{{d}_{i}}^{{A}_{i}} ) ;$$
and
if the anonymous transaction is successfully completed but the collaborative user Aᵢ does not finish executing the transaction within a time period Δt specified by the requesting user, broadcasting information message_{P}_{₀}(¬Δt_{A}_{ᵢ}); if a collaborative user in the anonymous set does not execute the transaction, indicating that the execution of the actual transaction D(P₀→S) of the requesting user is not completed, that is, ∃Aᵢ∈Set, Aᵢ was not executed dᵢ(Aᵢ [symbol] Aᵢ₊₁)⇔D(P₀→S) is not completed, broadcasting, by the requesting user, a collaborative user who fails verification or even does not send a collaboration credential; and
(5) after receiving the payment credential
$${\tilde{V}}_{{P}_{0}}^{{A}_{i}} = ( {Num}_{{f}_{i}}^{{P}_{0}} , {Sign}_{{P}_{0}} ( {Num}_{{f}_{i}}^{{P}_{0}} ) )$$
sent by the requesting user P₀, responding, by the collaborative user Aᵢ, based on whether the corresponding remuneration is received: if the collaborative user Aᵢ does not receive anonymous transaction remuneration O_{A}_{ᵢ} paid by the requesting user, broadcasting information
$${message}_{{A}_{i}} ( {}^{¬} {Num}_{{f}_{i}}^{{P}_{0}} ) ,$$
and ending an anonymous transaction process.

15. The system for protecting location privacy in mobile payment according to claim 12, wherein the reputation update phase in step 3 comprises:
storing information message(·) through a blockchain, jointly verifying, by all nodes in the blockchain, the information by using a consensus characteristic of blockchain nodes, and storing message(·) that passes the verification as reputation evaluation evidence in a block; wherein
a set of the bad user behavior defined in the anonymous set generation phase and the transaction execution phase is Act={message(¬Δt), message(¬mes), message(¬P), message(¬X), message(¬Num)}, wherein message(¬Δt) indicates that the collaborative user does not finish executing the transaction within the specified time period; message(¬mes) indicates that the user maliciously broadcasts information; message(¬P) indicates that an identity of the user fails verification; message(¬X) indicates that a comprehensive reputation value of the user fails verification; message(¬Num) indicates that a transaction number transmitted by the requesting user or the collaborative user is not true or valid, that is, the requesting user does not transfer anonymous transaction funds, the collaborative user does not execute the anonymous transaction, or the requesting user does not pay remuneration to the collaborative user;
an incentive factor p and a penalty factor are set to be constant, and α_{P}^{t} increases by 1 when a user as a collaborative user honestly participates in an anonymous transaction, but a cumulative quantity of times of β_{P}^{t} is determined based on impact of bad behavior of the user on the anonymous transaction; message(¬Δt) has minimum impact because the collaborative user honestly executes the anonymous transaction but does not finish executing the anonymous transaction within a time period given by the requesting user, and is regarded as one time of bad behavior; message(¬mes) indicates that the user maliciously slanders another user and is regarded as two times of bad behavior; the bad behavior message(¬P) or message(¬X) has relatively small impact because the bad behavior occurs before the anonymous set is generated, the requesting user has not paid an anonymous transaction amount, and the collaborative user has not executed the anonymous transaction, and is regarded as two times of bad behavior; and the bad behavior message(¬Num) occurs in a process of executing the anonymous transaction, and is regarded as three times of bad behavior; and
an instantaneous reputation value X_{P}_{₀}(t) of the requesting user, an instantaneous reputation value X_{P}_{ⱼ}(t) of a network user, and an instantaneous reputation value X_{A}_{ᵢ}(t) of the collaborative user are respectively calculated through a formula
$${χ}_{{}_{{P}_{0}}} ( t ) = max ( 0 , {χ}_{{}_{{P}_{0}}} ( t - 1 ) - n * \frac{{β}_{{P}_{0}}^{t}}{{α}_{{P}_{0}}^{t} + {β}_{{P}_{0}}^{t}} )$$
for calculating the instantaneous reputation value of the requesting user, a formula
$${χ}_{{}_{{P}_{j}}} ( t ) = max ( 0 , {χ}_{{}_{{P}_{j}}} ( t - 1 ) - n * \frac{{β}_{{P}_{j}}^{t}}{{α}_{{P}_{j}}^{t} + {β}_{{P}_{j}}^{t}} )$$
for calculating the instantaneous reputation value of the network user, and a formula
$${χ}_{{}_{{A}_{i}}} ( t ) = \{ \begin{matrix}min ( 1 , {χ}_{{}_{{A}_{i}}} ( t - 1 ) + p * \frac{{α}_{{A}_{i}}^{t}}{{α}_{{A}_{i}}^{t} + {β}_{{A}_{i}}^{t}} ) \\ max ( 0 , {χ}_{{}_{{A}_{i}}} ( t - 1 ) - n * \frac{{β}_{{A}_{i}}^{t}}{{α}_{{A}_{i}}^{t} + {β}_{{A}_{i}}^{t}} )\end{matrix}$$
for calculating the instantaneous reputation value of the collaborative user in the reputation evaluation model, and uploaded to the blockchain to update the reputation values of the users.

16. The computer device according to claim 8, wherein in the method for protecting location privacy in mobile payment, the anonymous transaction model in the mobile payment environment constructed based on the decentralized coin mixing idea comprises the requesting user, the collaborative users and the merchant, and a secure communication link exists between the requesting user and the collaborative user;
a set of all users in a network is U={P₀, P₁, P₂, . . . , Pₙ, . . . , Pₘ}, the requesting user P₀ is an initiator of an anonymous transaction, sends an anonymous transaction collaboration request Q_{P}_{₀} to the other users U′={P₁, P₂, . . . , Pₙ, . . . , Pₘ} in the network, and selects k users from n candidate collaborative users who accept the collaboration request, to construct the anonymous set Set={A₁ . . . , Aᵢ, . . . , Aₖ}, and k is the privacy requirement of the requesting user P₀; the anonymous set Set is introduced to transform an actual transaction D(P₀→S) into D(P₀→S)⇔D₀(P₀→A_{Set})·D₁(A_{Set}→S), wherein D₀(P₀→A_{Set}) is used to cut off the direct transaction association between the requesting user P₀ and the merchant S, and D₁(A_{Set}→S) is used to ensure that funds are transferred to a correct merchant account; after the anonymous set is successfully constructed, the requesting user P₀ divides the original transaction as follows: D(P₀→)⇔d₀(P₀→A₁)·d₁(A₁→A₂)· . . . ·dₖ₋₁(Aₖ₋₁→Aₖ)·dₖ(Aₖ→S), and each transaction dᵢ(Aᵢ→Aᵢ₊₁) obtained after the division is executed by a collaborative user Aᵢ to implement a flow of the funds of the requesting user; the collaborative user Aᵢ is a participant in the anonymous transaction and obtains remuneration by providing a collaboration service to the requesting user; after receiving a collaboration task dᵢ(Aᵢ→Aᵢ₊₁) sent by the requesting user P₀, the collaborative user Aᵢ transfers a fixed amount of funds to an account of Aᵢ₊₁ based on collaboration content, and the collaborative user of the current transaction is a requesting user of a next transaction; and the merchant S is an actual recipient of the anonymous transaction, does not participate in a specific execution process of the anonymous transaction, and serves only as a final recipient of the funds;
impact of the historical behavior of the user in an anonymous transaction process on the reputation value of the user is analyzed through the reputation evaluation model; within a discrete time period T={1, 2, . . . , t, . . . }, the requesting user P₀ broadcasts the collaboration request Q_{P}_{₀} in expectation of a response from the network user Pⱼ, to generate the anonymous set Set; if the requesting user has malicious behavior of falsifying information, deceiving the collaborative user into executing a false anonymous transaction, or not paying remuneration to the collaborative user who executes a transaction in the anonymous transaction process, a reputation value of the requesting user is reduced as a penalty; and a formula for measuring an instantaneous reputation value X_{P}_{₀}(t) of the requesting user P₀ at a moment t is as follows:
$${χ}_{{}_{{P}_{0}}} ( t ) = max ( 0 , {χ}_{{}_{{P}_{0}}} ( t - 1 ) - n * \frac{{β}_{{P}_{0}}^{t}}{{α}_{{P}_{0}}^{t} + {β}_{{P}_{0}}^{t}} ) ,$$
if the network user Pⱼ has behavior of falsifying information during response to the requesting user P₀, a reputation value of the network user is reduced as a penalty; and a formula for measuring an instantaneous reputation value X_{P}_{ⱼ}(t) of the network user Pⱼ at the moment t is as follows:
$${χ}_{{}_{{P}_{j}}} ( t ) = max ( 0 , {χ}_{{}_{{P}_{j}}} ( t - 1 ) - n * \frac{{β}_{{P}_{j}}^{t}}{{α}_{{P}_{j}}^{t} + {β}_{{P}_{j}}^{t}} ) ,$$
if the collaborative user Aᵢ leaks the specific collaboration task dᵢ(Aᵢ→Aᵢ₊₁) issued by the requesting user P₀, or delays or interrupts execution of the collaboration task, a reputation value of the collaborative user is reduced as a penalty; if the collaborative user honestly executes the collaboration task, the reputation value of the collaborative user is increased as a reward; and a formula for measuring an instantaneous reputation value X_{A}_{ᵢ}(t) of the collaborative user Aᵢ at the moment t is as follows:
$${χ}_{{}_{{A}_{i}}} ( t ) = \{ \begin{matrix}min ( 1 , {χ}_{{}_{{A}_{i}}} ( t - 1 ) + p * \frac{{α}_{{A}_{i}}^{t}}{{α}_{{A}_{i}}^{t} + {β}_{{A}_{i}}^{t}} ) \\ max ( 0 , {χ}_{{}_{{A}_{i}}} ( t - 1 ) - n * \frac{{β}_{{A}_{i}}^{t}}{{α}_{{A}_{i}}^{t} + {β}_{{A}_{i}}^{t}} )\end{matrix} ,$$
wherein p is an incentive factor, n is a penalty factor, α_{P}^{t} is a cumulative quantity of times the user honestly participates in anonymous transactions by t, and β_{P}^{t} is a cumulative quantity of times the user has bad behavior by t; 0<p«n<1, and a self-interested user is prompted to adhere to rational consensus by increasing a penalty; and the instantaneous reputation value of the user meets a condition 0≤X_{P}(t)≤1, and an initial reputation value X_{P}(0) of the user is 0.5;
each instantaneous reputation value X_{P}(t) of the user in the anonymous transaction process is fused to calculate a comprehensive reputation value of the user; and a quadratic decreasing function is used to define a weight of each instantaneous reputation value X_{P}(t) of the user in the comprehensive reputation value as follows:
$$ω ( {χ}_{{}_{P}} ( t ) ) = \{ \begin{matrix}{( 1 - \frac{T - t}{Γ} )}^{2} , & T - Γ < t \leq T \\ 0 , & 0 \leq T - Γ\end{matrix} ,$$
wherein T is a current moment, and Γ is a validity period of the reputation value; when t=T, ω(X_{P}(t))=1, that is, when X_{P}(t) is a reputation value at the current moment, a weight of the reputation value in the comprehensive reputation value is 1; when 0≤t≤T−Γ, ω(X_{P}(t))=0, indicating that a reputation value at a moment with an interval to the current moment T exceeding the validity period T is not used for evaluation; and the comprehensive reputation value of the user is finally obtained through a weighted average sum method as follows:
$${χ}_{{}_{P}} = {\sum }_{T - Γ < t \leq T} ( {χ}_{{}_{P}} ( t ) * \frac{ω ( {χ}_{{}_{P}} ( t ) )}{{\sum }_{T - Γ < t \leq T} ω ( {χ}_{{}_{P}} ( t ) )} ) ,$$
a double auction mechanism comprises: in the network, n requesting users U={P₀, P₁, P₂, . . . , Pₙ} are waiting for anonymous services and m network users U′={Pₙ₊₁, Pₙ₊₂, . . . , Pₙ₊ₘ} are waiting to receive collaboration tasks; and each requesting user Pᵢ∈U broadcasts a collaboration request Q_{P}_{ᵢ}=(X_{P}_{ᵢ}, M, Δt, O_{P}_{ᵢ}) to the other user Pⱼ∈U′ in the network, wherein X_{P}_{ᵢ} is a comprehensive reputation value of the requesting user, M is an actual transaction amount of the requesting user, Δt is an acceptable anonymous transaction execution delay of the requesting user, and O_{P}_{ᵢ} is a bid base of the auction; and
the bid base of the requesting user is
$${O}_{{P}_{i}} = \frac{M * φ ( Δ t )}{{χ}_{{}_{{P}_{i}}}} ,$$
wherein φ(Δt) is a decreasing function; a bid O_{P}_{ⱼ} of the network user Pⱼ needs to have a positive correlation with the bid base of the requesting user, and the bid of the network user is O_{P}_{ⱼ}=O_{P}_{ᵢ}*X_{P}_{ⱼ}*ρ, wherein ρ is a control coefficient used to limit overbidding; after receiving the collaboration request Q_{P}_{ᵢ}, the network user Pⱼ∈U′ ranks the requesting user in ascending order of the bid base O_{P}_{ᵢ} and the comprehensive reputation value X_{P}_{ᵢ}, and determines, based on a comprehensive ranking of the bid base and the comprehensive reputation value of the requesting user Pᵢ, whether to accept the request; if the network user accepts the request, the network user sends a reply R_{P}_{ᵢ}=(X_{P}_{ⱼ}, O_{P}_{ⱼ}) to the requesting user; or if the network user rejects the request, the network user does not respond; the network user selectively accepts collaboration requests of a plurality of requesting users based on a capability of the network user, and establishes a to-be-executed task set W_{P}_{ⱼ}={w₁, w₂, . . . , wₙ}; and the requesting user Pᵢ arranges the candidate collaborative users in ascending order of comprehensive reputation value and in descending order of bid, and determines that k users whose comprehensive ranking is the highest constitute the anonymous set Set={A₁ . . . , Aᵢ, . . . , Aₖ}.

17. The computer device according to claim 8, wherein the method for protecting location privacy in mobile payment comprises the following steps:
step 1: in an anonymous set generation phase, describing a mutual relationship between users from a perspective of a supply-demand relationship, and generating the anonymous set for the requesting user through a double auction mechanism;
step 2: in a transaction execution phase, executing an anonymous transaction based on the anonymous transaction model; and
step 3: in a reputation update phase, updating reputations of the users based on the reputation evaluation scheme and bad user behavior defined in the anonymous set generation phase and the transaction execution phase.

18. The computer device according to claim 17, wherein the anonymous set generation phase in step 1 comprises:
(1) before executing a mobile payment transaction, broadcasting, by the requesting user P₀, a collaboration request Q_{P}_{₀}=(X_{P}_{₀}, M, Δt, O_{P}_{₀}, Sign_{P}_{₀}(X_{P}_{₀}∥M∥Δt∥O_{P}_{₀})) to the other users in a network, wherein Sign(·) is a secure signature function, and Sign_{P}_{₀}(X_{P}_{₀}∥M∥Δt∥O_{P}_{₀}) indicates that the requesting user P₀ signs a comprehensive reputation value, a transaction amount, and an acceptable task execution delay by using a private key;
(2) after receiving the collaboration request Q_{P}_{₀}=(X_{P}_{₀}, M, Δt, O_{P}_{₀}, Sign_{P}_{₀}(X_{P}_{₀}∥M∥Δt∥O_{P}_{₀})) sent by the requesting user P₀, verifying, by the network user Pⱼ, correctness of the signature information Sign_{P}_{₀}(X_{P}_{₀}∥M∥Δt∥O_{P}_{₀}) and the comprehensive reputation value X_{P}_{₀} of the requesting user P₀ in the collaboration request Q_{P}_{₀}:
1) if Ver_{P}_{₀}(Sign_{P}_{₀}(X_{P}_{₀}∥M∥Δt∥O_{P}_{₀}))=Sign_{P}_{₀}(X_{P}_{₀}∥M∥Δt∥O_{P}_{₀}), indicating that an identity of the requesting user passes the verification, verifying the comprehensive reputation value X_{P}_{₀} of the requesting user; and p1 if
$$Ver ( {χ}_{{}_{{P}_{0}}} ) = {\sum }_{T - Γ < t \leq T} ( {χ}_{{}_{{P}_{0}}} ( t ) * \frac{ω ( {χ}_{{}_{{P}_{0}}} ( t ) )}{{\sum }_{T - Γ < t \leq T} ω ( {χ}_{{}_{{P}_{0}}} ( t ) )} ) ,$$
indicating that the identity and the comprehensive reputation value of the requesting user both pass the verification, determining, by the network user based on a bid base O_{P}_{₀} given by and the comprehensive reputation value X_{P}_{₀} of the requesting user, whether to accept the collaboration request; if the network user Pⱼ accepts the collaboration request of the requesting user P₀, sending a reply R_{P}_{ⱼ}=X_{P}_{ⱼ}, O_{P}_{ⱼ}, add(Pⱼ), Sign_{P}_{ⱼ}(X_{P}_{ⱼ}∥O_{P}_{ⱼ}∥add(Pⱼ))) to the requesting user P₀, wherein add(Pⱼ) is an account address of the network user Pⱼ; otherwise, not responding; and accepting, by the network user, collaboration requests of a plurality of requesting users based on a capability of the network user, to form a to-be-executed task set W_{P}_{ⱼ}={w₁, w₂, . . . , wₙ}; or
if
$$Ver ( {χ}_{{}_{{P}_{0}}} ) \neq {\sum }_{T - Γ < t \leq T} ( {χ}_{{}_{{P}_{0}}} ( t ) * \frac{ω ( {χ}_{{}_{{P}_{0}}} ( t ) )}{{\sum }_{T - Γ < t \leq T} ω ( {χ}_{{}_{{P}_{0}}} ( t ) )} ) ,$$
indicating that the comprehensive reputation value of the requesting user fails the verification, broadcasting, by the network user Pⱼ, information message_{P}_{ⱼ}(¬X_{P}_{₀}); or
2) if Ver_{P}_{₀}(Sign_{P}_{₀}(X_{P}_{₀}∥M∥Δt∥O_{P}_{₀}))≠Sign_{P}_{₀}(X_{P}_{₀}∥M∥Δt∥O_{P}_{₀}), indicating that an identity of the requesting user fails the verification, broadcasting, by the network user Pⱼ, information message_{P}_{ⱼ}(¬P₀) without verifying the comprehensive reputation value X_{P}_{₀} of the requesting user, wherein Ver(·) is a verification function, Ver_{P}_{₀}Sign_{P}_{₀}(X_{P}_{₀}∥M∥Δt∥O_{P}_{₀})) indicates verification of correctness of the signature information Sign_{P}_{₀}(X_{P}_{₀}∥M∥Δt∥O_{P}_{₀}by using a public key of the requesting user P₀, and if the verification fails, Sign_{P}_{₀}(X_{P}_{₀}∥M∥Δt∥O_{P}_{₀}) is not a signature generated through encryption performed by using the private key of P₀, and the identity of the requesting user is likely to be forged;
(3) verifying, by the requesting user P₀, correctness of the reply R_{P}_{ⱼ}=(X_{P}_{ⱼ}, O_{P}_{ⱼ}, add(Pⱼ), Sign_{P}_{ⱼ}(X_{P}_{ⱼ}∥O_{P}_{ⱼ}∥add(Pⱼ))) of the network user Pⱼ:
1) if Ver_{P}_{ⱼ}(Sign_{P}_{ⱼ}(X_{P}_{ⱼ}∥O_{P}_{ⱼ}∥add(Pⱼ)))=Sign_{P}_{ⱼ}(X_{P}_{ⱼ}∥O_{P}_{ⱼ}∥add(Pⱼ)), indicating that an identity of the network user passes the verification, verifying a comprehensive reputation value of the network user; and
if
$$Ver ( {χ}_{{}_{{P}_{j}}} ) = {\sum }_{T - Γ < t \leq T} ( {χ}_{{}_{{P}_{j}}} ( t ) * \frac{ω ( {χ}_{{}_{{P}_{j}}} ( t ) )}{{\sum }_{T - Γ < t \leq T} ω ( {χ}_{{}_{{P}_{j}}} ( t ) )} ) ,$$
indicating that the comprehensive reputation value of the network user passes the verification, taking the network user Pⱼ as a candidate collaborative user; or
if
$$Ver ( {χ}_{{}_{{P}_{j}}} ) \neq {\sum }_{T - Γ < t \leq T} ( {χ}_{{}_{{P}_{j}}} ( t ) * \frac{ω ( {χ}_{{}_{{P}_{j}}} ( t ) )}{{\sum }_{T - Γ < t \leq T} ω ( {χ}_{{}_{{P}_{j}}} ( t ) )} ) ,$$
indicating that the comprehensive reputation value of the network user fails the verification, broadcasting, by the requesting user P₀, information message_{P}_{₀}(¬X_{P}_{ⱼ}); or
2) if Ver_{P}_{ⱼ}(Sign_{P}_{ⱼ}(X_{P}_{ⱼ}∥O_{P}_{ⱼ}∥add(Pⱼ)))≠Sign_{P}_{ⱼ}(X_{P}_{ⱼ}∥O_{P}_{ⱼ}∥add(Pⱼ)), indicating that an identity of the network user fails the verification, broadcasting, by the requesting user P₀, information message_{P}_{₀}(¬Pⱼ) without verifying the comprehensive reputation value X_{P}_{ⱼ} of the network user; and
(4) ranking, by the requesting user P₀, the candidate collaborative user in ascending order of the comprehensive reputation value X_{P}_{ⱼ} and in descending order of a bid O_{P}_{ⱼ} to obtain a comprehensive reputation value ranking N_{X}(Pⱼ) and a bid ranking N_{O}(Pⱼ) of the candidate collaborative user Pⱼ, wherein a comprehensive ranking of the candidate collaborative user is N(Pⱼ)=N_{X}(Pⱼ)+N_{O}(Pⱼ); selecting k users whose comprehensive ranking N(Pⱼ) is the highest from all candidate collaborative users to form the anonymous set Set={A₁ . . . , Aᵢ, . . . , Aₖ}; and if a current size k of the anonymous set does not meet a privacy protection requirement of the requesting user, continuing to wait for the other network users to reply;
wherein in the anonymous set generation phase, after the network user Pⱼ receives the collaboration request Q_{P}_{₀} sent by the requesting user P₀ or after the requesting user P₀ receives the reply R_{P}_{ⱼ} sent by the network user, the correctness of the signature information and the comprehensive reputation value is verified to confirm authenticity of the identity and the comprehensive reputation value of the user.

19. The computer device according to claim 17, wherein the transaction execution phase in step 2 comprises:
(1) executing, by the requesting user P₀, a fund transfer transaction d₀(P₀ [symbol] A₁), and sending a transaction credential
$${V}_{{P}_{0}} = ( {Num}_{{d}_{0}}^{{P}_{0}} , {Sign}_{{P}_{0}} ( {Num}_{{d}_{0}}^{{P}_{0}} ) )$$
to the collaborative user A₁, wherein
$${Num}_{{d}_{0}}^{{P}_{0}}$$
represents a transaction number obtained after the requesting user P₀ executes d₀(P₀ [symbol] A₁); and sending a collaboration task
$${w}_{{P}_{0}}^{{A}_{i}} = ( M , Δ t , add ( {A}_{i + 1} ) , {Sign}_{{P}_{0}} ( M ‖ Δ t ‖ add ( {A}_{i + 1} ) ) )$$
to the collaborative user Aᵢ, wherein add(Aᵢ₊₁) represents a target address of a transaction to be executed by the collaborative user Aᵢ;
(2) after receiving the transaction credential
$${V}_{{P}_{0}} = ( {Num}_{{d}_{0}}^{{P}_{0}} , {Sign}_{{P}_{0}} ( {Num}_{{d}_{0}}^{{P}_{0}} ) )$$
sent by the requesting user P₀, verifying, by the collaborative user A₁, authenticity of the transaction credential:
1) if
$$Ver ( {Num}_{{d}_{0}}^{{P}_{0}} ) = 1 ,$$
verifying the signature information
$${Sign}_{{P}_{0}} ( {Num}_{{d}_{0}}^{{P}_{0}} ) ;$$
and
if
$$Ver ( {Sign}_{{P}_{0}} ( {Num}_{{d}_{0}}^{{P}_{0}} ) ) = {Sign}_{{P}_{0}} ( {Num}_{{d}_{0}}^{{P}_{0}} ) ,$$
indicating that an identity of and the transaction number transmitted by the requesting user P₀ are both true, broadcasting no information; or if
$$Ver ( {Sign}_{{P}_{0}} ( {Num}_{{d}_{0}}^{{P}_{0}} ) ) \neq {Sign}_{{P}_{0}} ( {Num}_{{d}_{0}}^{{P}_{0}} ) ,$$
indicating that an identity of the requesting user P₀ is forged, broadcasting information message_{A}_{₁}(¬P₀); or
2) if
$$Ver ( {Num}_{{d}_{0}}^{{P}_{0}} ) = 0 ,$$
indicating that the transaction number transmitted by the requesting user P₀ is not true or valid, broadcasting, by the collaborative user A₁, information
$${message}_{{A}_{1}} ( {}^{¬} {Num}_{{d}_{0}}^{{P}_{0}} )$$
without verifying the signature information
$${Sign}_{{P}_{0}} ( {Num}_{{d}_{0}}^{{P}_{0}} ) ;$$
and
immediately terminating, by the remaining collaborative users who receive the broadcast information message_{A}_{₁}(¬P₀) or
$${message}_{{A}_{1}} ( {}^{¬} {Num}_{{d}_{0}}^{{P}_{0}} ) ,$$
a collaboration task related to the requesting user;
(3) after receiving the collaboration task
$${w}_{{P}_{0}}^{{A}_{i}} = ( M , Δ t , add ( {A}_{i + 1} ) , {Sign}_{{P}_{0}} ( M ‖ Δ t ‖ add ( {A}_{i + 1} ) ) )$$
sent by the requesting user P₀, checking, by the collaborative user Aᵢ, whether the information message_{A}_{₁}(¬P₀) or
$${message}_{{A}_{1}} ( {}^{¬} {Num}_{{d}_{0}}^{{P}_{0}} )$$
exists; and if the information exists, terminating the collaboration task; or if the information does not exist, verifying correctness of the signature information Sign_{P}_{₀}(M∥Δt∥add(Aᵢ₊₁)) of the requesting user P₀ in the collaboration task
$${w}_{{P}_{0}}^{{A}_{i}} :$$
1) if Ver_{P}_{₀}(Sign_{P}_{₀}(M∥Δt∥add(Aᵢ₊₁)))=Sign_{P}_{₀}(M∥Δt∥add(Aᵢ₊₁)), indicating that an identity of the requesting user passes the verification, executing, by the collaborative user Aᵢ, a transaction dᵢ(Aᵢ [symbol] Aᵢ₊₁) based on content in the collaboration task
$${w}_{{P}_{0}}^{{A}_{i}} ;$$
and after executing the transaction dᵢ(Aᵢ [symbol] Aᵢ₊₁), sending a collaboration credential
$${V}_{{A}_{i}} = ( {Num}_{{d}_{i}}^{{A}_{i}} , {Sign}_{{A}_{i}} ( {Num}_{{d}_{i}}^{{A}_{i}} ) )$$
to the requesting user P₀ to obtain remuneration for executing the anonymous transaction; or
2) if Ver_{P}_{₀}(Sign_{P}_{₀}(M∥Δt∥add(Aᵢ₊₁)))≠Sign_{P}_{₀}(M∥Δt∥add(Aᵢ₊₁)), indicating that an identity of the requesting user P₀ is forged, refusing, by the collaborative user Aᵢ, to execute the collaboration task, and broadcasting information message_{A}_{ᵢ}(¬P₀); wherein
execution of an actual transaction D(P₀→S) of the requesting user is completed only after all collaborative users Aᵢ in the anonymous set execute the transaction dᵢ, that is, ∀Aᵢ∈Set, Aᵢ has executed dᵢ(Aᵢ [symbol] Aᵢ₊₁)D(P₀→S) is completed;
(4) after receiving the collaboration credential
$${V}_{{A}_{i}} - ( {Num}_{{d}_{i}}^{{A}_{i}} , {Sign}_{{A}_{i}} ( {Num}_{{d}_{i}}^{{A}_{i}} ) )$$
sent by the collaborative user Aᵢ, verifying, by the requesting user P₀, the collaboration credential:
1) if
$$Ver ( {Num}_{{d}_{i}}^{{A}_{i}} ) = 1 ,$$
verifying the signature information
$${Ver}_{{A}_{i}} - ( {Sign}_{{A}_{i}} ( {Num}_{{d}_{i}}^{{A}_{i}} ) ) ;$$
and
if
$${Ver}_{{A}_{i}} - ( {Sign}_{{A}_{i}} ( {Num}_{{d}_{i}}^{{A}_{i}} ) ) = {Sign}_{{A}_{i}} ( {Num}_{{d}_{i}}^{{A}_{i}} ) ,$$
indicating that a transaction number transmitted by the collaborative user Aᵢ is true and valid and an identity of the collaborative user passes the verification, executing, by the requesting user, a remuneration transaction
$${f}_{i} = ( {P}_{0} {\to }^{{O}_{{A}_{i}}} {A}_{i} ) ,$$
and sending a payment credential
$${\tilde{V}}_{{P}_{0}}^{{A}_{i}} = ( {Num}_{{f}_{i}}^{{P}_{0}} , {Sign}_{{P}_{0}} ( {Num}_{{f}_{i}}^{{P}_{0}} ) )$$
to the collaborative user Aᵢ; or
if
$${Ver}_{{A}_{i}} ( {Sign}_{{A}_{i}} ( {Num}_{{d}_{i}}^{{A}_{i}} ) ) \neq {Sign}_{{A}_{i}} ( {Num}_{{d}_{i}}^{{A}_{i}} ) ,$$
indicating that an identity of the collaborative user Aᵢ is forged, broadcasting information message_{P}_{₀}(¬Aᵢ); or
2) if
$$Ver ( {Num}_{{d}_{i}}^{{A}_{i}} ) = 0 ,$$
indicating that a transaction number transmitted by the collaborative user Aᵢ is not true or valid, broadcasting, by the requesting user P₀, information
$${message}_{{P}_{0}} ( {}^{¬} {Num}_{{d}_{i}}^{{A}_{i}} )$$
without verifying the signature information
$${Sign}_{{A}_{i}} ( {Num}_{{d}_{i}}^{{A}_{i}} ) ;$$
and
if the anonymous transaction is successfully completed but the collaborative user Aᵢ does not finish executing the transaction within a time period Δt specified by the requesting user, broadcasting information message_{P}_{₀}(¬Δt_{A}_{ᵢ}); if a collaborative user in the anonymous set does not execute the transaction, indicating that the execution of the actual transaction D(P₀→S) of the requesting user is not completed, that is, ∃Aᵢ∈Set, Aᵢ was not executed dᵢ(Aᵢ [symbol] Aᵢ₊₁)⇔D(P₀→S) is not completed, broadcasting, by the requesting user, a collaborative user who fails verification or even does not send a collaboration credential; and
(5) after receiving the payment credential
$${\tilde{V}}_{{P}_{0}}^{{A}_{i}} = ( {Num}_{{f}_{i}}^{{P}_{0}} , {Sign}_{{P}_{0}} ( {Num}_{{f}_{i}}^{{P}_{0}} ) )$$
sent by the requesting user P₀, responding, by the collaborative user Aᵢ, based on whether the corresponding remuneration is received: if the collaborative user Aᵢ does not receive anonymous transaction remuneration O_{A}_{ᵢ} paid by the requesting user, broadcasting information
$${message}_{{A}_{i}} ( {}^{¬} {Num}_{{d}_{i}}^{{P}_{0}} ) ,$$
and ending an anonymous transaction process.

20. The computer device according to claim 17, wherein the reputation update phase in step 3 comprises:
storing information message(·) through a blockchain, jointly verifying, by all nodes in the blockchain, the information by using a consensus characteristic of blockchain nodes, and storing message(·) that passes the verification as reputation evaluation evidence in a block; wherein
a set of the bad user behavior defined in the anonymous set generation phase and the transaction execution phase is Act={message(¬Δt), message(¬mes), message(¬P), message(¬X), message(¬Num)}, wherein message(¬Δt) indicates that the collaborative user does not finish executing the transaction within the specified time period; message(¬mes) indicates that the user maliciously broadcasts information; message(¬P) indicates that an identity of the user fails verification; message(¬X) indicates that a comprehensive reputation value of the user fails verification; message(¬Num) indicates that a transaction number transmitted by the requesting user or the collaborative user is not true or valid, that is, the requesting user does not transfer anonymous transaction funds, the collaborative user does not execute the anonymous transaction, or the requesting user does not pay remuneration to the collaborative user;
an incentive factor p and a penalty factor are set to be constant, and α_{P}^{t} increases by 1 when a user as a collaborative user honestly participates in an anonymous transaction, but a cumulative quantity of times of β_{P}^{t} is determined based on impact of bad behavior of the user on the anonymous transaction; message(¬Δt) has minimum impact because the collaborative user honestly executes the anonymous transaction but does not finish executing the anonymous transaction within a time period given by the requesting user, and is regarded as one time of bad behavior; message(¬mes) indicates that the user maliciously slanders another user and is regarded as two times of bad behavior; the bad behavior message(¬P) or message(¬X) has relatively small impact because the bad behavior occurs before the anonymous set is generated, the requesting user has not paid an anonymous transaction amount, and the collaborative user has not executed the anonymous transaction, and is regarded as two times of bad behavior; and the bad behavior message(¬Num) occurs in a process of executing the anonymous transaction, and is regarded as three times of bad behavior; and
an instantaneous reputation value X_{P}_{₀}(t) of the requesting user, an instantaneous reputation value X_{P}_{ⱼ}(t) of a network user, and an instantaneous reputation value X_{A}_{ᵢ}(t) of the collaborative user are respectively calculated through a formula
$${χ}_{{P}_{0}} ( t ) = max ( 0 , {χ}_{{P}_{0}} ( t - 1 ) - n * \frac{{β}_{{P}_{0}}^{t}}{{α}_{{P}_{0}}^{t} + {β}_{{P}_{0}}^{t}} )$$
for calculating the instantaneous reputation value of the requesting user, a formula
$${χ}_{{P}_{j}} ( t ) = max ( 0 , {χ}_{{P}_{j}} ( t - 1 ) - n * \frac{{β}_{{P}_{j}}^{t}}{{α}_{{P}_{j}}^{t} + {β}_{{P}_{0 j}}^{t}} )$$
for calculating the instantaneous reputation value of the network user, and a formula
$${χ}_{{A}_{i}} ( t ) = \{ \begin{matrix}min ( 1 , {χ}_{{A}_{i}} ( t - 1 ) + p * \frac{{α}_{{A}_{i}}^{t}}{{α}_{{A}_{i}}^{t} + {β}_{{A}_{i}}^{t}} ) \\ max ( 0 , {χ}_{{A}_{i}} ( t - 1 ) - n * \frac{{β}_{{A}_{i}}^{t}}{{α}_{{A}_{i}}^{t} + {β}_{{A}_{i}}^{t}} )\end{matrix}$$
for calculating the instantaneous reputation value of the collaborative user in the reputation evaluation model, and uploaded to the blockchain to update the reputation values of the users.
